(19) United States
(12) Patent Application Publication
(10) Pub. No.: US 2024/0270549 A1
(43) Pub. Date: Aug. 15, 2024

(54) LIFT DEVICE

(71) Applicant: Oshkosh Corporation, Oshkosh, WI (US)

(72) Inventors: Morton Ellis, Oshkosh, WI (US); Scott Harris, Oshkosh, WI (US); Neil Doherty, Oshkosh, WI (US)

(73) Assignee: Oshkosh Corporation, Oshkosh, WI (US)

(21) Appl. No.: 18/441,790

(22) Filed: Feb. 14, 2024

Related U.S. Application Data
(60) Provisional application No. 63/445,782, filed on Feb. 15, 2023.
(60) Provisional application No. 63/445,780, filed on Feb. 15, 2023.
(60) Provisional application No. 63/445,876, filed on Feb. 15, 2023.
(60) Provisional application No. 63/445,859, filed on Feb. 15, 2023.
(60) Provisional application No. 63/536,020, filed on Aug. 31, 2023.
(60) Provisional application No. 63/536,016, filed on Aug. 31, 2023.
(60) Provisional application No. 63/535,975, filed on Aug. 31, 2023.
(60) Provisional application No. 63/535,977, filed on Aug. 31, 2023.
(60) Provisional application No. 63/536,021, filed on Aug. 31, 2023.
(60) Provisional application No. 63/536,017, filed on Aug. 31, 2023.
(60) Provisional application No. 63/535,870, filed on Aug. 31, 2023.

(51) Int. Cl. B66F 11/04; B66F 3/44

(52) U.S. Cl. CPC B66F 11/04; B66F 3/44

(57) ABSTRACT

A lift device includes a base, a mast assembly including an inner mast section coupled to the base and an outer mast section, a platform assembly pivotally coupled to the outer mast section, a guardrail assembly pivotally coupled to the outer mast section, a crank assembly including a drive gear that is rotatably coupled to a pulley assembly, and a lift assist motor rotatably coupled to the drive gear. Rotation of the pulley assembly is configured to move the outer mast section relative to the inner mast section. The lift assist motor is configured to selectively apply an assisting torque on the drive gear to assist in raising the outer mast section, the platform assembly, and the guardrail assembly relative to the base.

### CROSS-REFERENCE TO RELATED PATENT APPLICATIONS

This application claims the benefit of and priority to (i) U.S. Provisional Application No. 63/445,780, filed on Feb. 15, 2023, (ii) U.S. Provisional Application No. 63/445,782, filed on Feb. 15, 2023, (iii) U.S. Provisional Application No. 63/445,859, filed on Feb. 15, 2023, (iv) U.S. Provisional Application No. 63/445,876, filed on Feb. 15, 2023, (v) U.S. Provisional Application No. 63/536,016, filed on Aug. 31, 2023, (vi) U.S. Provisional Application No. 63/536,017, filed on Aug. 31, 2023, (vii) U.S. Provisional Application No. 63/536,020, filed on Aug. 31, 2023, (viii) U.S. Provisional Application No. 63/536,021, filed on Aug. 31, 2023, (ix) U.S. Provisional Application No. 63/535,975, filed on Aug. 31, 2023, (x) U.S. Provisional Application No. 63/535,977, filed on Aug. 31, 2023, and (xi) U.S. Provisional Application No. 63/535,870, filed on Aug. 31, 2023, the entire disclosures of which are hereby incorporated by reference herein.

### BACKGROUND

Lift device or lift assemblies are designed to support a user or equipment on a platform at various heights. Some lift assemblies are operated manually (e.g., without supplying electrical energy) and may be used as an alternative to ladders or scaffolding.

### SUMMARY

At least one embodiment relates to a lift device. The lift device includes a base, a mast assembly including an inner mast section coupled to the base and an outer mast section, a platform assembly pivotally coupled to the outer mast section, a guardrail assembly pivotally coupled to the outer mast section, a crank assembly including a drive gear that is rotatably coupled to a pulley assembly, and a lift assist motor rotatably coupled to the drive gear. Rotation of the pulley assembly is configured to move the outer mast section relative to the inner mast section. The lift assist motor is configured to selectively apply an assisting torque on the drive gear to assist in raising the outer mast section, the platform assembly, and the guardrail assembly relative to the base.

Another embodiment relates to a lift device including a base, a mast assembly including an inner mast section coupled to the base and an outer mast section, a platform assembly pivotally coupled to the outer mast section, a guardrail assembly pivotally coupled to the outer mast section, a crank assembly including a handle, a drive gear, a driven gear, and a pulley assembly, and a lift assist motor rotatably coupled to the drive gear. The handle is rotatably fixed to the drive gear, and the driven gear is rotatably fixed to the pulley assembly. The pulley assembly is coupled between the inner mast section and the outer mast section so that rotation of the pulley assembly is configured to raise and lower the outer mast section, the platform assembly, and the guardrail assembly relative to the base. The lift assist motor is configured to selectively apply an assisting torque on the drive gear that reduces a torque required to rotate the handle and raise the outer mast section, the platform assembly, and the guardrail assembly relative to the base via the pulley assembly.

Another embodiment relates to a lift device including a base, a mast assembly including an inner mast section coupled to the base and an outer mast section, a platform assembly pivotally coupled to the outer mast section, a guardrail assembly pivotally coupled to the outer mast section, a crank assembly including a handle and a pulley assembly, a lift assist motor, a torque sensor, and a controller in communication with the lift assist motor and the torque sensor. The pulley assembly is coupled between the inner mast section and the outer mast section. The handle is rotatably coupled to the pulley assembly so that rotation of the handle in a first direction is configured to raise the outer mast section, the platform assembly, and the guardrail assembly relative to the base. The controller is configured to detect, via the torque sensor, that the handle is being rotated in the first direction and, in response, instruct the lift assist motor to generate an assisting torque that reduces a torque required to rotate the handle and raise the outer mast section, the platform assembly, and the guardrail assembly relative to the base via the pulley assembly.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements.

FIGS. 1 and 2 are perspective views of a lift device, according to an exemplary embodiment.

FIG. 3 is a front view of the lift device of FIG. 1.

FIG. 4 is a perspective view of the lift device of FIG. 1 in an elevated position.

FIGS. 5, 6, and 7 are right side views of the lift device of FIG. 1 in various configurations.

FIG. 8 is a perspective view of the lift device of FIG. 1.

FIG. 9 is a front view of the lift device of FIG. 1.

FIG. 10 is a perspective view of the lift device of FIG. 1.

FIG. 11 is a rear view of a pivot assembly of the lift device of FIG. 1.

FIGS. 12 and 13 are rear perspective section views of the lift device of FIG. 1 showing the pivot assembly of FIG. 11.

FIG. 14 is an exploded perspective view of the lift device of FIG. 1.

FIG. 15 is a left side view of an outrigger leg of the lift device of FIG. 1.

FIG. 16 is a front section view of the lift device of FIG. 1.

FIG. 17 is a perspective view of the lift device of FIG. 1 with a base shown as transparent.

FIG. 18 is a left section view of the base of FIG. 17.

FIG. 19 is a perspective view of the lift device of FIG. 1.

FIG. 20 is a right section view of the lift device of FIG. 1.

FIGS. 21 and 22 are left section views of the lift device of FIG. 1.

FIG. 23 is a front section view of the lift device of FIG. 1.

FIG. 24 is a right side view of the lift device of FIG. 1 with the outrigger leg of FIG. 15 removed.

FIGS. 25 and 26 are front perspective views of the lift device of FIG. 1.

FIG. 27 is a left side view of an outrigger assembly of the lift device of FIG. 1.

FIG. 28 is a right side view of the outrigger assembly of FIG. 27.

FIG. 29 is a left side view of the outrigger assembly of FIG. 27.

FIG. 30 is a right side view of the outrigger assembly of FIG. 27.

FIG. 31 is a perspective view of a crank assembly of the lift device of FIG. 1.

FIG. 32 is a right section view of the lift device of FIG. 1.

FIG. 33 is a rear section view of the lift device of FIG. 1.

FIGS. 34 and 35 are perspective views of the lift device of FIG. 1.

FIG. 36 is a front view of the lift device of FIG. 1.

FIG. 37 is a right side view of the lift device of FIG. 1.

FIGS. 38 and 39 are left section views of the lift device of FIG. 1.

FIGS. 40, 41, and 42 are front section views of a locking mechanism of the lift device of FIG. 1.

FIG. 43 is a perspective view of a guardrail assembly of the lift device of FIG. 1.

FIG. 44 is a front section view of the guardrail assembly of FIG. 43.

FIG. 45 is an exploded section view of the guardrail assembly of FIG. 43.

FIG. 46 is a perspective view of the guardrail assembly of FIG. 43 and a platform assembly of the lift device of FIG. 1.

FIG. 47 is a perspective view of a lift assembly, according to an exemplary embodiment.

FIGS. 48, 49, and 50 are wire frame perspective views illustrating the process of stowing a lift assembly, according to an exemplary embodiment.

FIGS. 51, 52, and 53 are wire frame perspective views illustrating the process of stowing a lift assembly, according to another exemplary embodiment.

FIGS. 54, 55, and 56 are wire fame side views illustrating the process stowing of the lift assemblies of FIGS. 48 and 51.

FIG. 57 is a perspective view of the lift assembly of FIG. 47 in a stowed configuration.

FIG. 58 is a detail view of a guard rail assembly of the lift assembly of FIG. 47.

FIG. 59 is a detail view of a guard rail release trigger assembly of the lift assembly of FIG. 47.

FIG. 60 is a rear perspective view of a tread plate of the lift assembly of FIG. 47.

FIG. 61 is a perspective view of a side panel of the guard rail assembly of FIG. 58.

FIG. 62 is a perspective view of the guard rail assembly of FIG. 58.

FIG. 63 is a perspective view of a foot well assembly of the lift assembly of FIG. 47.

FIG. 64 is a perspective view of a base assembly coupled to a mast of the lift assembly of FIG. 47.

FIG. 65 is a perspective view of a rotatable portion of an outrigger assembly of the lift assembly of FIG. 47.

FIG. 66 is a detail view of a locking guide of the rotatable portion of FIG. 66.

FIG. 67 is a perspective view of the base assembly of FIG. 64.

FIG. 68 is a perspective view of the outrigger assembly of FIG. 65.

FIG. 69 is a detail view of the outrigger assembly of FIG. 65.

FIG. 70 is a front view of the lift assembly of FIG. 47 in the stowed configuration.

FIG. 71 is a side view of the lift assembly of FIG. 47 in the stowed configuration.

FIGS. 72 and 73 are side views of the lift assembly of FIG. 47.

FIGS. 74, 75, 76, and 77 are perspective views of the lift assembly of FIG. 47.

FIG. 78 is a side view of the lift assembly of FIG. 47 in an elevated position.

FIG. 79 is a front view a lifting mechanism of the lift assembly of FIG. 47.

FIG. 80 is a rear view of the lifting mechanism of FIG. 79.

FIG. 81 is a front view of a panel of the lifting mechanism of FIG. 79.

FIG. 82 is a front view of a drive gear and a driven gear of the lifting mechanism of FIG. 79.

FIG. 83 is a section view of the lifting mechanism of FIG. 79.

FIG. 84 is a perspective view of the lifting mechanism of FIG. 79.

FIGS. 85 and 86 are rear views of the lifting mechanism of FIG. 79.

FIG. 87 is a section view of the lifting mechanism of FIG. 79.

FIG. 88 is a side view of the lifting mechanism of FIG. 79.

FIG. 89 is a rear view of the lifting mechanism of FIG. 79.

FIG. 90 is a perspective view of a link of the lifting mechanism of FIG. 79.

FIG. 91 is a rear view of the lifting mechanism of FIG. 79 including the link of FIG. 90.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The use herein of the term “axial” and variations thereof refers to a direction that extends generally along an axis of symmetry, a central axis, or an elongate direction of a particular component or system. For example, axially extending features of a component may be features that extend generally along a direction that is parallel to an axis of symmetry or an elongate direction of that component. Similarly, the use herein of the term “radial” and variations thereof refers to directions that are generally perpendicular to a corresponding axial direction. For example, a radially extending structure of a component may generally extend at least partly along a direction that is perpendicular to a longitudinal or central axis of that component. The use herein of the term “circumferential” and variations thereof refers to a direction that extends generally around a circumference of an object or around an axis of symmetry, a central axis or an elongate direction of a particular component or system.

### Lift Device

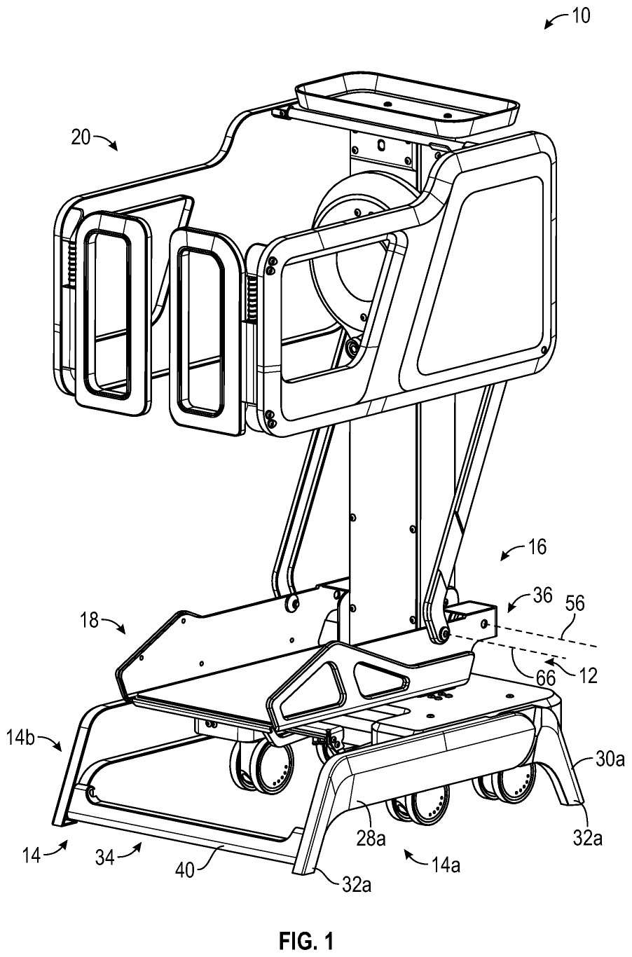

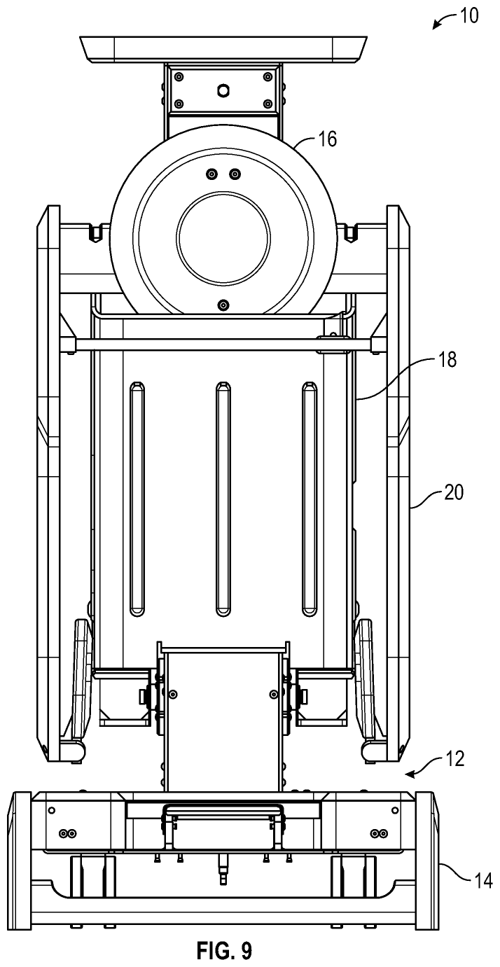

FIGS. 1-10 show a lift device, lift assembly, manual lift, vehicle, or platform lift, shown as lift device 10, according to an exemplary embodiment. In general, the lift device 10 is configured to support a user/operator and/or equipment at various heights above a ground on which the lift device 10 is supported. The lift device 10 includes a base, a frame, or a chassis, shown as base 12, a pair of outrigger assemblies 14 both pivotally coupled to the base 12, a mast assembly 16 supported on and coupled to the base 12, a platform assembly 18 pivotally coupled to the mast assembly 16, and a guardrail assembly 20 pivotally coupled to the mast assembly 16 and arranged above the platform assembly 18.

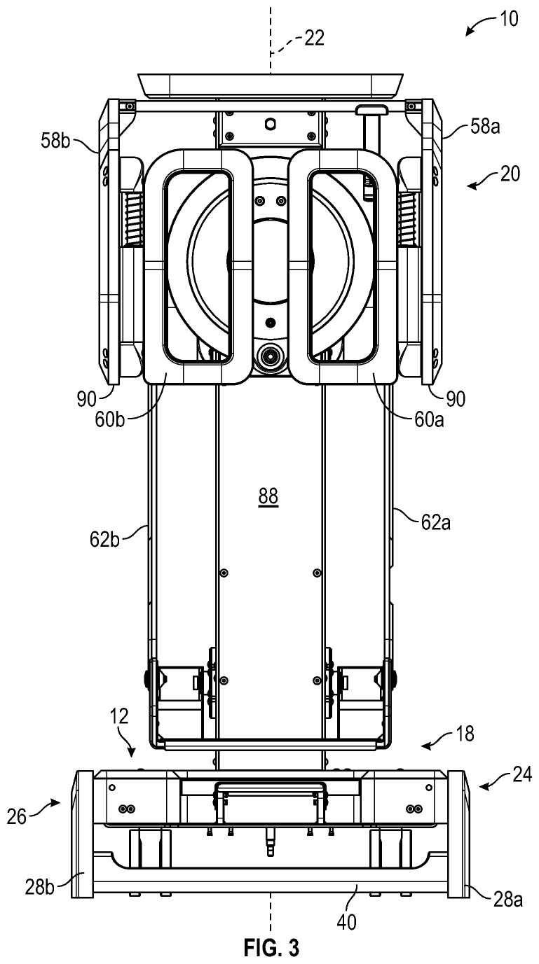

The pair of outrigger assemblies 14 includes a first or right outrigger assembly 14a coupled to a first or right side 24 of the base 12 and a second or left outrigger assembly 14b coupled to an opposite second or left side 26 of the base 12. The first outrigger assembly 14a includes the same components and is symmetric to the second outrigger assembly 14b about a center plane 22 that extends through a centerline of the lift device 10. As shown in FIG. 3, the center plane 22 faces in a lateral direction (i.e., extends vertically and longitudinally). As such, the description herein of the first outrigger assembly 14a applies symmetrically to the second outrigger assembly 14b and vice versa, with like features identified using similar reference numerals and the “a” suffix referring to the first side and the “b” suffix referring to the second side.

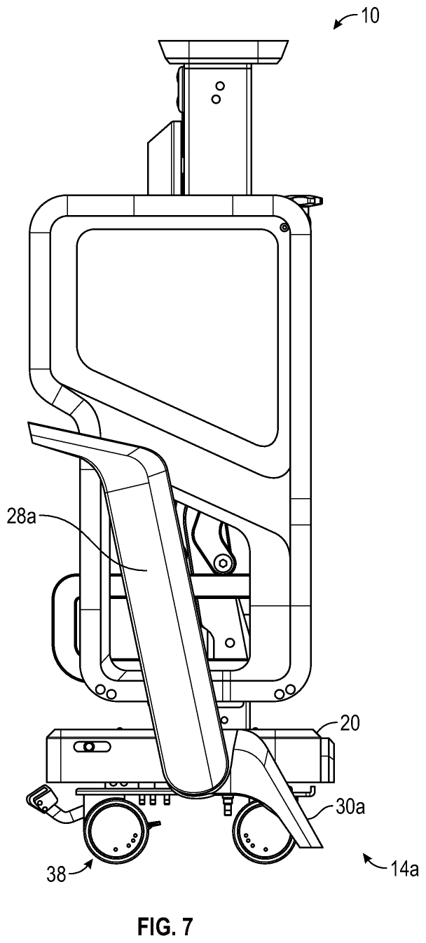

The first outrigger assembly 14a includes a front outrigger leg 28a and a rear outrigger leg 30a, and the second outrigger assembly 14a includes a front outrigger leg 28b and a rear outrigger leg 30b. The front outrigger leg 28a and the rear outrigger leg 30a each include a foot 32a, and the front outrigger leg 28b and the rear outrigger leg 30b each include a foot 32b. In general, the outrigger assemblies 14a, 14b are both pivotally movable between a lowered or deployed configuration or position (see, e.g., FIGS. 1-6) and a raised or stowed configuration or position (see, e.g., FIG. 7). In the deployed position, the feet 32a, 32b may all engage the ground on which the lift device 10 is supported such that the outrigger assemblies 14a, 14b stabilize and support the lift device 10. In the deployed position, the front outrigger legs 28a, 28b extend from the base 12 in a direction opposite to the rear outrigger legs 30a, 30b. For example, the front outrigger legs 28a, 28b extend forward and outwardly past a front side 34 of the base 12 and the rear outrigger legs 30a, 30b extend rearward toward a rear side 36 of the base 12. In the stowed position, the front outrigger legs 28a, 28b and the rear outrigger legs 30a, 30b are pivoted upward relative to the base 12 so that the feet 32a, 32b are raised off the ground and the lift device 10 is supported by a wheel assembly or caster assembly 38 coupled to the base 12. The movement of the front outrigger leg 28a and the front outrigger leg 28b is synchronized by a tie bar 40 that is coupled between the front outrigger leg 28a and the front outrigger leg 28b. In this way, for example, a user may grasp one of the front outrigger leg 28a, the front outrigger leg 28b, or the tie bar 40 and apply an upward or downward force to transition the outrigger assemblies 14a, 14b between the deployed position and the stowed position.

In general, the mast assembly 16 is coupled to the base 12 so that the mast assembly 16 is configured to extend and retract to raise and lower a working height of the platform assembly 18 and the guardrail assembly 20. Specifically, the mast assembly 16 includes a base mast section, stationary mast section, or post, shown as inner mast section 42, and a fly mast section or movable mast section, shown as outer mast section 44. The inner mast section 42 is rigidly coupled to the base 12 so that the inner mast section 42 is fixed to the base 12 and does not move relative to the base 12. The outer mast section 44 extends over (e.g., receives) the inner mast section 42 in a telescoping arrangement and is selectively movable relative to the base 12. As will be described herein, a lift assembly is coupled to the outer mast section 44 and configured to raise (see, e.g., and lower the outer mast section 44, and the platform assembly 18 and the guardrail assembly 20 coupled thereto, relative to the base 12.

The platform assembly 18 includes a floor, platform, or treadplate, shown as platform 46, a pair of sidewalls 48 coupled to and extending upwardly from opposing sides of the platform 46, and a pair of platform brackets 50. The platform brackets 50 are coupled to and extend upwardly from a rear end of the platform 46 (e.g., a side closer to the mast assembly 16). Each of the platform brackets 50 is rotatably coupled to a platform mounting plate 52 via a platform pivot shaft or platform mounting shaft 54. One of the platform mounting plates 52 is coupled to a first or right side of the outer mast section 44 and another of the platform mounting plates 52 is coupled to a second or left side of the outer mast section 44. Each of the platform mounting shafts 54 extends through a respective one of the platform brackets 50 and a respective one of the platform mounting plates 52 so that the platform mounting shafts 54 define a first platform pivot axis 56 about which the platform assembly 18 pivots relative to the outer mast section 44. The first platform pivot axis 56 is fixed relative to the outer mast section 44 and extends laterally through the centers of the platform mounting shafts 54.

The guardrail assembly 20 includes a first or right guardrail 58a, a second or left guardrail 58b, a first or right door 60a, and a second or left door 60b. The first guardrail 58a and the first door 60a include the same components and are symmetric to the second guardrail 58b and the second door 60b about the center plane 22. As such, the description herein of the first guardrail 58a and the first door 60a applies symmetrically to the second guardrail 58b and the second door 60b and vice versa, with like features identified using similar reference numerals and the “a” suffix referring to the first or right side and the “b” suffix referring to the second or left side. The first door 60a is pivotally coupled to a free end of the first guardrail 58a (e.g., a distal end of the first guardrail 58a that is not coupled to the outer mast section 44). Similarly, the second door 60b is pivotally coupled to a free end of the second guardrail 58b.

The platform assembly 18 is pivotally coupled to the guardrail assembly 20 by a pair of link arms. Specifically, a first or right link arm 62a is pivotally coupled between the platform assembly 18 and the guardrail assembly 20 and a second or left link arm 62b is pivotally coupled between the platform assembly 18 and the guardrail assembly 20. A first end of the first link arm 62a is coupled to one of the sidewalls 48 (e.g., a right sidewall) and a second end of the first link arm 62a is coupled to a pivot assembly 64. A first end of the second link arm 62b is coupled to the other of the sidewalls 48 (e.g., a left sidewall) and a second end of the second link arm 62b is coupled to the pivot assembly 64. The pivotal coupling between the first link arm 62a, the second link arm 62b, and the respective sidewalls 48 defines a second platform pivot axis 66 that is spaced from the first platform pivot axis 56 (e.g., in a direction away from the mast assembly 16) and extends laterally (e.g., parallel to the first platform pivot axis 56).

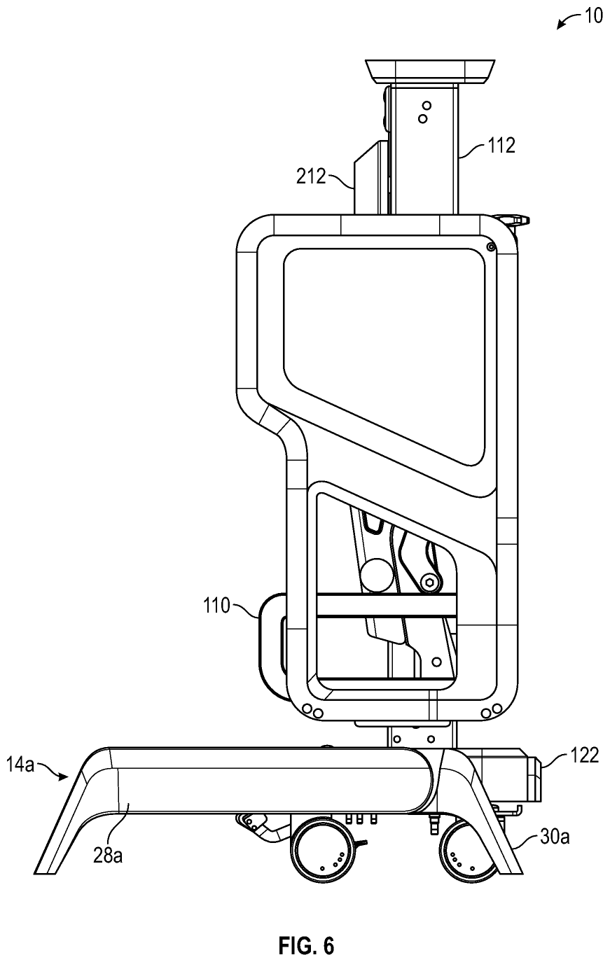

In general, the platform assembly 18 and the guardrail assembly 20 are both pivotally coupled to the outer mast section 44 by the pivot assembly 64 so that the platform assembly 18 and the guardrail assembly 20 are both pivotally movable between a raised or folded configuration or position (see, e.g., FIGS. 6-10) and a lowered or working configuration or position (see, e.g., FIGS. 1-5). The pivot assembly 64 is pivotally coupled to the guardrail assembly 20 and the outer mast section 44, and the pivot assembly 64 is also pivotally coupled to the first link arm 62a and the second link arm 62b, which links the movement of the guardrail assembly 20 to the movement of the platform assembly 18 and vice versa.

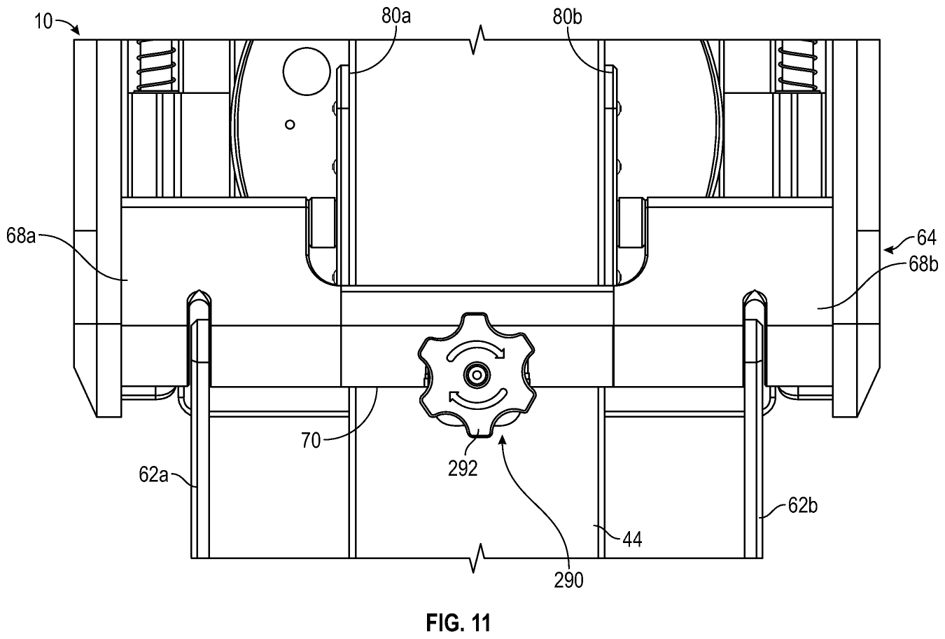

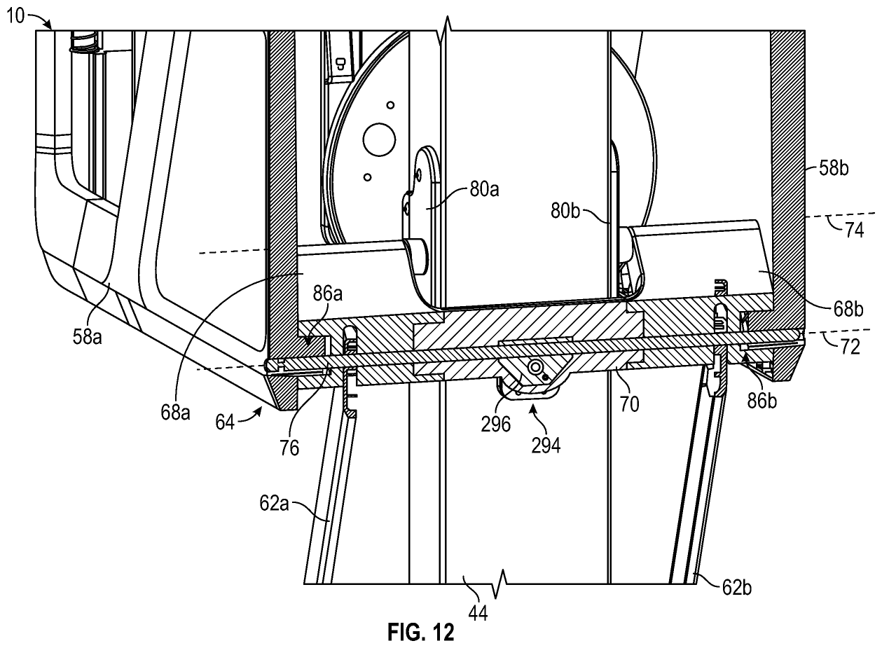

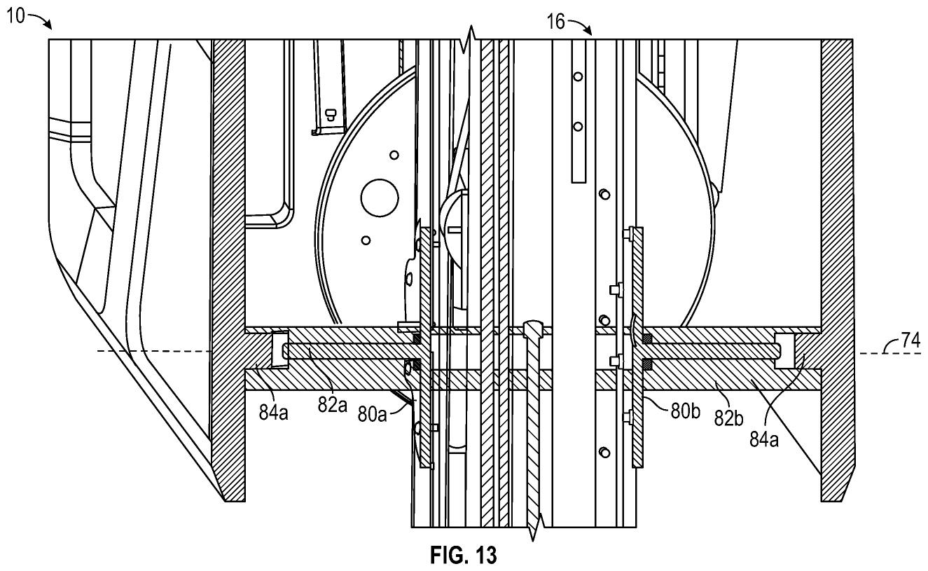

With reference to FIGS. 11-13, the pivot assembly 64 includes a first or right boss or member, shown as first link 68a, a second or left boss or member, shown as second link 68b, and a central portion, coupler portion, or locking portion, shown as cross member 70, arranged laterally between the first link 68a and the second link 68b. The first link 68a forms a pivotal coupling between the second end of the first link arm 62a, the outer mast section 44, and the first guardrail 58a, and the second link 68b forms a pivotal coupling between the second end of the second link arm 62b, the outer mast section 44, and the second guardrail 58b. For example, the first link 68a and the second link 68b both extend between a first guardrail pivot axis 72 and a second guardrail pivot axis 74. The first guardrail pivot axis 72 is defined along a rod or post, shown as hinge rail 76. The hinge rail 76 extends through a first end (e.g., a free end that is configured to pivot relative to the mast assembly 16) of both the first link 68a and the second link 68b, and through the cross member 70. A first end of the hinge rail 76 is received within and coupled to the first guardrail 58a and a second end of the hinge rail 76 is received within and coupled to the second guardrail 58b. The second ends of the first link arm 62a and the second link arm 62b are also rotatably coupled to the hinge rail 76.

The first guardrail pivot axis 72 is movable relative to the mast assembly 16 so that the hinge rail 76 is allowed to pivot relative to the mast assembly 16 about a second guardrail pivot axis 74. The first link 68a and the second link 68b are coupled to the outer mast section 44 by a first rail bracket 80a and a second rail bracket 80b, respectively. The first rail bracket 80a is coupled to a first or right side of the outer mast section 44 and the second rail bracket 80b is coupled to a second or left side of the outer mast section 44. The first rail bracket 80a includes a first rail post 82a that extends outwardly from the first rail bracket 80a and is received within a second end of the first link 68a. The first rail post 82a extends into a first side of the first link 68a (e.g., a side closer to the mast assembly 16), and a first protrusion 84a extends outwardly from an inner surface of the first guardrail 58a and is received within a first opening or slot 86a formed in a second side of the first link 68a (e.g., a side further away from the mast assembly 16). In general, the first slot 86a and the first protrusion 84a define complementary shapes and are geometrically shaped to ensure that the first guardrail 58a is rotationally fixed (e.g., clocked or keyed) to the first link 68a (e.g., the first guardrail 58a rotates with the first link 68a and is not allowed to rotate relative to the first link 68a). In some embodiments, the first protrusion 84a and the first slot 86a define an oval shape, a rectangular shape, an oblong shape, or another anti-rotation geometry that prevents the first guardrail 58a from rotating relative to the first link 68a.

Similar to the first rail bracket 80a, the second rail bracket 80b includes a second rail post 82b that extends outwardly from the second rail bracket 80b and is received within a second end of the second link 68b. The second rail post 82b extends into a first side of the second link 68b (e.g., a side closer to the mast assembly 16), and a second protrusion 84b extends outwardly from an inner surface of the second guardrail 58b and is received within a second opening or slot 86b formed in a second side of the second link 68b (e.g., a side further away from the mast assembly 16. The second slot 86b and the second protrusion 84b define complementary shapes and are geometrically shaped to ensure that the second guardrail 58b is rotationally fixed to the second link 68b (e.g., the second guardrail 58b rotates with the second link 68b and is not allowed to rotate relative to the second link 68b). In some embodiments, the second protrusion 84b and the second slot 86b define an oval shape, a rectangular shape, an oblong shape, or another anti-rotation geometry that prevents the second guardrail 58b from rotating relative to the second link 68b.

Because the first rail bracket 80a and the second rail bracket 80b are coupled to the outer mast section 44, the second guardrail pivot axis 74 is fixed relative to the outer mast section 44. Accordingly, the second ends of the first link 68a and the second link 68b (i.e., the ends coupled to the first/second rail posts 82a, 82b) do not translate or move relative to the outer mast section 44 other than rotating about the second guardrail pivot axis 74. On the other hand, the first guardrail pivot axis 72 extends through the first ends or free ends of both the first link 68a and the second link 68b, and through the cross member 70, and the first guardrail pivot axis 72 is allowed to move or pivot relative to the mast assembly 16 about the second guardrail pivot axis 74.

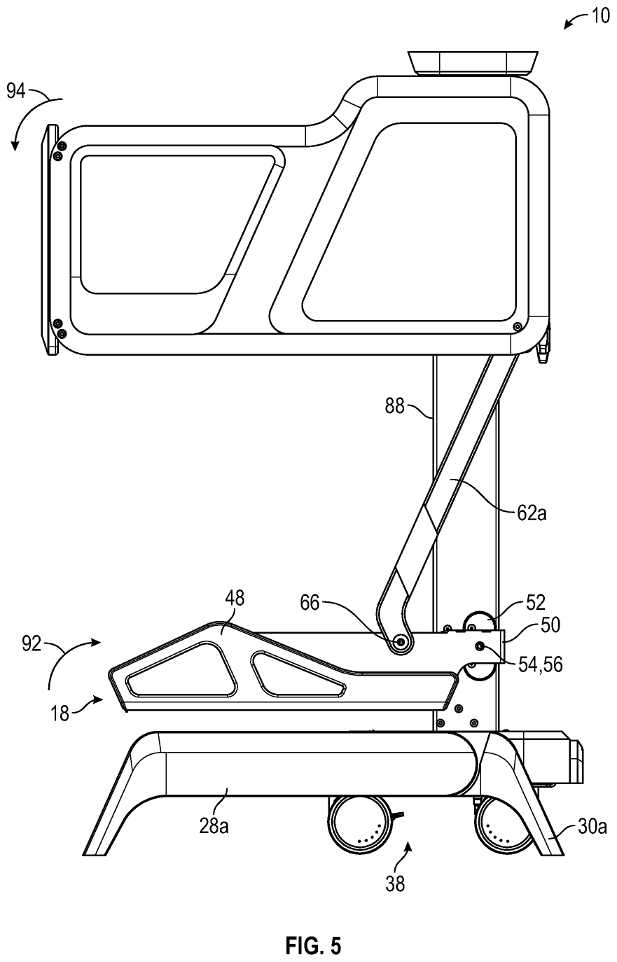

With reference to FIGS. 1-13, in the working position (see, e.g., FIGS. 1-5), the platform assembly 18 and the guardrail assembly 20 extend in a direction that is generally perpendicular to the mast assembly 16 (e.g., parallel to a ground on which the lift device 10 is supported). For example, in the working position, the platform 46 is arranged generally perpendicularly to a front surface 88 of the outer mast section 44, and the first/section guardrails 58a, 58b are arranged so that bottom surfaces 90 thereof extend along a plane that is perpendicular to the front surface 88 of the outer mast section 44. To pivot the platform assembly 18 and the guardrail assembly 20 from the working position to the folded position (see, e.g., FIGS. 6-10), the platform assembly 18 may be pivoted upwardly toward the mast assembly 16 along a first pivot direction 92 (e.g., clockwise from the perspective of FIG. 5) or the guardrail assembly 20 may be pivoted downwardly toward the mast assembly 16 along a second pivot direction 94 (e.g., counterclockwise from the perspective of FIG. 5). When the platform assembly 18 is pivoted relative to the mast assembly 16, the linkage formed between the link arms 62a, 62b and the pivot assembly 64 transfers the pivotal motion from the platform assembly 18 to the guardrail assembly 20 so that the platform assembly 18 and the guardrail assembly 20 simultaneously pivot toward the mast assembly 16 and into the folded configuration. Alternatively, when the guardrail assembly 20 is pivoted relative to the mast assembly 16, the linkage formed between the link arms 62a, 62b and the pivot assembly 64 transfers the pivotal motion from the guardrail assembly 20 to the platform assembly 18 so that the platform assembly 18 and the guardrail assembly 20 simultaneously pivot toward the mast assembly 16 and into the folded configuration. As such, an operator may either push up on the platform assembly 18 or push down on the guardrail assembly 20 to transition to the folded position.

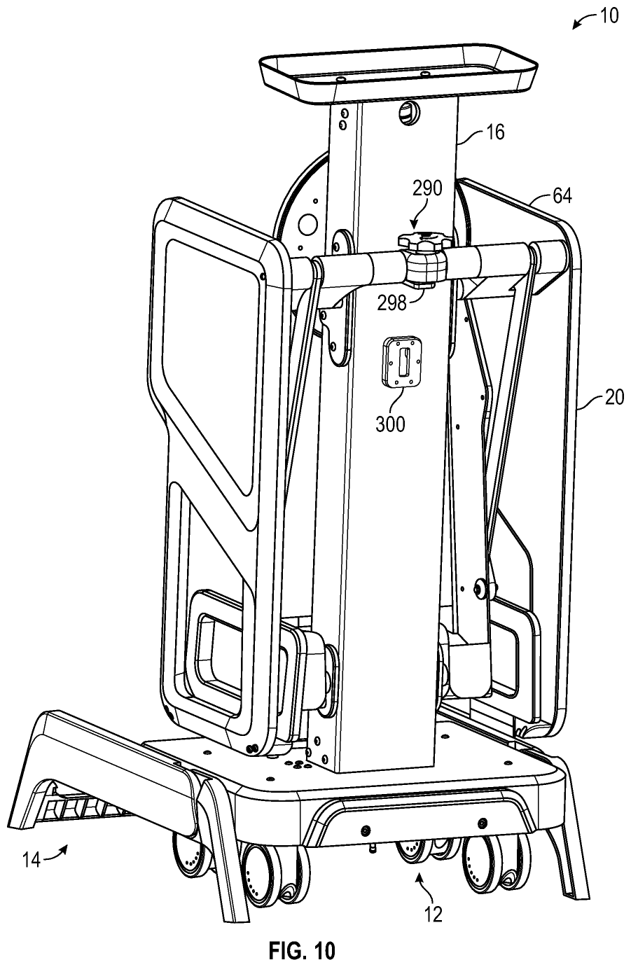

As the platform assembly 18 and the guardrail assembly 20 transition to the folded position, the hinge rail 76, which defines the second guardrail pivot axis 74, is forced away from the mast assembly 16 by the link arms 62a, 62b and pivots about the first guardrail pivot axis 72 (see, e.g., FIG. 10). The pivotal movement of the hinge rail 76 pivots the first link 68a and the second link 68b about the first guardrail pivot axis 72 along the second pivot direction 94, and the first guardrail 58a and the second guardrail 58b, which are coupled to the first link 68a and the second link 68b, respectively, are also pivoted relative to the mast assembly 16 along the second pivot direction 94. Simultaneous or synchronous with the pivotal movement of the guardrail assembly 20, the pivotal movement of the hinge rail 76 applies a pivotal force on the link arms 62a, 62b, which is applied to the platform assembly 18 at the second platform pivot axis 66 (i.e., the coupling between the link arms 62a, 62b and the sidewalls 48 of the platform 46). The pivotal force applied to the platform assembly 18 at the second platform pivot axis 66 results in the platform assembly 18 pivoting about the first platform pivot axis 56 toward the mast assembly 16 along the first pivot direction 92. As will be described herein, the pivot assembly 64 includes a locking mechanism that is configured to selectively couple the cross member 70 and the hinge rail 76 coupled thereto to the outer mast section 44 to prevent pivotal movement of the hinge rail 76 (e.g., such that a transition from the working position to the folded position is prevented), and selectively decouple the cross member 70 and the hinge rail 76 coupled thereto from the outer mast section 44 to allow pivotal movement of the hinge rail 76 (e.g., such that a transition from the working position to the folded position is allowed).

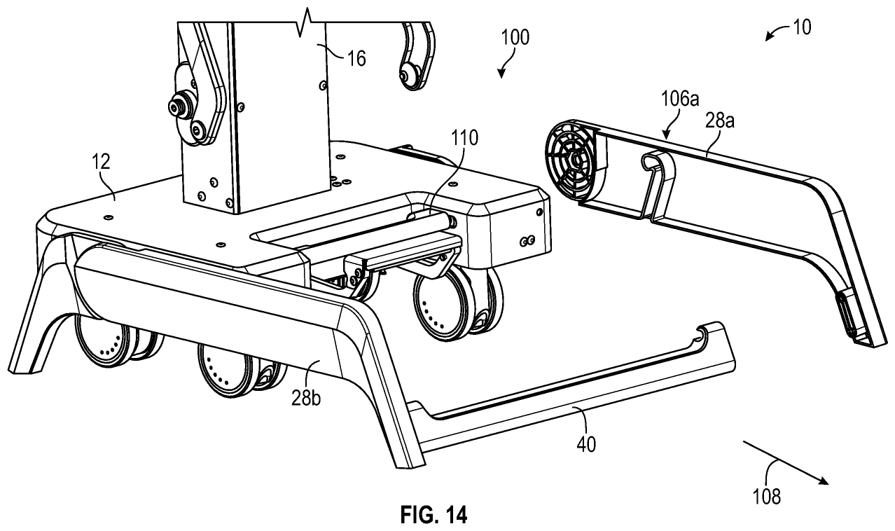

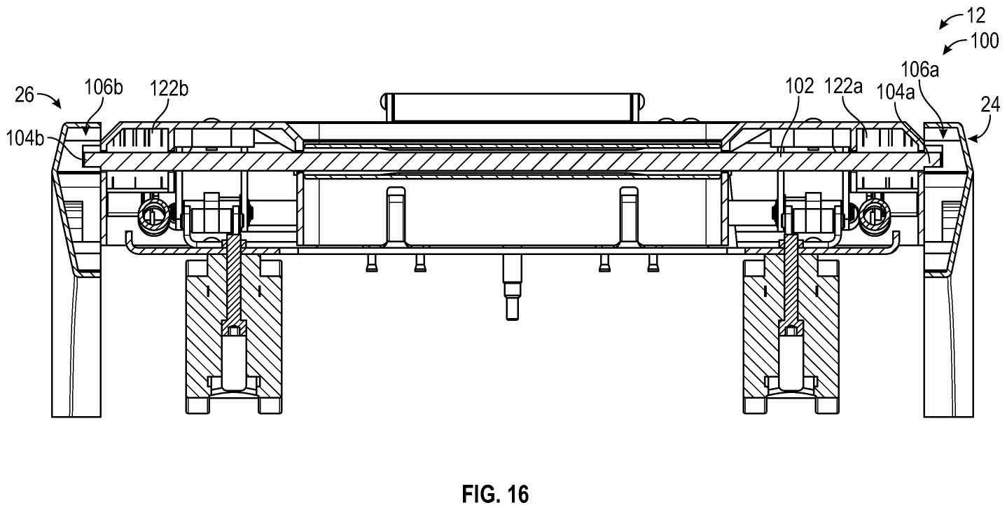

With reference to FIGS. 14-18, the front outrigger leg 28a and the front outrigger leg 28b both include an outrigger locking assembly 100 that is configured to selectively lock the front outrigger leg 28a and the front outrigger leg 28b in the deployed position. In some embodiments, the outrigger locking assembly 100 is in the form of a pin and slot, where the pin is selectively secured within a slot to lock the front outrigger legs 28a, 28b to the base 12 and prevent the front outrigger legs 28a, 28b from pivoting upward to the stowed position. In the illustrated embodiment, the outrigger locking assembly 100 includes an outrigger bar, pin, or rod, shown as outrigger bar 102 that extends through the base 12 so that a first end 104a of the outrigger bar 102 protrudes from the first side 24 of the base 12 and a second end 104b of the outrigger bar 102 protrudes from the second side 26 of the base 12. The first end 104a of the outrigger bar 102 is configured to be received within a locking slot 106a formed in the front outrigger leg 28a, and the second end 104b of the outrigger bar 102 is configured to be received within a locking slot 106b formed in the front outrigger leg 28b (see, e.g., FIG. 16). The outrigger bar 102 extends through slots formed in the base 12 that extend along a locking direction 108 (e.g., a direction perpendicular to the front surface 88 of the outer mast section 44). In this way, for example, the outrigger bar 102 is allowed to selectively displace along the locking direction 108 relative to the base 12 and the first/second locking slots 106a, 106b. The outrigger bar 102 includes a handle 110 that is arranged in a cutout formed in the front side 34 of the base 12. In some embodiments, a user may grab the handle 110 to move the outrigger bar 102 along the locking direction 108.

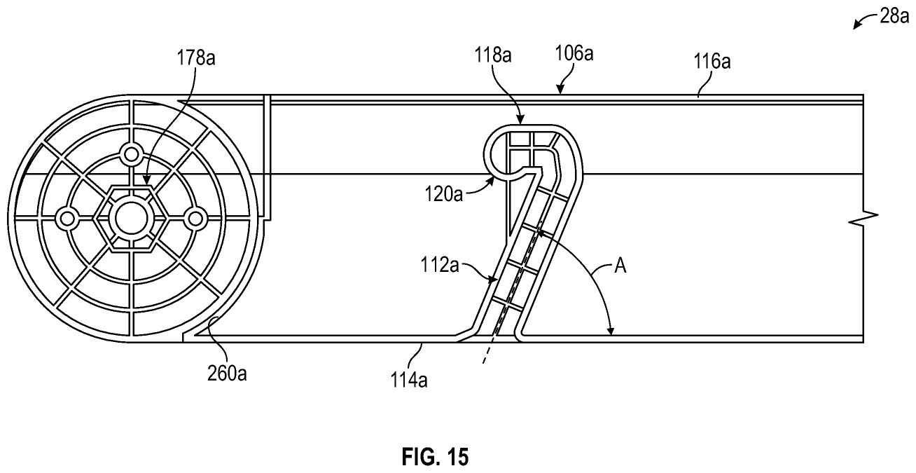

With specific reference to FIG. 15, the locking slot 106a is illustrated, according to an exemplary embodiment. It should be appreciated that the following description of the locking slot 106a and the selective locking and unlocking of the front outrigger leg 28a applies symmetrically to the locking slot 106b and the front outrigger leg 28b. In the illustrated embodiment, the locking slot 106a defines a generally backwards-seven-shaped slot. For example, the locking slot 106a includes an angled portion 112a that extends upwardly from a bottom surface 114a of the front outrigger leg 28a at an angle relative to the bottom surface 114a. In some embodiments, an angle A formed between a centerline of the angled portion 112a and the bottom surface 114a is an acute angle. The angled portion 112a extends upwardly into the front outrigger leg 28a (e.g., toward a top surface 116a) to a location between the bottom surface 114a and the top surface 116a. The locking slot 106a includes a locking portion 118a formed at an end of the angled portion 112a that extends along the locking direction 108 (e.g., substantially parallel to the bottom surface 114a or the top surface 116a). An end of the locking portion 118a includes a notch 120a that extends downward from the locking portion 118a and is configured to receive and hold the second end 104a of the outrigger bar 102.

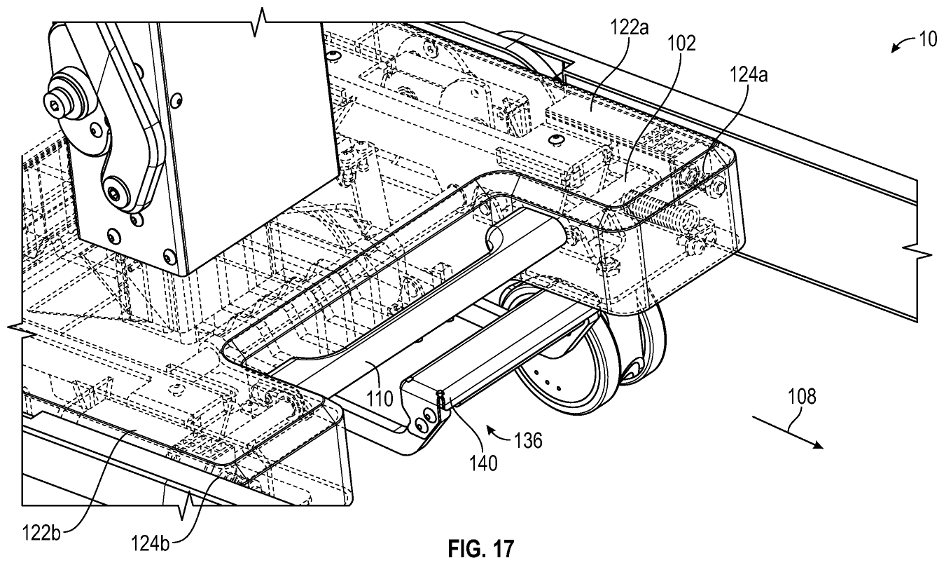

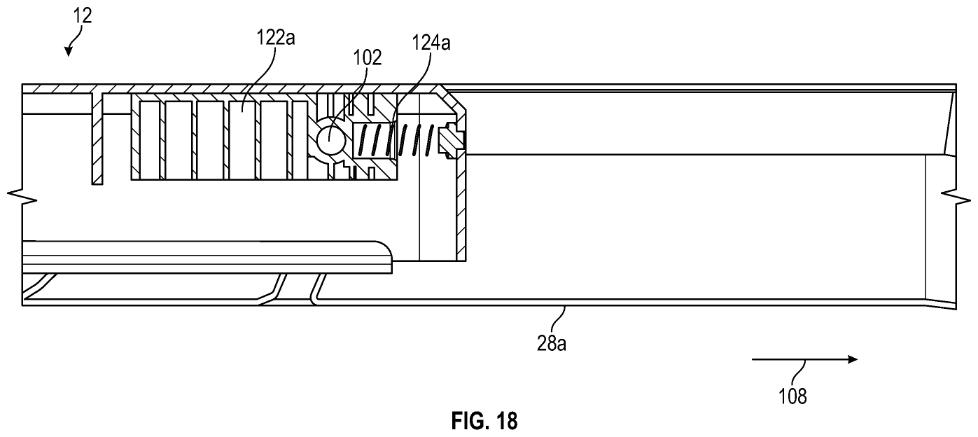

Turning to FIGS. 17 and 18, a pin slider or pin block 122a is arranged within the base 12, and the outrigger bar 102 extends through the pin slider 122a. A slider spring 124a is biased between the pin slider 122a and an inner surface of the base 12 so that the slider spring 124a generates a force on the outrigger bar 102 that biases the outrigger bar 102 in a direction opposite to the locking direction 108. In other words, when the second end 104a of the outrigger bar 102 is received within the notch 120a of the locking portion 118a, the sider spring 124a acts to maintain the second end 104a of the outrigger bar 102 within the notch 120a.

With reference back to FIGS. 14-18, in operation, when the outrigger assemblies 14a, 14b are in the deployed position, the ends 104a, 104b of the outrigger bar 102 are received within the notches 120a, 120b of the locking portions 118a, 118b and the slider springs 124a, 124b act to maintain the ends 104a, 104b of the outrigger bar 102 within the notches 120a, 120b, which prevents the front outrigger legs 28a, 28b from pivoting to the stowed position. To transition to the stowed position, the platform assembly 18 is transitioned to the folded configuration, which provides a user access to the handle 110 of the outrigger bar 102. In general, when the platform assembly 18 is in the working position, the platform assembly 18 covers the handle 110. Once a user can access the handle 110, the user may apply a force to the outrigger bar 102 in the locking direction 108 by pulling on the handle 110. When the force overcomes the biasing force of the slider springs 124a, 124b, the outrigger bar 102 translates along the locking direction 108 and the ends 104a, 104b of the outrigger bar 102 are displaced or translated out of the notches 120a, 120b and into the end of the angled portions 112a, 112b. With the ends 104a, 104b arranged within the angled portions 112a, 112b, the front outrigger legs 28a, 28b are allowed to pivot in a direction toward the mast assembly 16 (e.g., a counterclockwise direction from the perspective of FIGS. 6 and 7) to the folded position and the ends 104a, 104b of the outrigger bar 102 slide out of the angled portions 112a, 112b. To transition back to the deployed position, the front outrigger legs 28a, 28b are pivoted in a direction to toward the base 12 (e.g., a clockwise direction from the perspective of FIGS. 6 and 7) and the ends 104a, 104b of the outrigger bar 102 slide into the angled portions 112a, 112b. Once the front outrigger legs 28a, 28b are pivoted toward the base 12 a distance sufficient to arrange the ends 104a, 104b within the locking portions 118a, 118b, the slider springs 124a, 124b bias the outrigger bar 102 so that the ends 104a, 104b snap into the notches 120a, 120b and lock the front outrigger legs 28a, 28b in the deployed position.

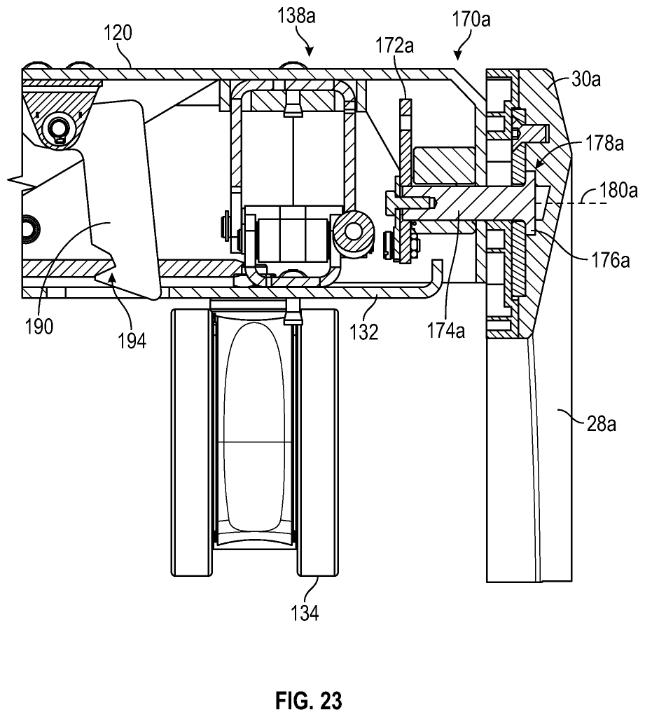

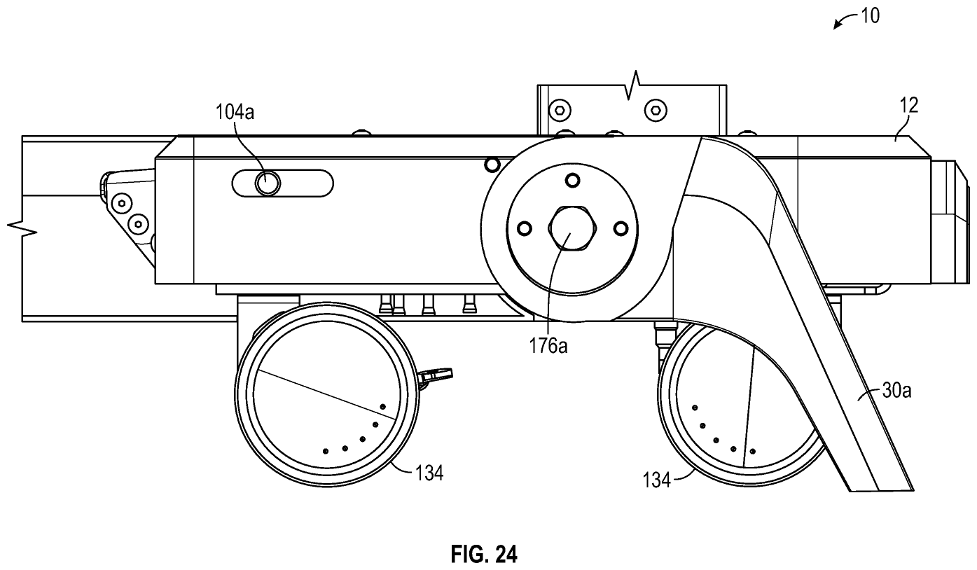

With reference to FIGS. 5-7 and 19-24, the lift device 10 includes a wheel or caster assembly 130 (e.g., the caster assembly 38) that is pivotally coupled to the base 12 so that the caster assembly 130 is configured to be selectively pivoted between an extended position (see, e.g., FIGS. 6 and 7) where the caster assembly 130 supports the lift device 10 on the ground and a retracted position (see, e.g., FIG. 5) where the caster assembly 130 is raised above the ground. The caster assembly 130 includes a caster plate 132 or tray, a plurality of wheels or caster wheels 134 coupled to the caster plate 132, a caster pedal assembly 136 coupled to the caster plate 132, and a caster linkage assembly 138 pivotally coupled between the base 12 and the caster plate 132. The caster pedal assembly 136 includes a pedal 140 that is pivotally coupled to the caster plate 132 by a pair of pedal lever arms 142. Each of the pedal lever arms 142 is fixed to the caster plate 132 by a bracket 144 and a distal end of both the pedal lever arms 142 is rotatably coupled to a pedal pivot bar 146. The pedal pivot bar 146 is fixed relative to the base 12 so that moving the pedal 140 (e.g., by a user stepping or pressing on the pedal 140) applies a pivotal force that pivots the caster plate 132 via the caster linkage assembly 138 from the retracted position to the extended position.

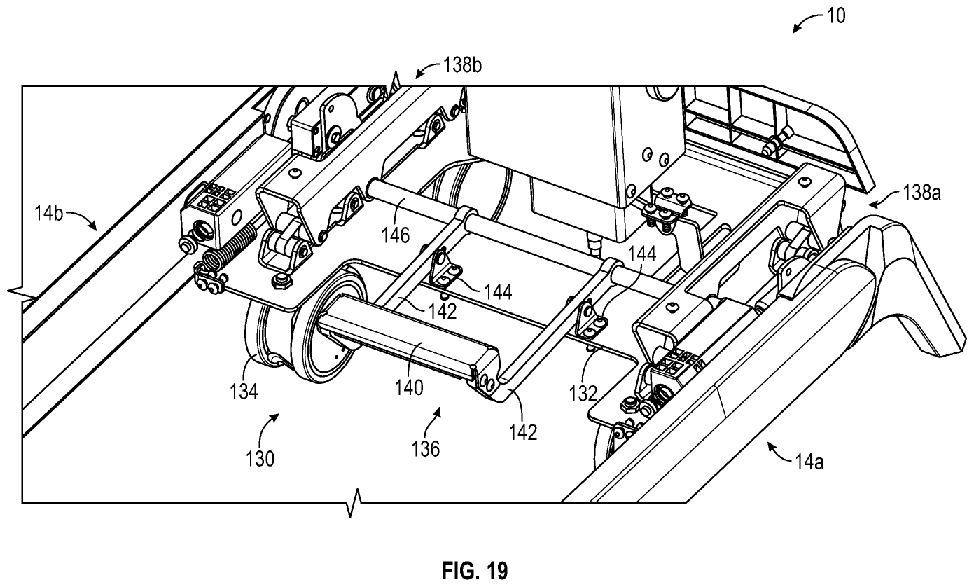

With specific reference to FIGS. 19-24, the caster linkage assembly 138 includes a first or right linkage assembly 138a and a second of left linkage assembly 138b. The first caster linkage assembly 138a includes the same components as the same components and is symmetric to the second linkage assembly 138b about the center plane 22. As such, the following description herein of the first linkage assembly 138a applies symmetrically to the second linkage assembly 138b and vice versa, with like features identified using similar reference numerals and the “a” suffix referring to the first side and the “b” suffix referring to the second side. In some embodiments, the first linkage assembly 138a defines a four-bar linkage between the base 12 and the caster plate 132. For example, the fist linkage assembly 138a incudes a base bracket 148a that is coupled to the base 12 so that the base bracket 148a is fixed to the base 12 and does not move relative to the base 12. The first linkage assembly 138a further includes a first caster link 150a, a second caster link 152a, and a third caster link 154a. The first caster link 150a is arranged adjacent to the front side 34 of the base 12, the third caster link 154a is arranged furthest from the front side 34 of the base 12, and the second caster link 152a is arranged between the first caster link 150a and the third caster link 154a.

The first caster link 150a is pivotally coupled between a first plate bracket 156a and the base bracket 148a, the second caster link 152a is pivotally coupled between a second plate bracket 158a and the base bracket 148a, and the third caster link 154a is pivotally coupled between a third plate bracket 160a and the base bracket 148a. Each of the first plate bracket 156a, the second plate bracket 158a, and the third plate bracket 160a is rigidly coupled or fixed to the caster plate 132. A biasing element, shown as caster spring 162a, is coupled between the caster plate 132 and the base bracket 148a. Specifically, the caster spring 162a is coupled between the third plate bracket 160a and the base bracket 148a at a location where the second caster link 152 couples to the base bracket 148a. In the illustrated embodiment, the caster spring 162a provides a tensile force between the caster plate 132 and the base bracket 148a, which acts to maintain the caster plate 132 in the retracted position. In some embodiments, the caster spring 162a may provide a compressive force between the caster plate 132 and the base bracket 148a, which acts to pivot the caster plate toward the extended position. In some embodiments, the caster spring 162a is in the form of a gas spring, an air spring, or a coil spring.

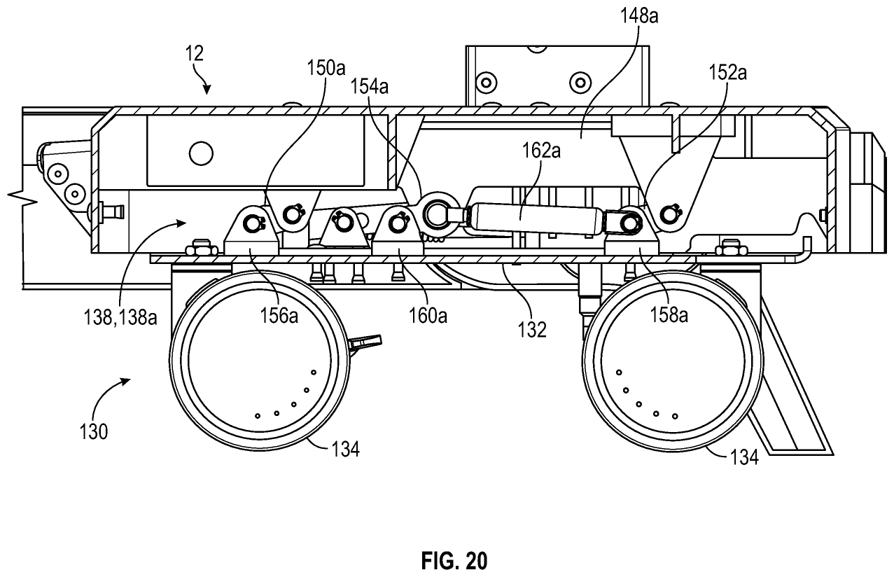

During operation, when the platform assembly 18 is in the folded position, a user may access the pedal 140 to deploy to the caster assembly 130 into the extended position. Like the handle 110, when the platform assembly 18 is in the working position, the platform assembly 18 covers the pedal 140. Once a user can access the pedal 140, a user may step on or otherwise provide a force on the pedal 140 in a caster deployment direction 164 (e.g., a direction toward or perpendicular to the ground). The force applied to the pedal 140 provides a pivotal force on the caster plate 132, which acts against the force of the caster spring 162a. Once the force on the caster plate 132 from the pedal 140 overcomes the force of the caster springs 162a, 162b, the first caster link 150a, the second caster link 152a, and the third caster link 154a all pivot in a first pivot direction 166 (e.g., counterclockwise from the perspective of FIG. 20), which moves the caster plate 132 relative to the base 12 and extends the caster plate 132 and the caster wheels 134 coupled thereto to the extended position where the caster wheels 134 engage the ground. As such, a user may selectively apply a force on the pedal 140 to deploy the caster assembly 130 into the extended position, which supports the lift device 10 on the caster assembly 130 prior to a user transitioning the outrigger assemblies 14a, 14b from the deployed position to the stowed position.

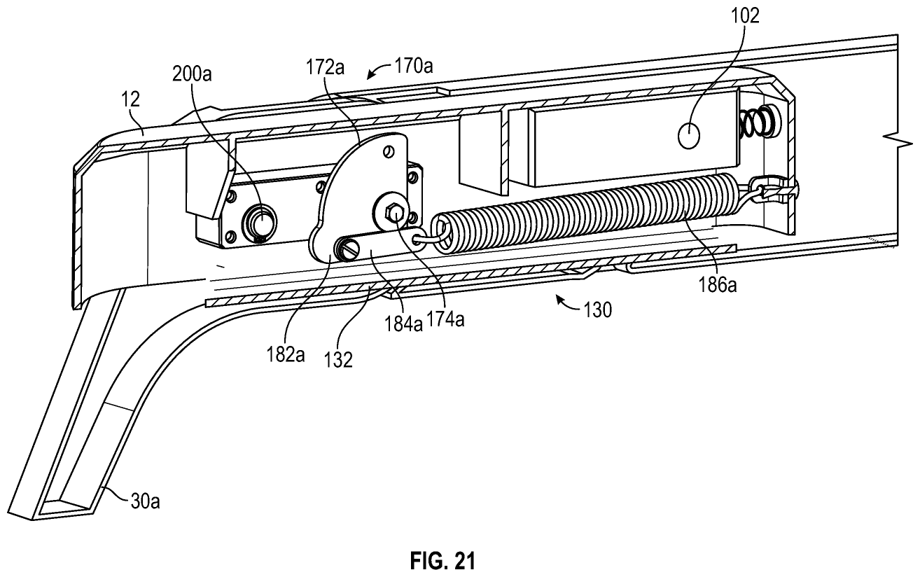

In some embodiments, transitioning the front outrigger legs 28a, 28b from the deployed position to the stowed position maintains the caster assembly 130 in the extended position. For example, the front outrigger legs 28a, 28b are each rotatably coupled to a cam assembly 170a, 170b, respectively. The cam assembly 170a includes the same components and is symmetric to the cam assembly 170b about the center plane 22. As such, the following description herein of the cam assembly 170a applies symmetrically to the cam assembly 170b and vice versa, with like features identified using similar reference numerals and the “a” suffix referring to the first side and the “b” suffix referring to the second side. With reference to FIGS. 21-24, the cam assembly 170a includes a cam plate 172a that is coupled to and rotatable with a pivot shaft 174a. The front outrigger leg 28a is pivotally coupled to the base 12 via the pivot shaft 174a, which extends through and into the base 12. A head 176a of the pivot shaft 174a is received within an aperture or recess 178a formed in the front outrigger leg 28a (see, e.g., FIG. 15). The shape of the head 176a is complementary to the shape of the recess 178a and the shape of the head 176a and the recess 178a define a geometry that rotatably fixes the front outrigger leg 28a to the pivot shaft 174a so that rotation of the front outrigger leg 28a results in the same rotation of the pivot shaft 174a. In other words, the geometry defined by the head 176a and the recess 178a prevents relative rotation between the front outrigger leg 28a and the pivot shaft 174a. In the illustrated embodiment, the head 176a and the recess 178a define a hexagonal shape. In some embodiments, the head 176a and the recess 178a may define a triangular shape, a rectangular shape, a pentagonal shape, an oval shape, an oblong shape, or another polygonal shape that prevents relative rotation between the front outrigger leg 28a and the pivot shaft 174a.

The pivot shaft 174a defines a front outrigger pivot axis 180a (e.g., a lateral axis) and the front outrigger leg 28a is configured to pivot about the front outrigger pivot axis 180a when transitioning between the deployed position and the stowed position. The cam plate 172a is rotatably fixed to an end of the pivot shaft 174a within the base 12 so that rotation of the front outrigger leg 28a results in the same rotation of the cam plate 172a. The cam plate 172a is arranged generally above the caster plate 132 and includes a cam lobe 182a that protrudes outwardly from an outer periphery of the cam plate 172a. The cam plate 172a is pivotally coupled to a cam linkage 184a and the cam linkage 184a is coupled to a cam spring 186a that extends between the cam linkage 184a and an internal surface of the base 12. The cam spring 186a provides a rotational force on the cam plate 172a that biases the cam lobe 182a in a direction toward the caster plate 132 (e.g., in a counterclockwise direction from the perspective of FIG. 21).

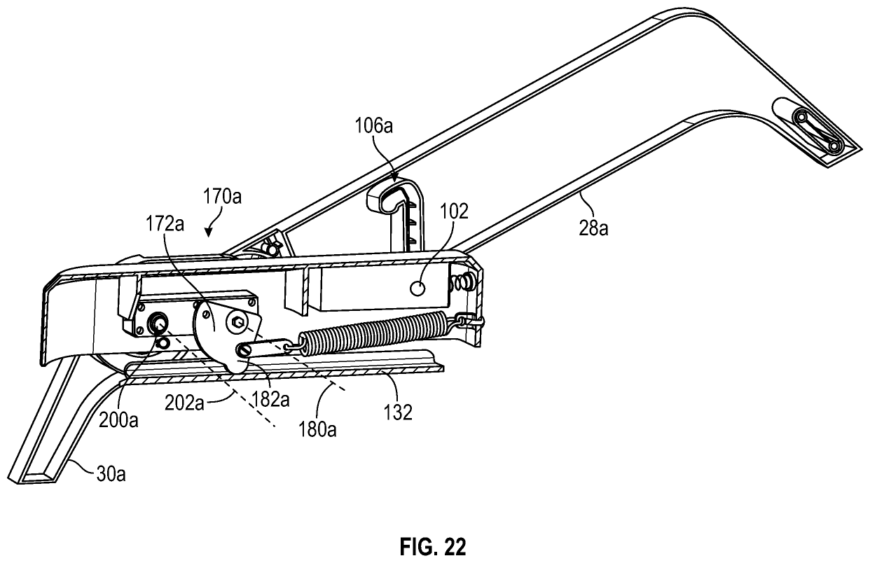

In operation, when the front outrigger leg 28a is pivoted about the front outrigger pivot axis 180a from the deployed position (FIG. 21) toward the stowed position (FIG. 22), the pivot shaft 174a rotates, which simultaneously rotates the cam plate 172a so that the cam lobe 182a rotates toward and engages the caster plate 132. The cam spring 186a provides a biasing force that acts to maintain the cam lobe 182a in engagement with the caster plate 132. The engagement between the cam lobe 182a and the caster plate 132 maintains the caster assembly 130 in the extended position and prevents the caster assembly 130 from pivoting to the retracted position, while the front outrigger legs 28a, 28b are in the folded position. In this way, for example, moving the front outrigger legs 28a, 28b to the stowed position ensures that the caster assembly 130 stays in the extended position and the caster wheels 134 engage the ground to support the lift device 10. With the platform assembly 18 and the guardrail assembly 20 in the folded position, the outrigger assemblies 14a, 14b in the stowed position, and the caster assembly 130 in the extended position, the lift device 10 may be moved by a user and rolled around via the caster wheels 134 to reposition the lift device 10. If the front outrigger legs 28a, 28b are pivoted back to the deployed position, the cam lobe 182a is rotated out of engagement with the caster plate 132 (FIG. 21), which allows the caster assembly 130 to pivot back to the retracted position and the feet 32a, 32b support the lift device 10.

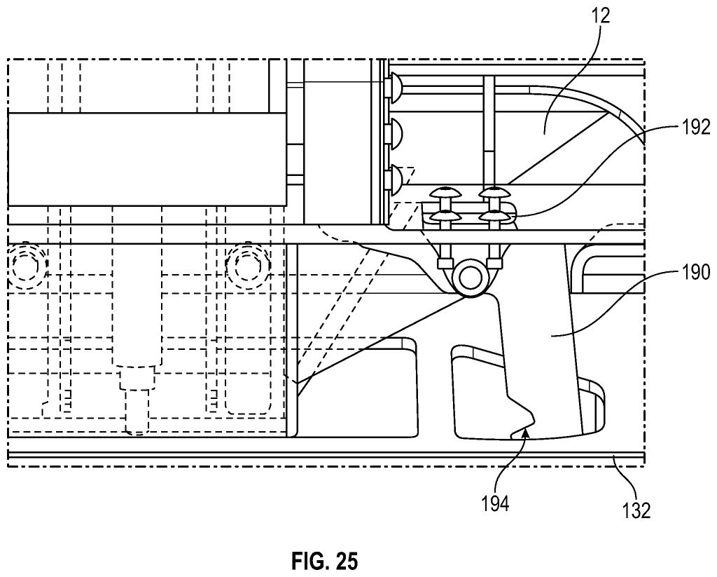

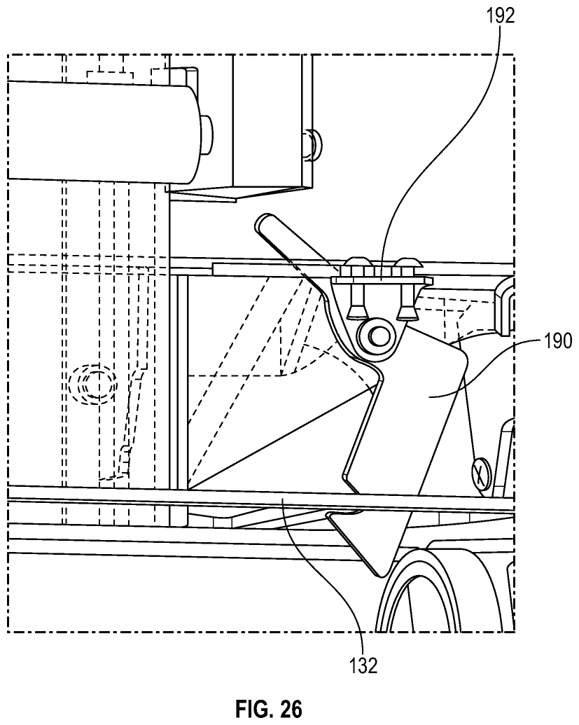

With reference to FIGS. 25 and 26, a wheel lock catch or wheel lock plate 190 is pivotally coupled to a top surface of the base 12 via a bracket 192. The wheel lock plate 190 includes a recess or notch 194 formed in a distal end thereof. In some embodiments, the wheel lock plate 190 is biased by a torsion spring so that the notch 194 is rotatably biased in a direction toward the caster plate 132 (e.g., clockwise from the perspective of FIGS. 25 and 26). During operation, the wheel lock plate 190 is configured to engage with the outer mast section 44, when the outer mast section 44 is lowered to the base 12 (FIG. 26). When the outer mast section 44 is lowered to the base 12, the outer mast section 44 engages the wheel lock plate 190 and pivots the notch 194 away from the caster plate 132, which allows the caster plate 132 to move to the extended position. When the outer mast section 44 is extended or raised above the base 12, the wheel lock plate 190 pivots the notch 194 toward the caster plate 132 so that a portion of the caster plate 132 is received within the notch 194. In this way, for example, the caster plate 132, and the caster wheels 134, are prevented from moving to the extended position when the outer mast section 44 is raised or extended above the base 12.

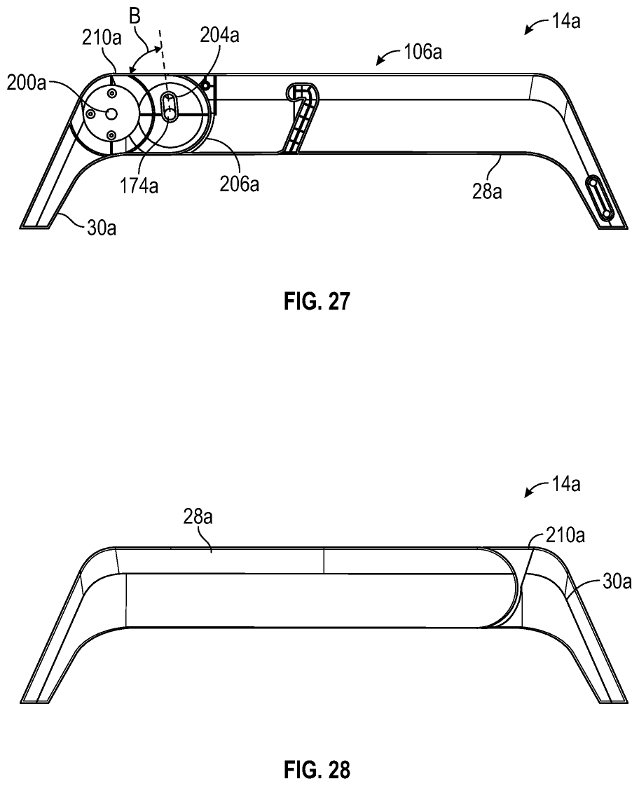

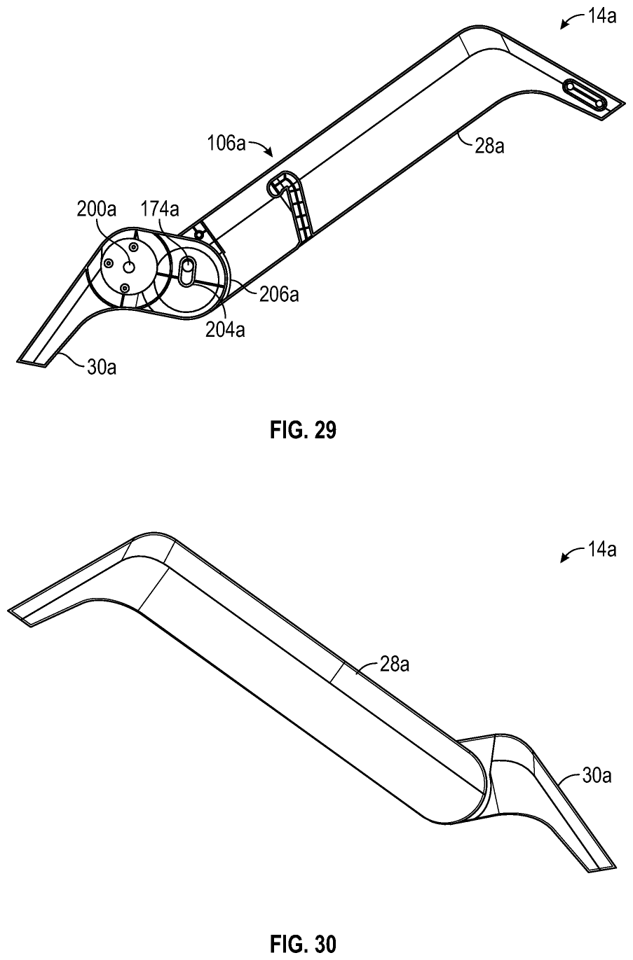

With reference to FIGS. 21, 22, and 27-30, the rear outrigger legs 30a, 30b are configured to pivot about a rear outrigger pivot axis 202a, which is spaced from and different than the front outrigger pivot axis 180a, 180b, to move the rear outrigger legs 30a, 30b between the deployed position and the stowed position. It should be appreciated that although the following description is made with reference to the front outrigger leg 28a and the rear outrigger leg 30a, the description symmetrically applies to the front outrigger leg 28b and the rear outrigger leg 30b. The rear outrigger leg 30a is pivotally coupled to the base 12 by a rear pivot shaft 200a, which defines a rear outrigger pivot axis 202a. The rear outrigger leg 30a includes an aperture or slot 204a that extends through the rear outrigger leg 30a. The pivot shaft 174a extends through the slot 204a, and the slot 204a defines a longitudinal length that is greater than a diameter of the pivot shaft 174a so that a gap is arranged between the pivot shaft 174a and the periphery of the slot 204a, when the rear outrigger leg 30a is in the deployed position (see, e.g., FIGS. 27-28). In general, with the longitudinal length of the slot 204a being larger than the diameter of the pivot shaft 174a, the rear outrigger leg 30a is allowed to pivot about the rear outrigger axis 202a between the deployed position and the stowed position where the foot 32a is pivoted relative to the base 12 (e.g., in a direction away from the ground, or in a clockwise direction from the perspective of FIGS. 27 and 29). The longitudinal length of the slot 204a defines the amount of pivotal movement allowed by the rear outrigger leg 30a (e.g., due to the pivot shaft 174a contacting the ends of the slot 204a).

The front outrigger leg 28a includes a wall or ramped surface 206a arranged on an inner surface thereof. When the front outrigger leg 28a is in the deployed position (see, e.g., FIG. 27), the ramped surface 206a extends below at least a portion of the rear outrigger leg 30a so that the rear outrigger leg 30a is prevented from pivoting from the deployed position to the stowed position. For example, when the rear outrigger leg 30a pivots toward the stowed position, a front portion 208a of the rear outrigger leg 30a pivots downward and the foot 32a pivots upward. Accordingly, when the front outrigger leg 28a is in the deployed position, the ramped surface 206a prevents the front portion 208a from pivoting downward and, thereby, prevents the rear outrigger leg 30a from pivoting to the stowed position. It follows that when the outrigger locking assemblies 100 lock the front outrigger legs 28a, 28b in the deployed position, the rear outrigger legs 30a, 30b are also locked in the deployed position. Once the front outrigger leg 28a is unlocked by the outrigger locking assembly 100 and pivoted to the folded position, the ramped surface 206a pivots or rotates away from extending below the front portion 208a (e.g., the ramped surface 206a is not arranged below the front portion 208a) of the rear outrigger leg 30a and the rear outrigger leg 30a is then allowed to pivot to the stowed position.

In some embodiments, the slot 204a is angled relative to a top surface 210a of the rear outrigger leg 30a. For example, a center axis 212a defined longitudinally along the slot 204a may angled relative to the top surface 210a so that an angle B is formed between the center axis 212a and the top surface 210a. In some embodiments, the angle B is an acute angle. In some embodiments, the angle B is between about sixty degrees and about eighty-five degrees, or between about sixty-five degrees and about eighty-five degrees, or between about seventy degrees and about eighty-five degrees, or between about seventy-five degrees and about eighty-five degrees, or between about eighty degrees and about eighty-five degrees. In general, the angle B formed between the center axis 212a and the top surface 210a is designed to ensure that the rear outrigger leg 30a pivots about a circular path relative to the rear outrigger pivot axis 202a and prevents contact or sticking between the rear outrigger leg 30a and the front outrigger leg 28a due to the rear outrigger leg 30a translating relative to the front outrigger leg 28a.

In some embodiments, the rear outrigger legs 30a, 30b are manually pivoted between the deployed position and the stowed position, for example, by a user grabbing the rear outrigger legs 30a, 30b and pivoting the rear outrigger legs 30a, 30b about the rear outrigger pivot axes 202a, 202b. In other embodiments, the rear outrigger legs 30a, 30b are biased toward the stowed position by a biasing element, such as a spring.

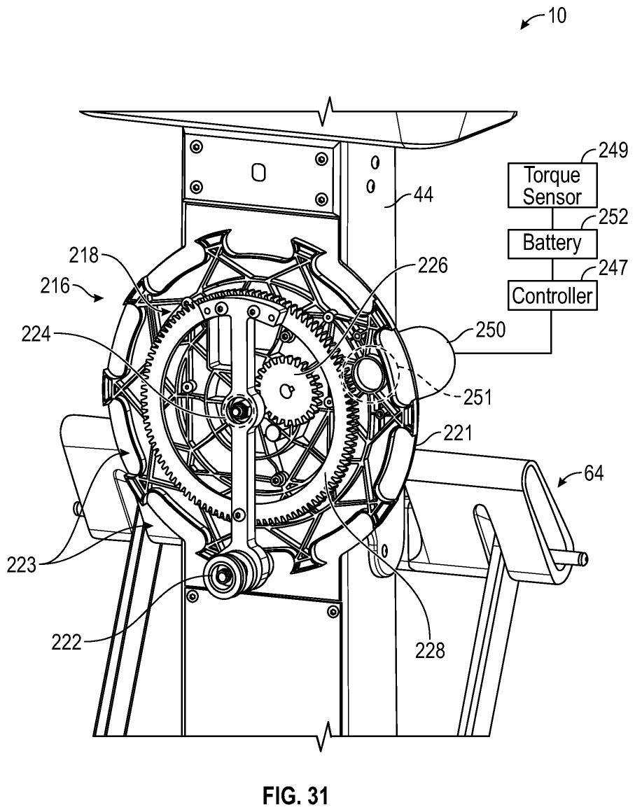

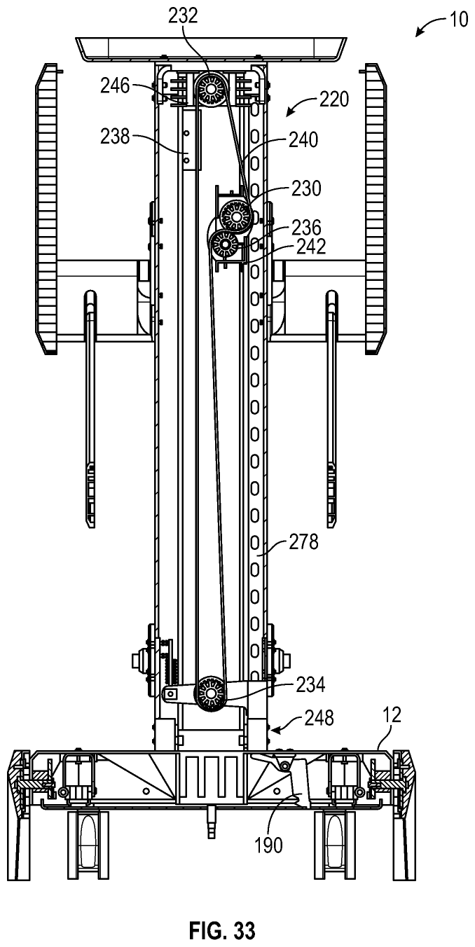

With reference to FIGS. 31-33, the inner mast section 42 is coupled to the outer mast section 44 by a lift mechanism or a pulley mechanism, shown as crank assembly 216. The crank assembly 216 is configured to be selectively manipulated or displaced (e.g., rotated) by a user on the platform assembly 18 to raise/extend or lower retract the outer mast section 44 (and the platform assembly 18 and the guardrail assembly 20 coupled thereto) relative to the inner mast section 42 and the base 12. In general, the crank assembly 216 includes a geartrain that is coupled to a belt and pulley assembly. Specifically, the crank assembly 216 includes a geartrain assembly 218 and a pulley assembly 220. The geartrain assembly 218 is coupled to the front side 34 of the outer mast section 44 by a support plate 221 and includes a handle 222, a drive gear 224, a driven gear 226, and an outer gear 228. The support plate 221 includes a plurality of stop slots 223 circumferentially spaced around an outer periphery of the support plate 221. In some embodiments, the handle 222 is biased in a direction toward the support plate 221 (e.g., via a spring) so that a portion of the handle 222 extends into one of the stop slots 223, which prevents the handle 222 from undesirably rotating under the weight supported by the outer mast section 44. As such, to facilitate rotation of the handle 222, the handle 222 may first be pulled in a direction away from the support plate 221 to disengage the handle 222 from one of the stop slots 223, and then the handle 222 may be rotated in a desired direction to raise and lower the outer mast section 44, the platform assembly 18, and the guardrail assembly 20 relative to the inner mast section 42 and the base 12.

The handle 222 is rotatably fixed to the drive gear 224 and the outer gear 228 so that rotation of the handle 222 results in the same rotation of the drive gear 224 and the outer gear 228. The driven gear 226 is rotatably coupled to the drive gear 224 so that rotation of the drive gear 224 results in rotation of the driven gear 226 at a predetermined gear ratio. The driven gear 226 is rotatably fixed to the pulley assembly 220 so that rotation of the driven gear 226 results in rotation of the pulley assembly 220.

The pulley assembly 220 is coupled between the inner mast section 42 and the outer mast section 44 so that rotation of the pulley assembly 220 is configured to raise and lower the outer mast section 44, the platform assembly 18, and the guardrail assembly 20 relative to the inner mast section 42 and the base 12.

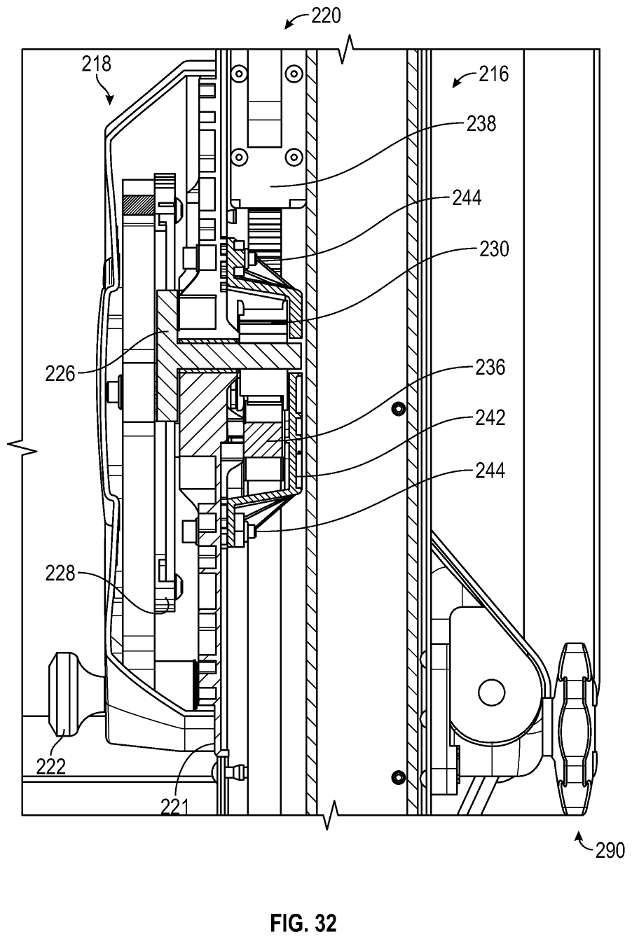

The pulley assembly 220 includes a first pulley wheel 230, a second pulley wheel 232, a third drive pulley wheel 234, an idler wheel 236, a belt locker 238, and a tensile member or timing belt, shown as toothed belt 240. The first pulley wheel 230 is rotatably coupled to the driven gear 226 so that rotation of the driven gear 226 results in the same rotation of the first pulley wheel 230. The toothed belt 240 is coupled and extends around each of the first pulley wheel 230, the second pulley wheel 232, the third pulley wheel 234, and the idler wheel 236. Each of the first pulley wheel 230, the second pulley wheel 232, the third pulley wheel 234, and the idler wheel 236 is coupled to the outer mast section 44 so that they raise and lower relative to the inner mast section 42 with the outer mast section 44. For example, the first pulley wheel 230 and the idler wheel 236 are coupled to the outer mast section 44 by a support bracket 242 via fasteners 244 that extend through the support plate 221 and into the support bracket 242 (see, e.g., FIG. 32). The second pulley wheel 232 is arranged adjacent to a top of the outer mast section 44 and is coupled to the outer mast section 44 by an upper bracket 246. The third pulley wheel 234 is arranged adjacent to a bottom of the outer mast section 44 and is coupled to the outer mast section 44 by a tension arm assembly 248.

The belt locker 238 is rigidly coupled to the inner mast section 42 and to the toothed belt 240 so that belt locker 238 cannot displace relative to the inner mast section 42. During operation, rotation of the handle 222 in a first direction (e.g., clockwise) results in rotation of the first pulley wheel 230 and the toothed belt 240 in a second direction (e.g., counterclockwise). Because the belt locker 238 is rigidly coupled to both the toothed belt 240 and the inner mast section 42, rotation of the toothed belt 240 in the second direction forces the outer mast section 44 to displace (e.g., extend or raise) relative to the inner mast section 42 and the base 12. If the outer mast section 44 is raised or extended above the base 12, then rotation of the handle 222 in the second direction (e.g., counterclockwise) results in rotation of the first pulley wheel 230 and the toothed belt 240 in the first direction (e.g., clockwise) and the outer mast section is forced to displace (e.g., retract or lower) relative to the inner mast section 42.

With specific reference to FIG. 31, the crank assembly 216 includes a lift assist motor 250 that is coupled to and mounted on the support plate 221. In some embodiments, the lift assist motor 250 is at least partially received within a recess formed in the support plate 221. In some embodiments, the lift assist motor 250 is an electric motor that is powered by a battery 252 of the lift device 10. The lift assist motor 250 is configured to selectively rotate in the first direction (e.g., counterclockwise), for example, in response to a user input to the handle 222. For example, the lift assist motor 250 is in communication with a controller 247, and the controller 247 (e.g., a processing circuit having a processor and memory storing instructions that are executed by the processor) is in communication with a torque sensor 249. In some embodiments, the torque sensor 249 is coupled to the handle 222 and configured to detect a magnitude and a direction of a torque applied by a user to the handle 222. In response to detecting the torque from the torque sensor 249 in the first direction, which is indicative of a user raising the outer mast section 44, the platform assembly 18, and the guardrail assembly 20, the controller 247 is configured to instruct the lift assist motor 250 to rotate in the first direction that to generate an assisting torque that aids a user in rotating the handle 222 (e.g., reduce a torque required to rotate the handle 222 in the first direction) to raise the outer mast section 44, the platform assembly 18, and the guardrail assembly 20 relative to the inner mast section 42 and the base 12.

In some embodiments, the torque sensor 249 is coupled to the lift assist motor 250 and configured to detect a magnitude and direction of the torque that is applied to the lift assist motor 250 via the geartrain assembly 218. For example, the lift assist motor 250 is rotatably coupled to the outer gear 228 by a pinion motor 251 so that rotation of the lift assist motor 250 results in the same rotation of the outer gear 228. Because the outer gear 228 is coupled to the drive gear 224 via the handle 222, rotation of the outer gear 228, via the lift assist motor 250, applies supplemental torque to the rotation of the drive gear 224 by the handle 222, and thereby rotation of the pulley assembly 220 and the toothed belt 240 is made easier by the lift assist motor 250. For example, the lift assist motor 250 is configured to rotate in the first direction to generate a first assisting torque on the outer gear 228, and thereby on the drive gear 224 and the pulley assembly 220, in the first direction to assist in raising the outer mast section 44, the platform assembly 18, and the guardrail assembly 20 relative to the inner mast section 42 and the base 12. Accordingly, the lift assist motor 250 makes it easier for a user to raise of the outer mast section 44, the platform assembly 18, and the guardrail assembly 20 relative to the inner mast section 42 and the base 12.

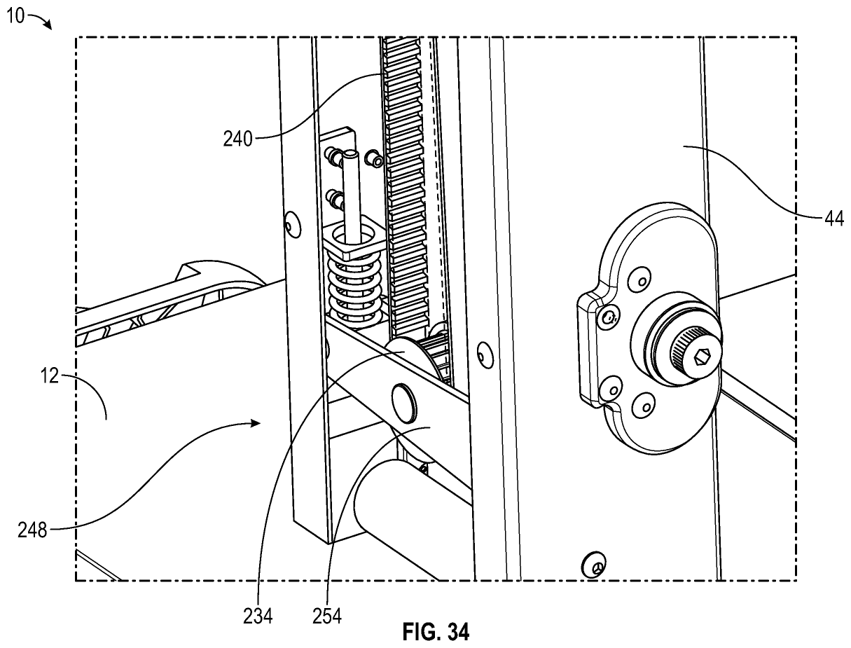

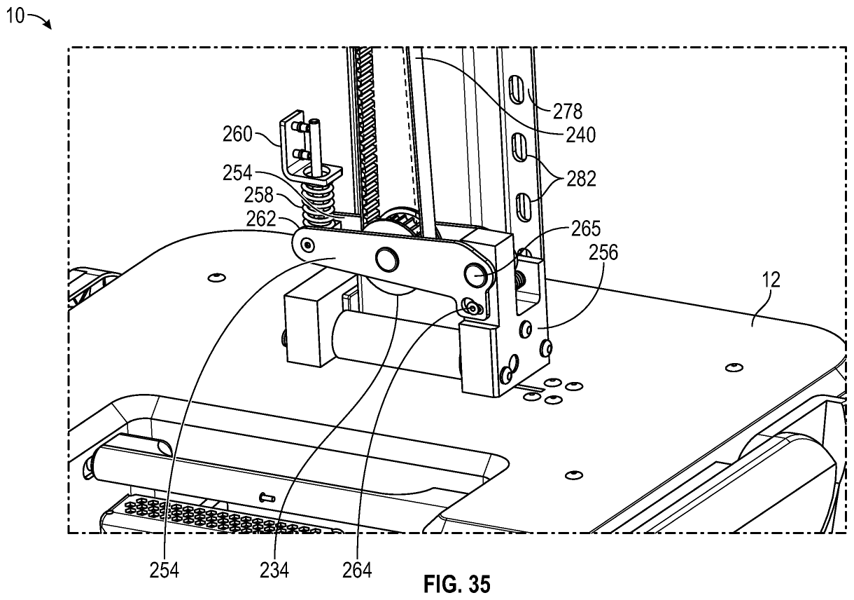

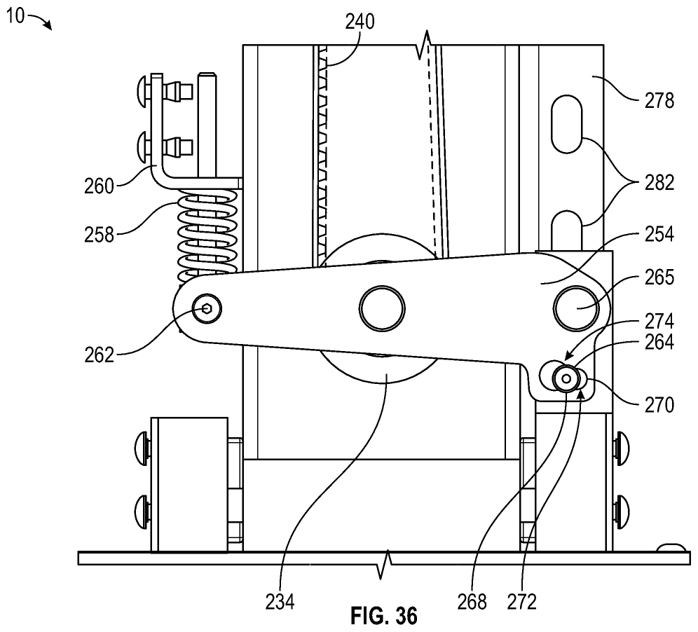

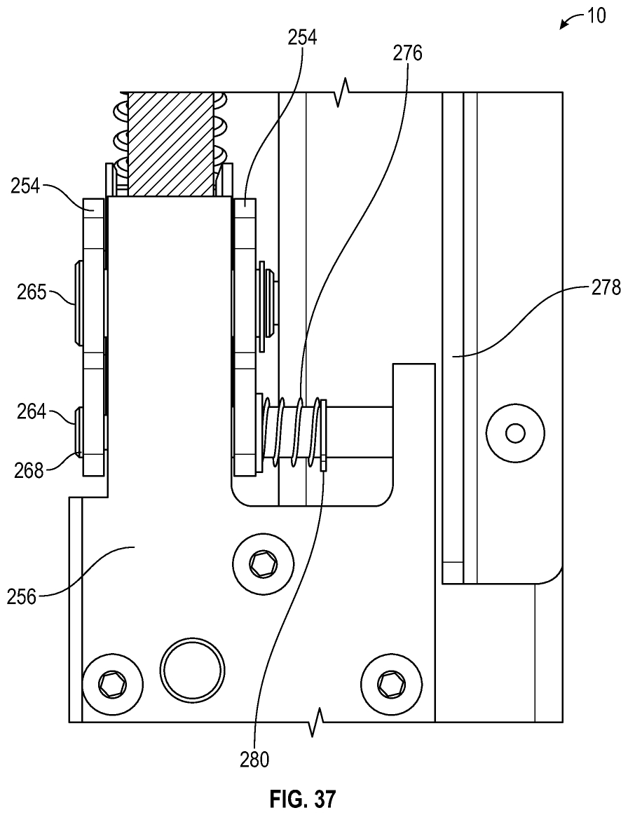

With reference to FIGS. 34-37, the tension arm assembly 248 includes a pair of tension arms 254, a pivot bracket 256, a tension spring 258, a spring bracket 260, a spring guide 262, and a locking pin 264. At first end of the tension arms 254 is pivotally coupled to the pivot bracket 256 via a pivot pin 265, which defines a pivot axis for the tension arms 254. The tension arms 254 are coupled to opposing sides of the third pulley wheel 234, and the spring guide 262 is coupled to and extends between a second end of the tension arms 254. The pivot bracket 256 is coupled to the outer mast section 44 so that the pivot bracket 256, and the tension arms 254 and the locking pin 264 coupled thereto displace relative to the inner mast section 42 with the outer mast section 44. The spring bracket 260 is coupled to the outer mast section 44 so that the spring bracket 260 displaces relative to the inner mast section 42 with the outer mast section 44. The tension spring 258 is biased between the spring bracket 260 and a surface (e.g., an upper surface) of the spring guide 262 so that the tension spring 258 generates a force on the tension arms 254, and thereby on the third pulley wheel 234, in a tension direction 266 (e.g., a downward direction from the perspective of FIG. 36). The force provided by the tension spring 258 in the tension direction 266 acts to maintain tension on the toothed belt 240.

The locking pin 264 is coupled to and extends through the tension arms 254 and the pivot bracket 256. The locking pin 264 includes a head 268 that is configured to interface with a cutout 270 that is formed in at least one of the tension arms 254. In some embodiments, the cutout 270 is formed in a first or front arm of the tension arms 254 (e.g., the tension arm arranged furthest from the inner mast section 42). In some embodiments, the cutout 270 is formed in both of the tension arms 254. In general, the cutout 270 is shaped to selectively abut the head 268 of the locking pin 264 or allow the head 268 of the locking pin 264 to pass through the cutout 270. The cutout 270 extends through the tension arm 254 and includes a first or blocking portion 272 and a second or unblocking portion 274. The blocking portion 272 defines a diameter or largest internal dimension that is less than a diameter of the head 268 of the locking pin 264. The unblocking portion 274 defines a diameter or largest internal dimension that is greater than the diameter of the head 268 of the locking pin 264.

The locking pin 264 is coupled to a locking spring 276 that is configured to generate a force on the locking pin 264 that biases the locking pin 264 in a direction toward a locking rail 278. In some embodiments, the locking pin 264 is biased between the pivot bracket 256 and a snap ring 280 that is coupled to the locking pin 264 so that the locking spring 276 is in compression and biases the locking pin 264 toward the locking rail 278. The locking rail 278 is coupled to a side of the inner mast section 42 and includes a plurality of spaced locking apertures or slots 282 that are formed along a longitudinal length of the locking rail 278. In some embodiments, the locking rail 278 extends along an entire longitudinal length of the inner mast section 42.

As described herein, during operation, the tension spring 258 is configured to provide a tension force on the tension arms 254 and the third pulley wheel 234, which maintains tension on the toothed belt 240. While the toothed belt 240 is coupled to the third pulley wheel 234, the tension on the toothed belt 240 maintains the tension arms 254 in a blocking position where the head 268 of the locking pin 264 is aligned with or at least partially overlaps the blocking portion 272 of the cutout 270. The smaller diameter or size of the blocking portion 272 relative to the diameter of the head 268 ensures that the head 268 engages the tension arm 254 and is prevented from translating relative to the locking rail 278. However, in the event of a belt failure (e.g., the toothed belt 240 breaks and decouples from the third pulley wheel 234) while the outer mast section 44 is raised or extended relative to the inner mast section 42, the tension force provided on the tension arms 254 by the tension spring 258 is no longer balanced by the tension of the toothed belt 240, and the tension arms 254 pivot about the pivot pin 265 in a first direction (e.g., toward the base 12 or counterclockwise from the perspective of FIG. 36) to an unblocking position. The pivotal movement of the tension arms 254 pivots the orientation of the head 268 of the locking pin 264 relative to the cutout 270. Specifically, the pivotal movement of the tension arms 254 in the first direction to the unblocking position moves the cutout 270 relative to the head 268 of the locking pin 264 so that the head 268 aligns with the unblocking portion 274 of the cutout 270. Because the unblocking portion 274 defines a larger diameter or size that the head 268 of the locking pin 264, the biasing force acting on the locking pin 264 by the locking spring 276 forces the locking pin 264 to displace relative to the pivot bracket 256 in a direction toward the locking rail 278. Specifically, the head 268 of the locking pin 264 is allowed to displace into the cutout 270, which allows the locking pin 264 to displace, translate, or move in a direction toward the locking rail 278 so that at least a portion of the locking pin 264 extends through one of the plurality of locking apertures 282 (e.g., one of the apertures 282 that is aligned with or directly below the locking pin 264 at the time of the belt failure).

When the locking pin 264 extends through one of the locking apertures 282, the outer mast section 44, which is coupled to the locking pin 264, is prevented from displacing relative to the inner mast section 42, which is coupled to the locking rail 278. In this way, for example, the tension arm assembly 248 and the locking pin 264 are configured to hold the outer mast section 44 relative to the inner mast section 42 and prevent further displacement (e.g., retraction or lowering) of the outer mast section 44 after a belt failure.

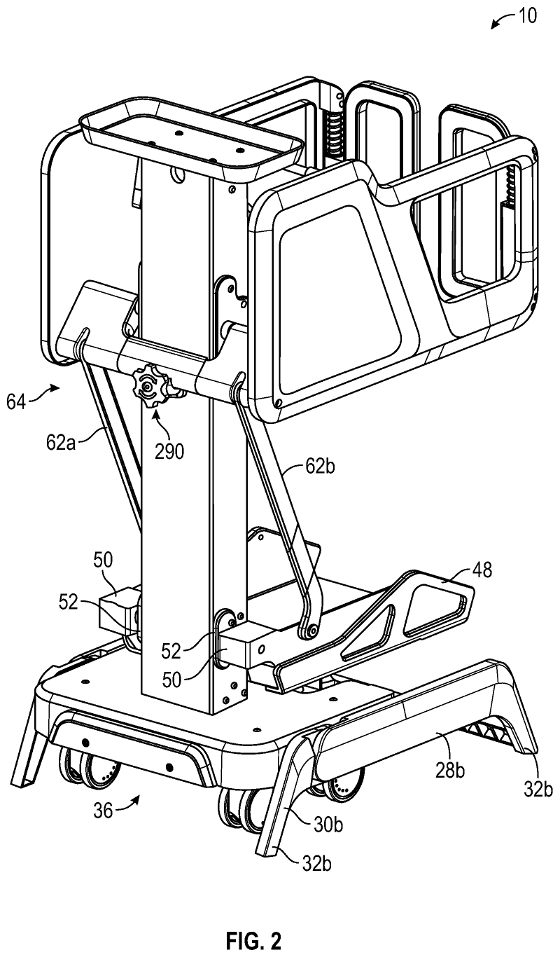

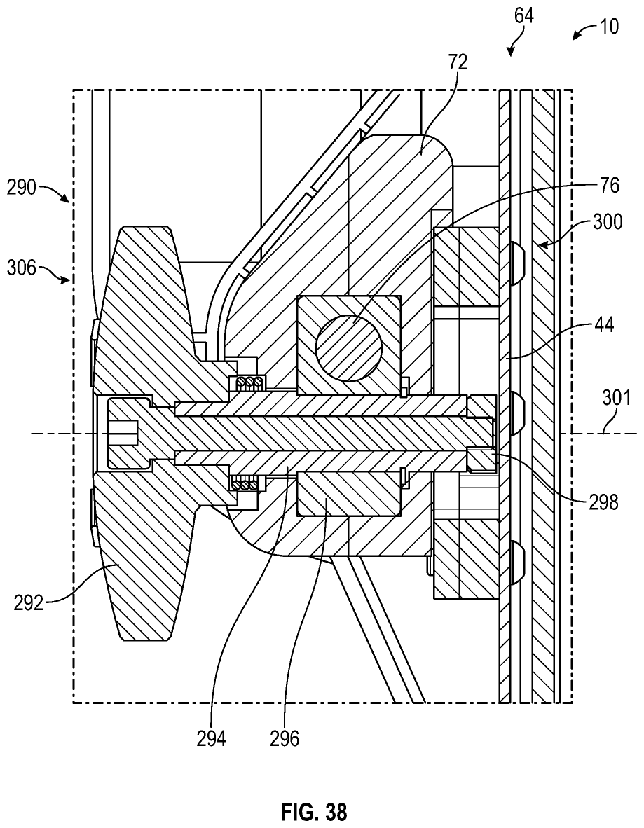

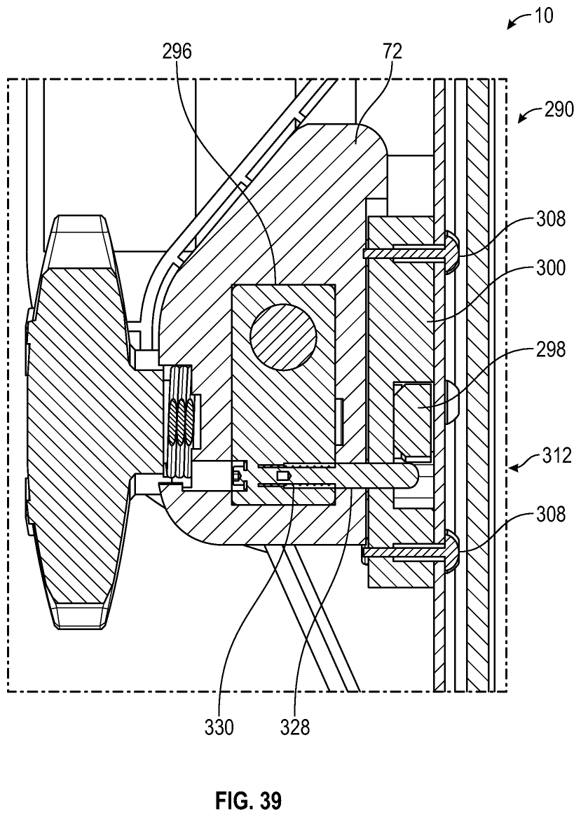

With reference to FIGS. 2, 10-13, and 38-42, the pivot assembly 64 includes a locking mechanism 290 that is configured to selectively couple the cross member 70 and the hinge rail 76 coupled thereto to the outer mast section 44 to prevent pivotal movement of the hinge rail 76 (e.g., transition from the working position to the folded position is prevented), and selectively decouple the cross member 70 and the hinge rail 76 coupled thereto from the outer mast section 44 to allow pivotal movement of the hinge rail 76 (e.g., transition from the working position to the folded position is allowed). The locking mechanism 290 includes a handle or knob 292, a lock shaft 294, an inner hub 296, a tab 298, and a locking plate 300. The handle 292 is rotatably coupled to the lock shaft 294 so that rotation of the handle 292 results in the same rotation of the lock shaft 294. For example, the handle 292 may include one or more flats that engage a corresponding flat on a proximal end of the lock shaft 294 (e.g., an end couped to the handle 292).

The lock shaft 294 extends into and through the cross member 70 and the inner hub 296, which is arranged within the cross member 70. The hinge rail 76 also extends through the inner hub 296 in a direction substantially perpendicular to the direction that the lock shaft 294 extends through the inner hub 296. A distal end of the lock shaft 294 is rotatably coupled to the tab 298 so that rotation of the handle 292 results in the same rotation of the tab 298 about a rotation axis 301 defined along a center of the lock shaft 294. In the illustrated embodiment, the distal end of the lock shaft 294 includes a flat 302 that engages a flat 304 formed on the tab 298 to rotatably couple the lock shaft 294 to the tab 298. In some embodiments, the distal end of the lock shaft 294 includes a pair of flats 302 that engage corresponding flats 304 formed in the tab 298. In some embodiments, the lock shaft 294 may be rotatably coupled to the tab 298 via a fastener or screw, or another interlocking coupling that prevents relative rotation between the lock shaft 294 and the tab 298.

The locking plate 300 is coupled to a rear side 306 of the outer mast section 44 via a plurality of fasteners 308 (e.g., screws, bolts, rivets, or an equivalent fastener). The locking plate 300 extends outwardly from the rear side 306 of the outer mast section 44 and defines an external cutout or keyhole 310 and an internal portion, cutout, or cavity 312. The external cutout 310 extends though an outer surface or wall 314 of the locking plate 300 and provides access to the internal cavity 312. In the illustrated embodiment, the external cutout 310 defines a generally rectangular, elongated shape with rounded corners. In the illustrated embodiment, the external cutout 310 extends longer in a first or vertical direction (e.g., a direction parallel to a longitudinal direction along which the outer mast section 44 extends) than in a second or horizontal direction (e.g., a direction perpendicular to the longitudinal direction along which the outer mast section 44 extends). In some embodiments, the external cutout 310 may extend longer in the second direction than in the first direction. The external cutout 310 is defines a shape that is complementary to the shape of the tab 298 and is dimensioned to be larger than the tab 298 so that the tab 298 is capable of being inserted through the external cutout 310 and into the internal cavity 312 when the tab 298 is oriented vertically.

In general, the internal cavity 312 is the same size or larger than the external cutout 310 in every dimension and is bordered or formed by a plurality of internal walls, surfaces, or shoulders of the locking plate 300. The internal walls, surfaces, or shoulders are configured to limit rotation of the tab 298 within the internal cavity 312 in both a first or locking direction and a second or unlocking direction opposite to the first or locking direction. For example, the internal cavity 312 is defined by a first shoulder 316 and a second shoulder 318. The first shoulder 316 and the second shoulder 318 are radially offset or spaced from the rotation axis 301 and circumferentially spaced from one another (e.g., about the rotation axis 301).

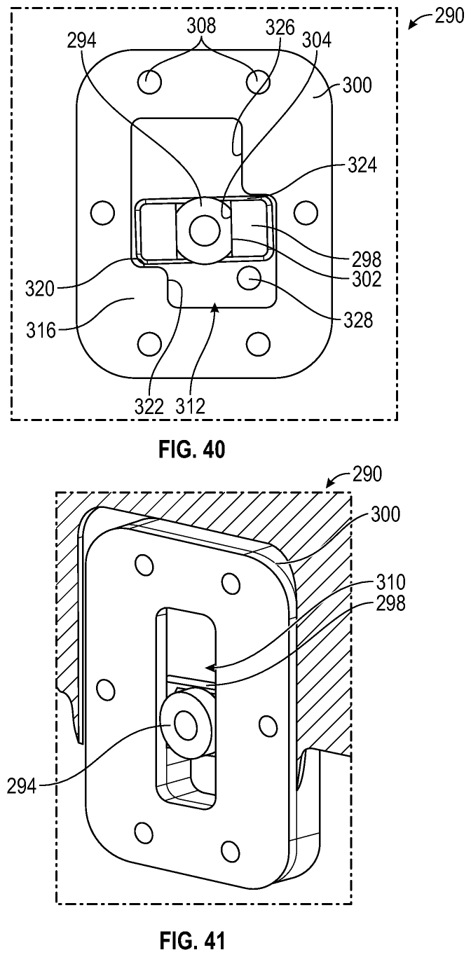

The first shoulder 316 generally opposes the second shoulder 318 so that the first shoulder 316 and the second shoulder 318 cooperate to limit rotation of the tab 298 in both the first or locking direction and the second or unlocking direction. For example, the first shoulder 316 includes a first locking surface 320 and a first unlocking surface 322, and the second shoulder 318 includes a second locking surface 324 and the second unlocking surface 326. The first locking surface 320 is arranged generally perpendicularly to the first unlocking surface 322 and the second unlocking surface 326, and generally parallel to the second locking surface 324. The first unlocking surface 322 is arranged generally perpendicularly to the first locking surface 320 and the second locking surface 324, and generally parallel to the second unlocking surface 326. The first locking surface 320 and the second locking surface 324 face in opposite directions. For example, the first locking surface 320 faces in a generally upward direction, while the second locking surface 324 faces in a generally downward direction. The first unlocking surface 322 and the second unlocking surface 326 face in opposite directions. For example, the first unlocking surface 322 faces in a generally rightward direction, while the second unlocking surface 326 faces in a generally leftward direction. In general, the opposite facing arrangement between the first locking surface 320 and the second locking surface 324 enable the first shoulder 316 and the second shoulder 318 to limit or stop rotation of the tab 298 in the first or locking direction (e.g., counterclockwise from the perspective of FIG. 40). Similarly, the opposite facing arrangement between the first unlocking surface 322 and the second unlocking surface 326 enable the first shoulder 316 and the second shoulder 318 to limit or stop rotation of the tab 298 in the second or unlocking direction (e.g., clockwise from the perspective of FIG. 40).

The locking mechanism 290 includes a detent pin 328 that is coupled to and extends through the inner hub 296. The detent pin 328 also extends through a portion of the cross member 70 and into the internal cavity 312. For example, a distal end of the detent pin 328 extends axially (e.g., parallel to the rotation axis 301) into the internal cavity 312 so that at least a portion of the detent pin 328 axially overlaps with the tab 298 so that the tab 298 contact the detent pin 328 during rotation between a locked position and an unlocked position, and vice versa. The detent pin 328 is coupled to a detent spring 330 that is configured to generate a force on the detent pin 328 that biases the detent pin 328 toward the internal cavity 312 (e.g., toward the outer mast section 44).

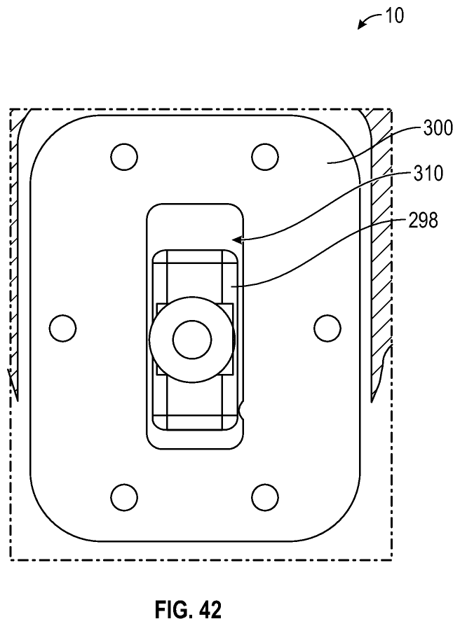

During operation, the handle 292 is configured to be rotated by a user to transition the tab 298 between a locked position (see, e.g., FIGS. 40-41) where the platform assembly 18 and the guardrail assembly 20 are held in the working position and prevented from pivoting to the folded position and an unlocked position (see, e.g., FIG. 42) where the platform assembly 18 and the guardrail assembly 20 are allowed to pivot from the working position to the folded position. To lock the platform assembly 18 and the guardrail assembly 20 with the locking mechanism 290, the user may transition the platform assembly 18 and the guardrail assembly 20 from the folded position to the working position. As the platform assembly 18 and the guardrail assembly 20 are transitioned from the folded position to the working position, the cross member 70, and the handle 292, the lock shaft 294, the tab 298, and the detent pin 328 coupled thereto, are pivoted toward the locking plate 300 (e.g., toward the outer mast section 44). The detent pin 328 may aid in maintaining the tab 298 in the unlocked position (e.g., orientated generally vertically so that the tab 298 aligns with the external cutout 310). As the platform assembly 18 and the guardrail assembly 20 reach the working position, the tab 298, which is in the unlocked position, is inserted through the external cutout 310 and into the internal cavity 312. In some embodiments, a user may be required to rotate the handle 292 to align the tab 298 with the external cutout 310 so that the tab 298 is capable of being inserted through the external cutout 310 and into the internal cavity 312.

Once the tab 298 is inserted into the internal cavity 312 in the unlocked position, the first shoulder 316 and the second shoulder 318 prevent a user from rotating the handle 292 in the unlock direction because of engagement between the tab 298 and both the first unlocking surface 322 and the second unlocking surface 326. As such, the tab 298 is only allowed to be rotated in the locking direction to the locked position. As the tab 298 is rotated in the locking direction, the tab 298 engages and extends past the detent pin 328. That is, a user must apply sufficient torque to the tab 298 to overcome the force of the detent spring 330, which forces the detent pin to retract into the inner hub 296 and allow the tab 298 to rotate past the detent pin 328 and into the locked position. The detent pin 328 aids in maintaining the tab 298 in the locked position, and the first shoulder 316 and the second shoulder 318 prevent the tab 298 from being rotated in the locking direction past the locked position via engagement between the tab 298 and both the first locking surface 320 and the second locking surface 324. Once the tab 298 is in the locked position, the tab 298 is misaligned with the external cutout 310 so that the tab 298 is prevented from being removed from the internal cavity 312 (e.g., via engagement with a border of the external cavity 310). In this way, for example, the rotation of the tab 298 to the locking position couples the cross member 70 to the outer mast section 44, maintains the platform assembly 18 and the guardrail assembly 20 in the working position, and prevents the platform assembly 18 and the guardrail assembly 20 from pivoting to the folded position.

If a user wants to transition the platform assembly 18 and the guardrail assembly 20 from the working position to the folded position, the user rotates the handle 292 in the unlocking direction (further rotation in the locking direction is prevented by the first shoulder 316 and the second shoulder 318). As the tab 298 is rotated in the unlocking direction, the tab 298 engages and extends past the detent pin 328. That is, a user must apply sufficient torque to the tab 298 to overcome the force of the detent spring 330, which forces the detent pin to retract into the inner hub 296 and allow the tab 298 to rotate past the detent pin 328 and into the unlocked position. Once the tab 298 is in the unlocked position, the tab 298 is capable of being removed from the internal cavity 312 through the external cutout 310, which decouples the cross member 70 from the outer mast section 44 and allows the platform assembly 18 and the guardrail assembly 20 to transition to the folded position.

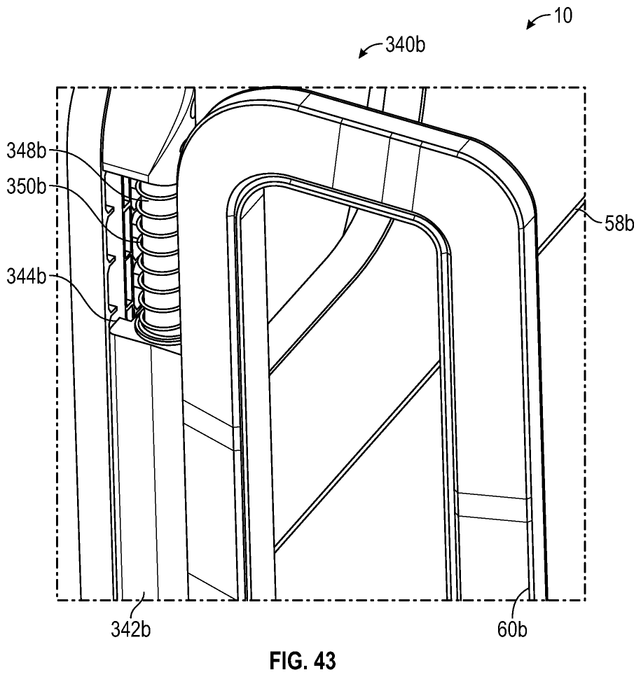

With reference to FIGS. 1-3, 8-10, and 43-46, the first gate or door 60a and the second gate or door 60b both include an automatic door hinge assembly that is configured to automatically transition the first door 60a and the second door 60b from a closed position to an open or stowed position when the guardrail assembly 20 transitions from the working position to the folded position, and automatically transition the first door 60a and the second door 60b from the open or stowed position to the closed position when the guardrail assembly 20 transitions from the folded position to the working position. For example, the first door 60a is pivotally coupled to the first guardrail 58a by a first automatic door hinge assembly 340a, and the second door 60b is pivotally coupled to the second guardrail assembly 58b by a second automatic door hinge assembly 340b. Although the automatic door hinge assembly 340b is illustrated in FIGS. 43-46, the description herein of the automatic door hinge assembly 340b, the second door 60b, and the second guardrail 58b symmetrically applies to the automatic door hinge assembly 340a, the first door 60a, and the second guardrail 58a, with like features identified using similar reference numerals and the “a” suffix referring to the first side and the “b” suffix referring to the second side.

The second door 60b includes a hinge barrel or coupling flange 342b that extends outwardly from an inner side of the second door 60b. The coupling flange 342b includes a stop surface 344b that is configured to engage a guardrail surface 346b of the second guardrail 58b, when the second door 60b is in a closed position (see, e.g., FIG. 43). The automatic door hinge assembly 340b includes a hinge rod 348b and a hinge rod spring 350b. The second door 60b is pivotally coupled to the second guardrail 58b by the hinge rod 348b.

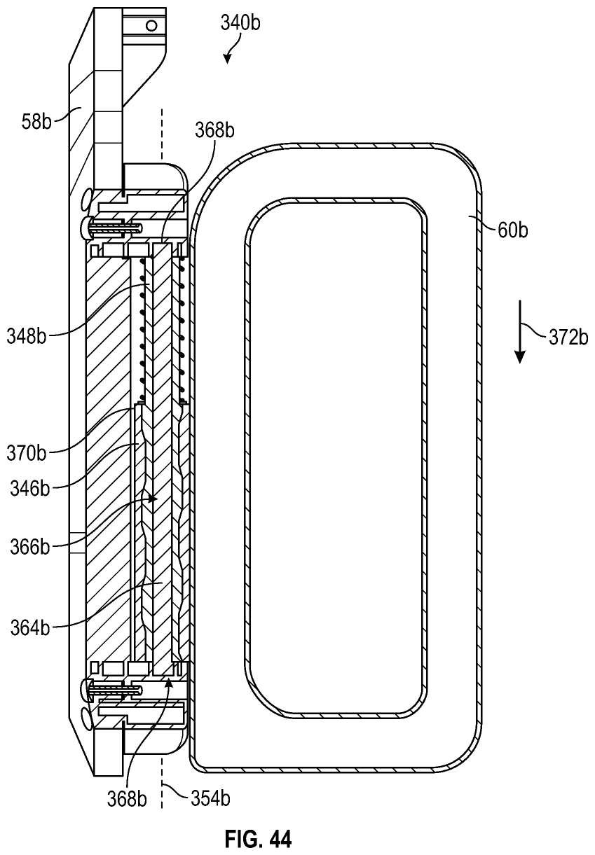

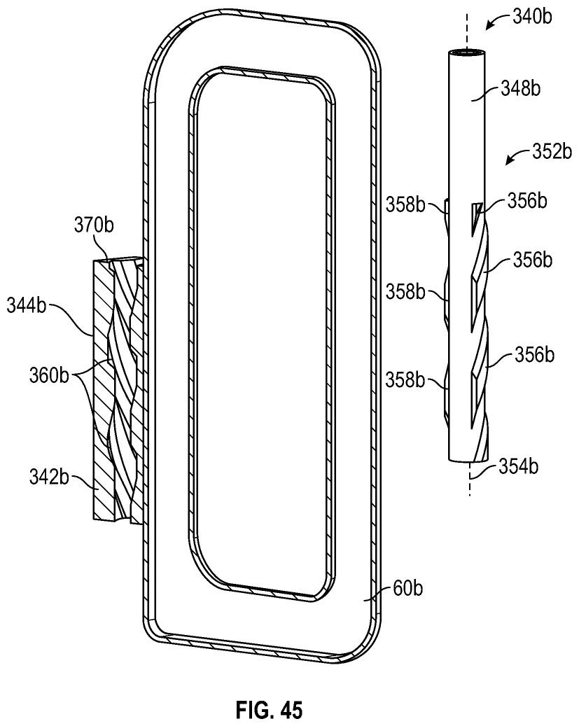

With specific reference to FIGS. 44 and 45, the hinge rod 348b includes a plurality of helical splines or protrusions 352b that protrude radially outwardly from the hinge rod 348a (e.g., relative to a center axis 354b defined along a center of the hinge rod 348b). In the illustrated embodiment, each of the helical protrusions 352b angles axially as it extends circumferentially around the hinge rod 348a. In the illustrated embodiment, the helical protrusions 352b includes a first set of helical protrusions 356b arranged on a first side of the hinge rod 348b and a second set of helical protrusions 358b arranged on a second side of the hinge rod 348b, which is circumferentially offset from the first side (e.g., by about one hundred and eighty degrees). The first set of helical protrusions 356b are axially spaced from one another along the first side of the hinge rod 348b, and the second set of helical protrusions 358b are axially spaced from one another along the second side of the hinge rod 348b.

Each of the helical protrusions 352b is configured to be received within a corresponding helical recess 360b formed within a hinge channel 362b that extends axially through the coupling flange 342b. Each of the helical recesses 360b is recessed into an inner surface of the hinge channel 362b and defines a helical shape or path as it extends axially along the hinge channel 362b. When the automatic door hinge assembly 340b is assembled, a coupling rod 364b is inserted through a center bore or channel 366b that extends axially through the hinge rod 348b. The center channel 366b of the hinge rod 348b and the coupling rod 364b define complementary geometries so that the coupling rod 364b is rotationally fixed to the hinge rod 348b. In other words, the hinge rod 348b is prevented from rotating relative to the coupling rod 364b. In some embodiments, the coupling rod 364b and the center channel 366b define a square or rectangular shape in cross section (e.g., taken in a direction perpendicular to the center axis 354b). In some embodiments, the coupling rod 364b and the center channel 366b define a triangular shape, a pentagonal shape, an oval shape, an oblong shape, or another polygonal shape that prevents relative rotation between the coupling rod 364b and the hinge rod 348b. Opposing ends of the coupling rod 364b are received within a hinge recess 368b formed in the second guardrail 58b. The hinge recesses 368b receive the ends of the coupling rod 364b and rotationally fix the coupling rod 364b and the hinge rod 348b relative to the second guardrail 58b.

The hinge rod spring 350b is biased between the second guardrail 58b and a top surface 370b of the coupling flange 342b, so that the hinge rod spring 350b generates a force on the second door 60b that biases the second door 60b in a first direction 372b toward the bottom surface 90 of the second guardrail 58b (e.g., downwardly from the perspective of FIG. 44).

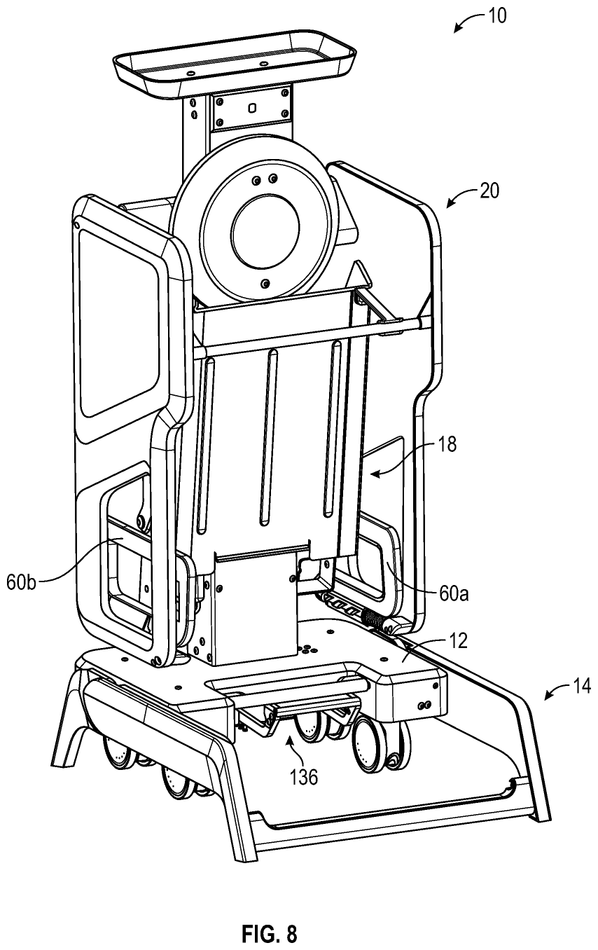

With the hinge rod 348b being rotationally fixed to the second guardrail 58b (e.g., prevented from rotating relative to the second guardrail 58b), as the second door 60b rotates or pivots relative to the second guardrail 58b about the center axis 354b, the second door 60b moves axially along the hinge rod 348b due to the interaction between the helical protrusions 352b and the helical recesses 360b. For example, as the second door 60b is pivoted from the closed position (see, e.g., FIGS. 1-3 and 43) to the open or stowed position (see, e.g., FIGS. 8-10), a free end of the second door 60b (e.g., an end not coupled to the second guardrail 58b) pivots toward the second guardrail 58b and the second door 60b translates relative to the hinge rod 348b and the second guardrail 58b along a second direction 374b (opposite to the first direction 372b) away from the bottom surface 90 of the second guardrail 58b (e.g., upwardly from the perspective of

FIG. 44). In general, the helical interaction between the helical protrusions 352b and the helical recesses 360b, and the biasing force provided by the hinge rod spring 350b enable the automatic door hinge assembly 340b to automatically transition the second door 60b between the closed position and the open or stowed position, and vice versa.

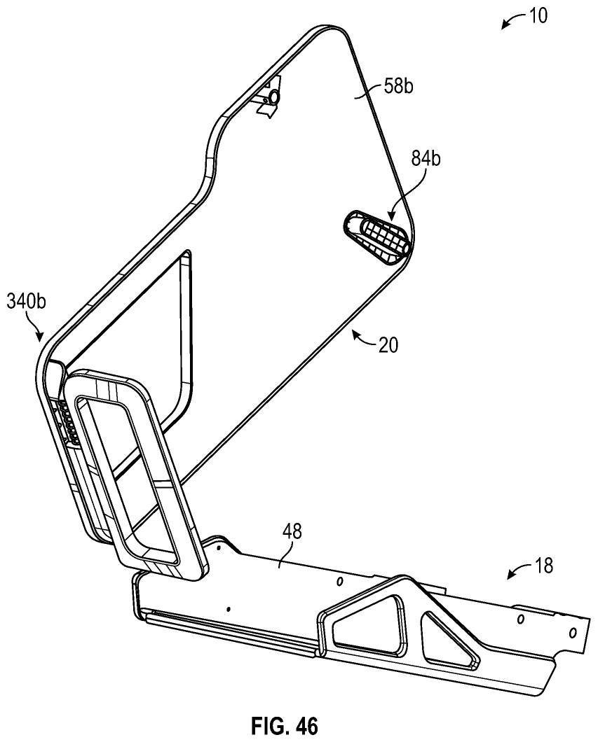

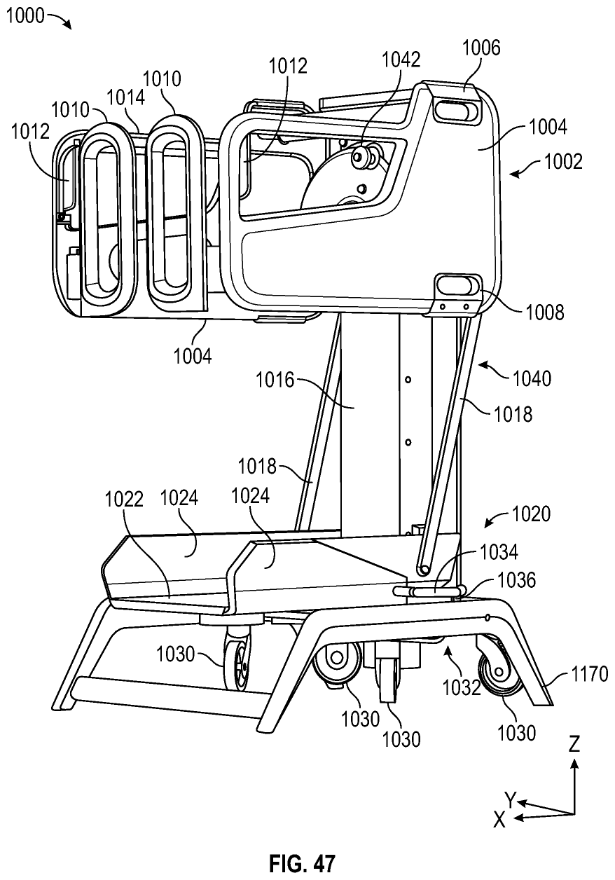

For example, when the platform assembly 18 and the guardrail assembly 20 transitions from the working position to the stowed position, the platform assembly 18 engages a bottom surface of the second door 60b (see, e.g., FIG. 46). Specifically, the sidewalls 48 are each configured to engage a bottom surface of a corresponding one of the first door 60a and the second door 60b. The engagement between the sidewall 48 of the platform assembly 18 and the second door 60b is configured to overcome the biasing force of the hinge rod spring 350b and translate the second door 60b along the hinge rod 348b in the second direction 374b, which results in the second door 60b pivoting to the open or stowed position due to the helical interaction between the helical protrusions 352b and the helical recesses 360b.

With the platform assembly 18 and the guardrail assembly 20 in the folded position, the first door 60a and the second door 60b are held in the open or stowed position via engagement with the sidewalls 48 of the platform assembly 18 (see, e.g., FIGS. 8-10). For example, the biasing force of the hinge rod springs 350a, 350b generate a force that attempts to bias the first door 60a and the second door 60b toward the closed position, but the platform assembly 18 is in the way and interferes with or prevents the first door 60a and the second door 60b from pivoting to the closed position. As the platform assembly 18 and the guardrail assembly 20 are transitioned back to the working position and the platform assembly 18 is clear from interfering with the first door 60a and the second door 60b, the biasing force of the hinge rod springs 350a, 350b acts to translate the first door 60a and the second door 60b in the first direction 372b, which results in the first door 60a and the second door 60b automatically rotating to the closed position. As such, the automatic door hinge assemblies 340a, 340b are configured to automatically transition the first door 60a and the second door 60b from the closed position to the open or stowed position when the platform assembly 18 and the guardrail assembly 20 transition from the working position to the stowed position, and automatically transition the first door 60a and the second door 60b from the open or stowed position the closed position when the platform assembly 18 and the guardrail assembly 20 are transition from the folded position to the working position. Similarly, when a user would like to board or egress from the lift device 10, the user can apply a force on the first door 60a and the second door 60b to overcome the biasing force of the hinge rod springs 350a and 350b and open the first door 60a and the second door 60b. If the user releases the first door 60a and the second door 60b, the biasing forces will automatically close the first door 60a and the second door 60b.

Lift assemblies can raise personnel or equipment on a stable base, while permitting space for a user to work. The assembly can include wheel assemblies to transport the lift assembly, an elevating mast actuated by a mast elevation mechanism, a guard rail to prevent unintended egress of a user, and a foot well for the user. Lift assemblies may occupy more space than some alternatives, such as ladders or stepstools, which can impede their use or storage. For example, the guard rail can occupy a space adequate for a user to occupy, turn, lift, and otherwise perform work functions on the lift. However, such a guard rail can occupy more space than may be available in some facilities. Thus, the guard rail may be configured to selectively alternate between a deployed configuration and a stowed configuration. A tread plate may also occupy space in a deployed configuration in excess of an available space. The guard rail and tread plate can be configured to deploy or stow via a linkage therebetween. Further, the guard rail can be configured to receive the tread plate in a stowed configuration. The lift assembly can include wheels for transport which can be retracted or retractable in a deployed configuration. For example, the wheels can be retracted by actuation of a control (e.g., lever) or by applying a weight to a foot well assembly. When the wheels are retracted, feet can support the lift assembly. A deployable outrigger can include at least a portion of the feet supporting the lift assembly, which elevate or otherwise reduce load transferred to the ground via the wheels. The outrigger can latch into a deployed position via a sprung bar of a base of the lift assembly.

According to the exemplary embodiment shown in FIG. 1, a lift assembly 1000 is depicted in a deployed configuration. The lift assembly 1000 is referred to with reference to a coordinate system, in which a positive x direction is referred to as “forward” “front” and the like, and a negative x direction is referred to as “rear” “backside” and the like. References to a height, vertical distance, or an upward dimension refer a distance along the Z plane. A positive Y axis is referred to as a left side of the lift assembly 1000 and the negative Y axis is referred to as the right side of the lift assembly 1000. A lateral plane refers to any X-Y plane; a displacement along a lateral plane may be referred to as a horizontal displacement.

The lift assembly 1000 includes a gate assembly or guard assembly 1002 that is rotatably coupled to a mast 1016, such that the guard assembly 1002 can alternate between the depicted deployed position and a stowed position. The guard assembly 1002 includes left and right side panels 1004 having a front grab handle 1006 and rear grab handle 1008. A door 1010 is rotatably coupled to a side panel, such as to each of the side panels 1004 as depicted, opposite from the mast 1016, such that the doors 1010, in combination with the side panels 1004 and the mast 1016 define a generally enclosed working space which contains no lateral openings for egress of personnel. The doors 1010 can be configured to open towards the rear of the lift assembly 1000, such that the doors 1010 do not substantially impede ingress to the lift assembly 1000, but can prevent unintended egress therefrom. As depicted, the doors 1010 can be referred to as closed, wherein the doors substantially enclose the front face of a tread plate 1022.

Each side panel 1004 of the guard assembly 1002 can rotatably couple to the mast 1016 by a pivot point (e.g., via a pivot bearing). The selective coupling between a lock-release mechanism and the mast 1016 at a position other than the pivot point can fix the guard assembly 1002 into the deployed position or allow the rotation of the guard assembly between the deployed position and the stowed position. The guard assembly 1002 includes at least one trigger 1012 to selectively lock the rotatable position of the guard assembly 1002. For example, each side panel 1004 can include a trigger 1012 which can engage the depicted cable 1014, a hydraulic line, or other force transfer mechanism to actuate the lock-release mechanism selectively coupled between the mast 1016 and the guard assembly 1002.

A foot well assembly 1020 includes a tread plate 1022 disposed along a generally lateral plane.

The tread plate 1022 can further include a sidewall portion extending upward from the lateral plane. A side plate 1024 can extend over the sidewall portion or otherwise extend vertically from the lateral plane of the tread plate 1022. The side plate 1024 can contact the doors 1010 during a stowage of the lift assembly 1000 which may cause an inward rotation of the doors 1010 about an axis of a helical hinge coupling the doors 1010 to the guard assembly 1002 (e.g., to the side panels 1004 thereof). The guard assembly 1002 is connected to the foot well assembly 1020 by a pair of linkage arms 1018. For example, the depicted linkage arms 1018 connect to the foot well assembly 1020 forward of a pivot point (not depicted) of the foot well, and to the guard assembly 1002 rearward of the pivot point of the side panels 1004. Either of the guard assembly 1002 or the foot well assembly 1020 can be rotated about their respective pivot points. Upon such a rotation, the linkage arms 1018 can cause the other of the guard assembly 1002 or the foot well assembly 1020 to rotate such that the guard assembly 1002 and foot well assembly 1020 can transition between a stowed and deployed configuration.

The lift assembly 1000 can include at least one wheel or caster 1030. The casters 1030 can be coupled with at least one of a base assembly, a base, a chassis, a frame, a support structure and/or among other possible structures that can house and/or otherwise establish a body of the lift assembly 1000. For example, the casters 1030 can be coupled with a base assembly that includes the mast 1016. The casters 1030 can be included in a caster assembly and/or a wheel assembly. For example, the caster assembly can include the casters 1030 and a structure. The structure can couple the casters 1030 to a component of the lift assembly 1000. At least a portion of the caster assembly can extend into, be disposed within, be disposed beneath, occupy and/or otherwise rest within a body and/or hollow portion of the base assembly. For example, a structure (e.g., a bar) of the caster assembly can be disposed within or beneath the body of the base assembly. The casters 1030 can be used to move at least a portion of the lift assembly 1000. For example, an operator of the lift assembly 1000 can interact with, interface with or otherwise engage with a portion of the lift assembly 1000 and the operator engaging the lift assemble can result in the casters 1030 rolling across and/or along a ground surface. The casters 1030 can move, responsive to the casters 1030 rolling across the ground surface, the lift assembly 1000. For example, the casters 1030 can move the lift assembly 1000 from a first location to a second location.

The casters 1030 can be repositionable. For example, the casters 1030 can have a first position and a second position. The first position can be a lowered position where the casters 1030 interact with, interface with and/or otherwise make contact with a ground surface. For example, the casters 1030 can be in the first position while making contact with a ground surface. The second position can be a raised position where the casters 1030 are no longer and/or prior to making contact with the ground surface. For example, the casters 1030 can be in the second position when the casters 1030 are raised off of the ground (e.g., no longer making contact with the ground surface). Similarly, the casters 1030 can make contact with the base assembly while in the second position. For example, the casters 1030 can be lifted off of the ground surface and the casters 1030 being lifted off of the ground surface can result in the casters 1030 making contact with the base assembly. FIG. 1 depicts an example of the casters 1030 in the second position.

The lift assembly 1000 can include at least one caster actuation assembly, shown as mechanism 1032. The mechanism 1032 can be coupled with a base assembly. The mechanism 1032 can also be coupled with the caster 1030 and/or caster assembly that includes the casters 1030. The mechanism 1032 can move the casters 1030 from the first position to the second position. The mechanism 1032 can move the casters 1030 from the first position to the second position by at least one of hinging, pivoting, rotating, spinning, lifting, and/or otherwise adjusting the casters 1030 from the first position to the second position. For example, the mechanism 1032 can move the casters 1030 from the first position to the second position by lifting the structure coupled with the casters 1030 resulting in the casters 1030 moving from the first position to the second position. The mechanism 1032 can also move the casters 1030 from the second position to the first position. The mechanism 1032 can move the casters 1030 from the second position to the first position by reversing the action that was performed to move the casters 1030 from the first position to the second position. For example, if the mechanism 1032 lifted the casters 1030 from the first position to the second position the mechanism 1032 can reverse the lifting action to move the casters 1030 from the second position to the first position.

The mechanism 1032 can include at least one handle 1034 (e.g., an interface element) and at least one bar 1036 (e.g., a linkage). The handle 1034 can be coupled with the bar 1036. The bar 1036 can be coupled with the casters 1030 and/or the bar 1036 can be coupled with the caster assembly that includes the casters 1030. Additionally, the bar 1036 can interface with, interact with and/or otherwise engage with the casters 1030 and/or the caster assembly. For example, the caster assembly can include an opening and/or an aperture and the bar 1036 can insert into and/or enter the opening resulting in the bar 1036 engaging the caster assembly. The bar 1036 can lift, responsive to engaging the caster assembly, the casters 1030 from the first position to the second position.

The bar 1036 can be and/or include at least one of a bracket, a metal bar, a piece of rebar, a metal sheet, a beam, a metal strut, a shaft, a pole, a stem, and/or among other possible support structures. The bar 1036 can be repositionable or reorientable. For example, the bar 1036 can have a first orientation and a second orientation. The orientations of the bar 1036 can be and/or include at least one of a position, a placement, a location, a deployment, and/or a distance. For example, the first orientation of the bars 1036 and the second orientation of the bars 1036 can refer to a distance between the bars 1036 and a ground surface. The first orientation of the bars 1036 can be and/or include a first interaction and/or a first placement with respect to the casters 1030 and/or the caster assembly and the second orientation of the bars 1036 can be and/or include a second interaction and/or a second placement with respect to the casters 1030 and/or the caster assembly. For example, the bars 1036 can, while in the first orientation, be decoupled from and/or otherwise disengaged with the casters 1030 and the bars 1036 can, while in the second orientation, be coupled with and/or otherwise engages with the casters 1030. The bars 1036 while in the first orientation can result in the casters 1030 being placed and/or otherwise located in the first position (e.g., the casters 1030 are making contact with a ground surface). The bars 1036 while in the second orientation can result in the casters 1030 being placed and/or otherwise located in the second position (e.g., the casters 1030 are lifted off of the a ground surface). The orientation of the bar 1036 can dictate, define, and/or otherwise establish a distance between the casters 1030 and a ground surface. For example, the bars 1036 being placed and/or otherwise located in the first orientation can result in the casters 1030 making contact with the ground surface (e.g., the first position having a first distance from the ground surface) and the bars 1036 being placed and/or otherwise located in the second orientation can result in the casters 1030 being raised off of the ground surface (e.g., the second position having a second distance from the ground surface). FIG. 1 depicts an example of the bar 1036 in the second orientation.

The handle 1034 can be and/or include at least one a lever, a knob, a latch, a grip, a shaft, and/or a stake. The handle 1034 can move the bars 1036 from a first orientation to a second orientation. The handle 1034 can move the bars 1036 from the first orientation to the second orientation by at least one of hinging, pivoting, rotating, spinning, and/or otherwise adjusting the bars 1036 from the first orientation to the second orientation. The handle 1034 and/or the mechanism 1032 can, responsive to handle 1034 moving the bars 1036 from the first orientation to the second orientation, move the casters 1030 from the first position to the second position. An operator of the lift assembly 1000 can interact with, interface with and/or engage the handle 1034 to move the casters 1030 and/or the bars 1036. For example, the operator can perform a first actuation (e.g., engage with the handle) to move the bars 1036 from the first orientation to the second orientation. The casters 1030 can be located in the first position with the bars 1036 in the first orientation. For example, the casters 1030 can be in the first position prior the first actuation of the handle 1034. Similarly, the casters 1030 can be located in the second position with the bars 1036 in the second orientation. For example, the casters 1030 can be in the second position responsive to the first actuation of the handle 1034. FIG. 1 depicts an example of a first actuation of the handle 1034 having been performed to move the casters 1030 from the first position to the second position.

A top surface of the tread plate 1022 can support an object. For example, the tread plate 1022 can support an operator (e.g., the object) of the lift assembly 1000. The tread plate 1022 can, responsive to the tread plate 1022 supporting the operator, transfer a force from the object (e.g., rest on) a portion of the base assembly (e.g., the mast 1016 or other intermediate components). For example, the operator of the lift assembly 1000 can step onto, rest on and/or otherwise be positioned on the tread plate 1022 and the operator being positioned on the tread plate 1022 can result in a portion of the tread plate 1022 making contact (e.g., resting) on the base assembly. The tread plate 1022 can include at least one a protrusion. The protrusion can, responsive to the tread plate 1022 supporting the object, interact with, interface with and/or otherwise engage with the caster assembly. The protrusion engaging with the caster assembly can result in the casters 1030 moving from the first position to the second position. For example, the protrusion engaging with the caster assembly can result in the casters 1030 being raised off of the ground resulting in the casters 1030 no longer making contact with the ground surface. The protrusion can, responsive to the tread plate 1022 no longer supporting the object, disengage with the caster assembly. The protrusion disengaging with the caster assembly can result in the casters 1030 moving from the second position to the first position. For example, the casters 1030 can be lowered toward to the ground surface, responsive to the protrusion disengaging the caster assembly, resulting in the casters making contact with the ground surface.

The lift assembly 1000 can include at least one lifting mechanism 1040. The lifting mechanism 1040 can be coupled with the mast 1016. The lifting mechanism 1040 can be and/or include at least one a drive gear, a cable, a rope, a capstan, a pulley, a spring, a hydraulic lift, a pneumatic lift, a piston, and/or among other possible lifting devices and/or components. The lifting mechanism 1040 can move, adjust, raise, lower, ascend, descend, lift, and/or otherwise change the height of at least a portion of the lift assembly 1000 and/or a component thereof with respect to a ground surface. For example, the lifting mechanism 1040 can lift a portion of the mast 1016 from a first height and/or a first distance from the ground surface to a second height and/or a second distance from the ground surface.

The lift assembly 1000 can include at least one interface, shown as crank 1042. The crank 1042 can be disposed on an external surface of the lifting mechanism 1040 and the crank 1042 can be coupled with the lifting mechanism 1040 and/or a component thereof. The crank 1042 can move, spin, adjust, swivel and/or otherwise rotate the lifting mechanism 1040. An operator of the lift assembly 1000 can interface with, interact with and/or otherwise engage the crank 1042. For example, the operator can grab the crank 1042 and the operator can, responsive to grabbing the crank 1042, spin and/or rotate the crank 1042 in a circular and/or semi-circular pattern. The spinning of the crank 1042 can result in crank 1042 engaging and/or interacting with the lifting mechanism 1040. The crank 1042 engaging the lifting mechanism 1040 can result in the lifting mechanism 1040 raising and/or lower the lift assembly 1000. For example, a clockwise rotation of the crank 1042 can result in the lifting mechanism raising the lift assembly 1000. Similarly, a counter clockwise rotation of the crank 1042 can result in the lifting mechanism lowering the lift assembly 1000. The crank 1042 can be and/or include at least one of a knob, a handle, an actuator, a button, a spring, a latch, a lever, an arm, a grip, a shaft, and/or among other possible components.

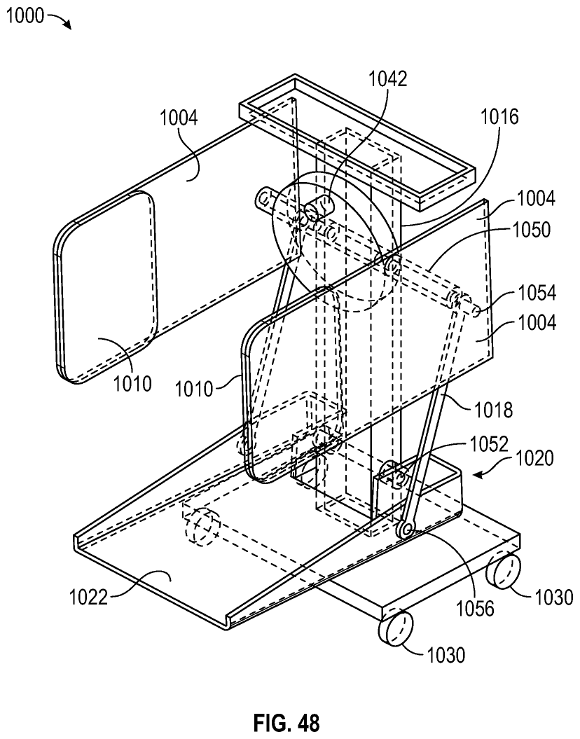

Referring now to FIGS. 48-50, a wire frame depiction of the lift assembly 1000 is shown according to an exemplary embodiment. Certain features are omitted or shown in a pre-stowed position merely to more clearly illustrate other elements of the present embodiment. Such omissions or adjustments are not intended to be limiting. Indeed, the various features depicted in the various embodiments, disclosed herein can be added, substituted, or omitted in various embodiments according to the present disclosure.

For example, the doors 1010 are depicted as closed in FIG. 48. In some embodiments, the doors 1010 can include a sprung hinge (not depicted) which may maintain the doors in the closed position. Such a hinge (e.g., a helical hinge) may prevent unintended egress from the lift assembly 1000.

Rotatable connection assemblies 1050 are shown coupled between the mast 1016 and a pivot point of each side panel 1004. The rotatable connection assemblies 1050 are rotatably coupled to at least one of the mast 1016 or a side panel 1004. In some embodiments, the rotatable connection assemblies 1050 may operate independently or include a coupling therebetween. For example, the rotatable connection assemblies 1050 may be a same rigid member coupled to each of the side panels. Such a rotatable connection assembly 1050 can pass through or otherwise couple to the mast 1016. Further rotatable connection assemblies 1052 can couple between the mast 1016 and a pivot point of the foot well assembly 1020.

The linkage arms 1018 can connect to the side panel 1004 and the foot well assembly 1020. For example, a linkage arm 1018 can couple to the side panel 1004 at a connection point 1054 posterior to the pivot point connecting the side panel 1004 to the mast 1016. The linkage arms 1018 can extend between the side panel connection point 1054 and a foot well connection point 1056. The linkage arms 1018 can interface between an interior surface of the side panel 1004 and an exterior surface of the foot well assembly 1020, which may reduce a pinch hazard in the foot well assembly 1020 or along the exterior surface of the side panel 1004. The side panel connection point 1054 may be located posterior to a front face of the mast 1016, or a lifting mechanism 1040 connected thereto, which may further reduce a pinch hazard. A center of mass of the side panels 1004 can be forward of the rotatable connection assemblies 1050 such that the panels can cause a counterclockwise rotation of the side panels 1004, as depicted. The center of mass of the foot well assembly 1020 can be forward of the foot well rotatable connection assemblies 1052, such that the foot well assembly 1020 can counter the clockwise force imparted by the side panels 1004. The foot well assembly 1020 can interface with a chassis, shown as base assembly 1060 to limit a movement of the foot well assembly (and, via the linkage arms 1018, limit the rotation of the side panels 1004).

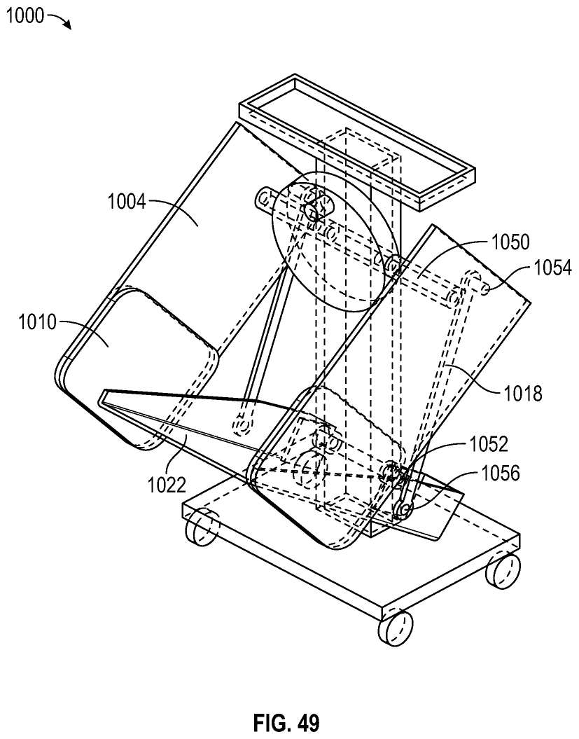

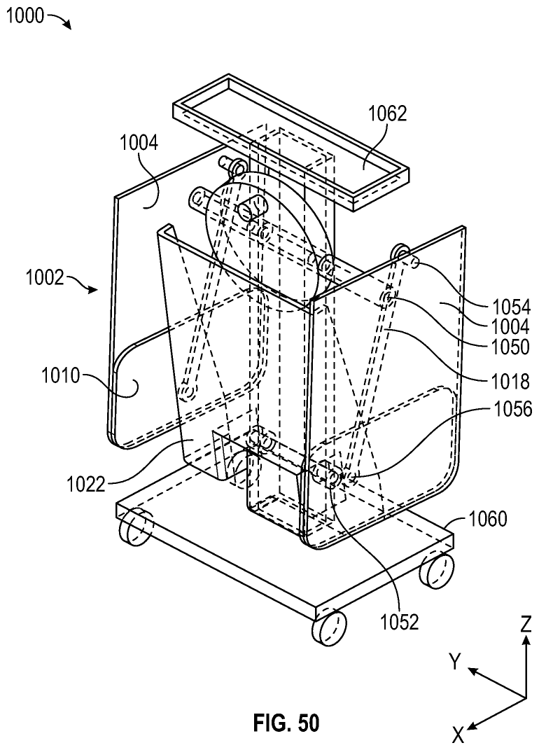

Referring now to FIG. 49, the lift assembly 1000 of FIG. 48 is depicted intermediate to the deployed mode depicted in FIG. 48, and the stowed mode depicted in FIG. 50. For example, the side panels 1004 are shown rotated about the side panel rotatable connection assemblies 1050 towards a stowed position. The foot well assembly 1020 is rotated (clockwise, as depicted) towards a stowed position about the foot well rotatable connection assemblies 1052. The side panel connection point 1054 and foot well connection points 1056 are elevated over a deployed position incident to stowing (e.g., clockwise rotation) of the foot well assembly 1020. The linkage arms 1018 can synchronize a stowage of the foot well assembly 1020 and side panels 1004.

Moreover, although the depicted doors 1010 were shown in a closed position, as deployed in FIG. 1, in some embodiments, the doors may be connected to the side panels 1004 via hinged springs which may maintain the doors 1010 in a closed position until the stowage thereof. Upon stowing the lift assembly 1000, the doors 1010 may contact the foot well assembly 1020 which may cause the doors 1010 to close. For example, a side plate 1024 of the foot well assembly 1020 can be configured to interface with the doors. For example, the doors 1010 can be formed from an injection molded plastic, and the side plate 1024 can be formed from a nylon material configured to maintain an appearance (e.g., be resistant to scratching or abrasion therebetween) upon engaging with the doors 1010. Upon a force between the side plate 1024 and the doors exceeding the force of the sprung hinge, the doors can open to allow the guard assembly 1002 to receive at least a portion of the foot well assembly 1020.

Referring now to FIG. 50, the lift assembly 1000 is depicted as stowed. The side panels 1004 are disposed generally vertically (e.g., about 90° from the deployed position). The foot well assembly 1020 is depicted as received within the guard assembly 1002. As stowed, a lateral dimension of the lift assembly 1000 can be substantially coextensive, or circumscribed by the lateral dimension of the base assembly 1060. Thus, the base assembly 1060 can be a maximum size which may not constrain a footprint occupied by the lift assembly 1000. According to various embodiments, the base assembly 1060 may exceed the lateral dimension of the other portions of the lift assembly 1000, or the other portions of the lift assembly 1000 can exceed the lateral dimension of the base assembly 1060. A storage tray 1062, bin, or the like is depicted as coupled to an upper surface of the mast 1016. Advantageously, the coupling of the storage bin to the mask may maintain any items deposited therein between deployments of the lift.

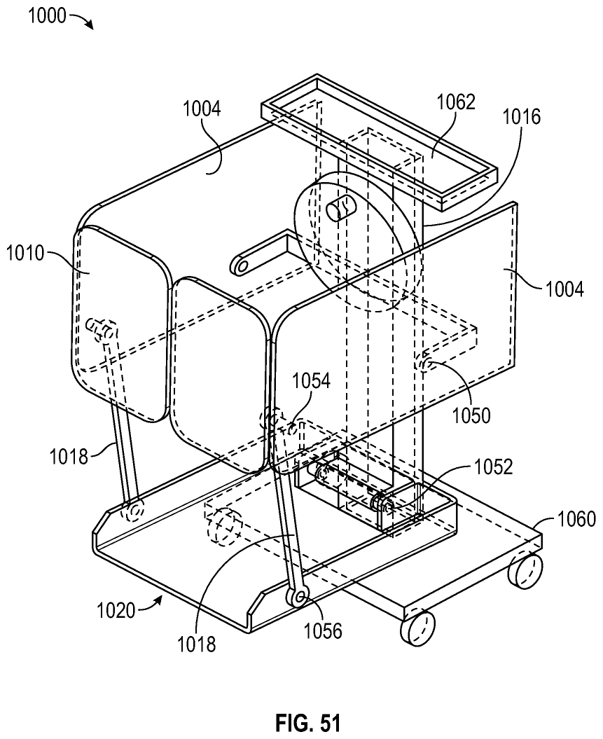

Referring now to FIG. 51, a wire frame depiction of the lift assembly 1000 according to another embodiment is shown. As depicted, the side panel connection point 1054 is disposed forward of the rotatable connection assemblies 1050. The rotatable connection assembly 1050 can couple to the mast 1016 via a rigid body. The rotatable connection assemblies 1050 can include a bearing rotatably coupled to the side panel 1004 or to the rigid body coupled to the mast 1016. The foot well connection point 1056 of the foot well assembly 1020 is coupled to the guard assembly 1002 via the linkage arms 1018. The foot well assembly 1020 can rotate around a foot well rotatable connection assembly 1052. Thus, upon a clockwise rotation of either of the foot well assembly 1020 or the guard assembly 1002, the other of the foot well assembly 1020 or the guard assembly 1002 is also rotated in the clockwise direction to stow the lift assembly 1000.

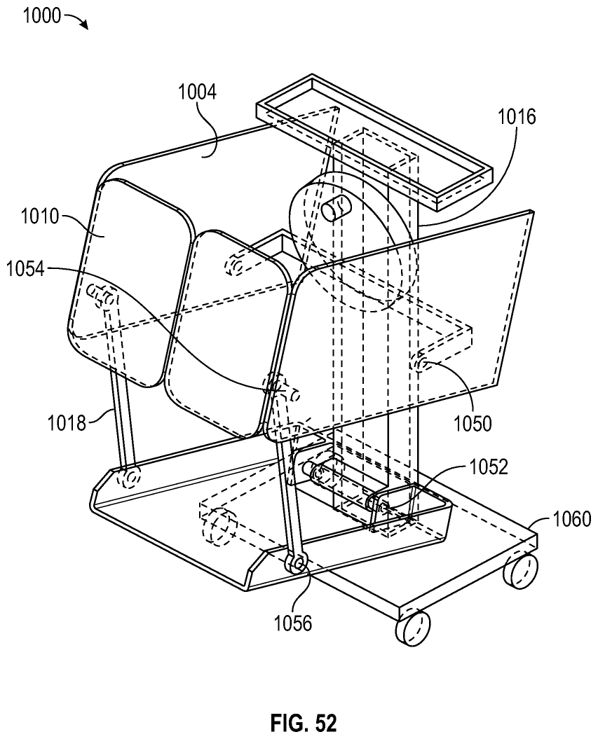

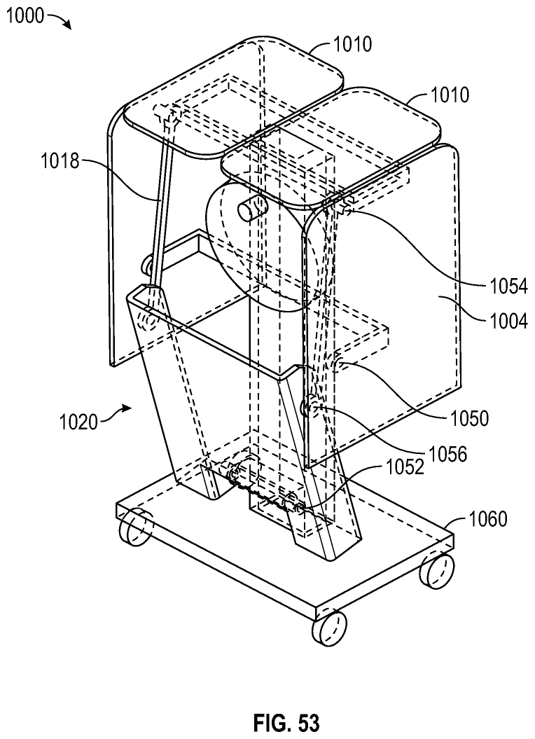

Referring now to FIG. 52, the lift assembly 1000 is shown intermediate to the deployed mode depicted in FIG. 51, and the stowed mode depicted in FIG. 53. As the guard assembly 1002 and foot well assembly 1020 are raised, as linked by the linkage arms 1018, the lift assembly 1000 stows. Referring now to FIG. 53, the assembly is shown in a stowed mode. In the stowed mode, the guard assembly 1002 and foot well assembly 1020 are disposed within the lateral outer bounds of the base assembly 1060. The center of mass of the guard assembly 1002 can be posterior to the side panel rotatable connection assembly 1050, such that the position of the guard assembly 1002 can be stable (e.g., may return to a stowed position upon a displacement therefrom). In some embodiments, the guard assembly 1002 can include a latching or locking mechanism to maintain the stowed position of the lift assembly.

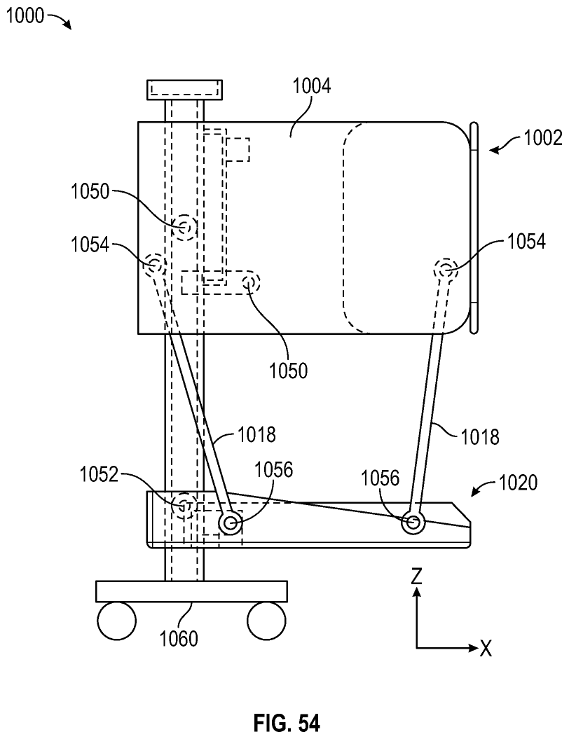

Referring now to FIG. 54-56, side views of the lift assemblies 1000 of FIGS. 48-53 are provided with the two lift assemblies 1000 overlaid atop one another for reference. FIGS. 54-56 may facilitate comparing the actuation paths of the components of the two lift assemblies 1000. The side views are provided along the X and Z dimensions. As depicted in the deployed configuration, the guard assembly 1002 is shown deployed similarly for each embodiment. The respective pivot points connecting to the rotatable connection assemblies 1050 of the guard assembly 1002 are depicted a coupled to the mast 1016. The side panel connection point 1054 of the respective linkage arms are disposed along an edge of the guard assembly 1002; a corresponding foot well connection point 1056 is disposed interior to the side panel connection point 1054. A foot well rotatable connection assembly 1052 is coupled to the mast 1016 of the lift assembly 1000.

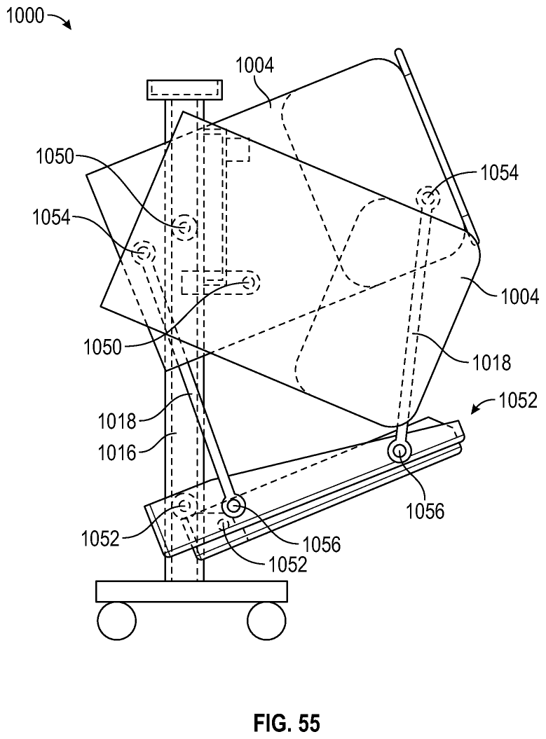

Referring now to FIG. 55, each foot well assembly 1020 is depicted as tilted upward (counterclockwise, as depicted) about the respective foot well rotatable connection assembly 1052. Each foot well assembly 1020 is coupled to a guard assembly 1002 via a linkage arm 1018 such that upon the stowing of the foot well assembly 1020, the guard assembly 1002 stows (or vice versa). For example, the guard assembly 1002 can rotate clockwise (upward) or counterclockwise (downward) about the respective rotatable connection assemblies 1050, as depicted. As described above, the downwardly rotating doors can open upon interfacing with the foot well assembly 1020 (e.g., a side plate 1024 thereof).

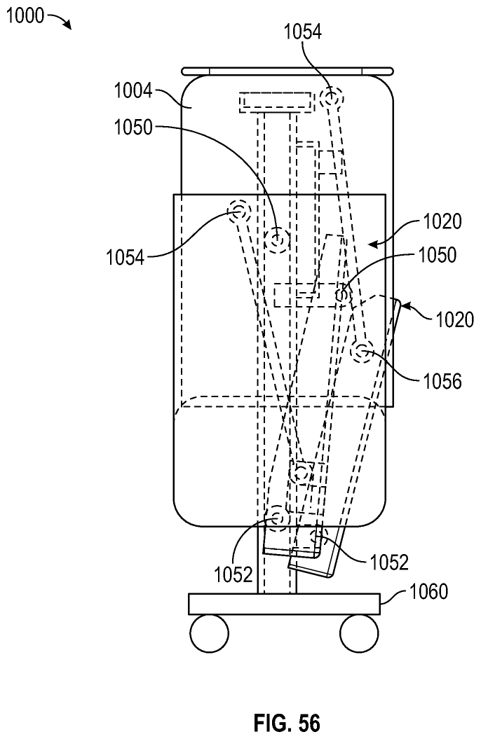

Referring now to FIG. 56, the lift assemblies 1000 are depicted in their stowed configurations. The foot well assemblies 1020 are received within the guard assemblies 1002, and the linkage arms are depicted in their stowed position. A sum of forces including the foot well assembly 1020 center of mass or other center of rotation and the guard assembly 1002 center of mass or other center of rotation can maintain a position of the lift assembly 1000 in the stowed mode (e.g., the stowed assembly can be a stable state, or be resistive to displacement thereof, returning to the stowed position). In some embodiments, a latch strap, detent or the like can maintain the stowed position of the lift assembly.

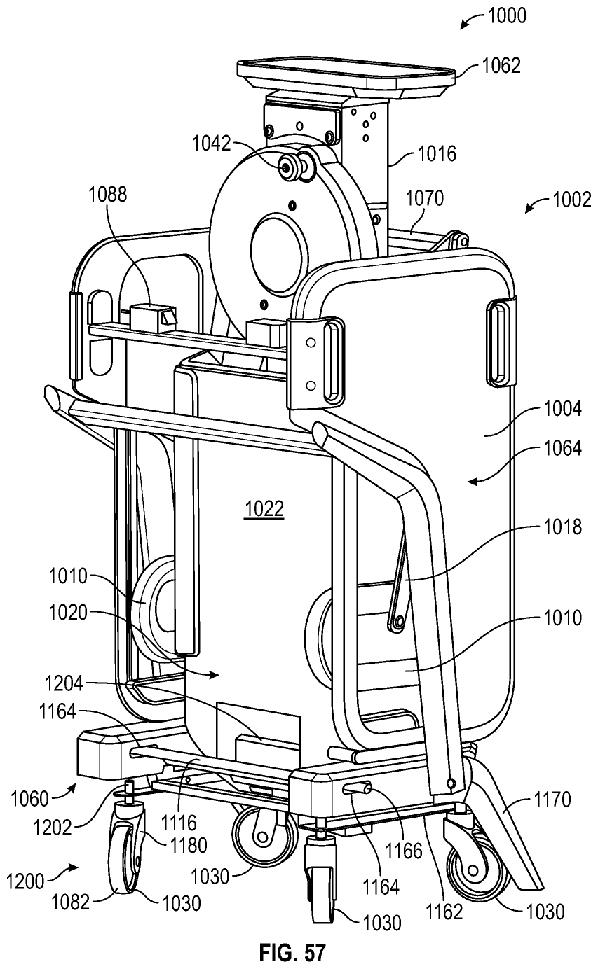

Referring now to FIG. 57, a perspective view of the lift assembly 1000 of FIG. 1 is provided in a stowed configuration, according to an exemplary embodiment. The bottom side of the foot well assembly 1020 is depicted, having a side plate 1024 extending along a lower surface thereof. For example, the side plate 1024 can wrap from a side of the tread plate 1022 to a bottom surface thereof. Such a side plate (or bottom plate, the tread plate, etc.) can interface with the base assembly 1060 of the lift assembly 1000. The doors 1010 are held open by interfacing with the foot well assembly 1020. The trigger 1012 coupled to the cable 1014 connects to a latch assembly 1088. The latch assembly 1088 can include a normally closed latch that interfaces with a side portion of the mast 1016. For example, the latch can couple the guard assembly 1002 to the mast 1016 to maintain the guard assembly 1002 in a deployed position. The actuation of the trigger 1012 can transmit force (e.g., via the cable 1014) to a lock-release mechanism of the latch assembly 1088 to decouple the guard assembly 1002 from the mast such that the guard assembly 1002 can rotate to the stowed position.

The side panels 1004 interface with an outrigger assembly 1064 in a stowed position. For example, the side panels 1004 can selectively couple to or otherwise interface with the outrigger assembly. For example, a face of the side panel can interface with a cross member of the outrigger 1030 to arrest a rotation of the guard assembly 1002.

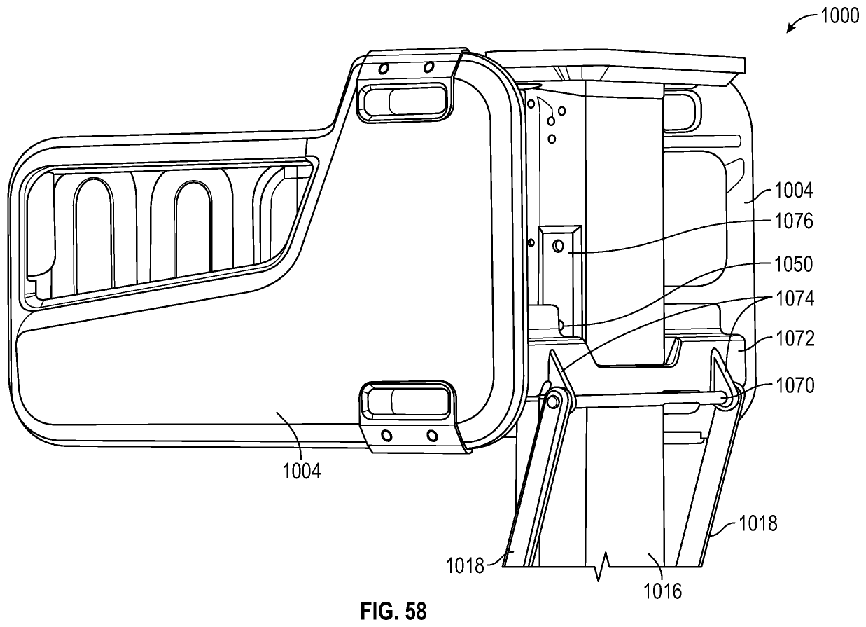

Referring now to FIG. 58, a detail view of the rear of the guard rail assembly 1002 is provided, according to an exemplary embodiment. The linkage arms 1018 connect to the guard assembly 1002. A cross-bar 1070 can link the linkage arms 1018. The view depicts a rear joining member 1072 joining the left and right side panels 1004. The rear joining member 1072 can couple to each of the side panels 1004 via an intermediate bolt, tab, adhesive or other coupling. Said coupling can be a non-rotatable coupling such that a rotation of the rear joining member 1072 can cause a same rotation of the side panels (e.g., between a deployed and stowed position). The rear joining member 1072 can sheath or otherwise contact a rotatable connection assembly 1050 for the side panels. Said rotatable connection assembly 1050 may be rotatably coupled with the side panels 1004 or the mast 1016, such that the side panels 1004 can rotate about a pivot point defined by the connection of the side panel 1004 to the rotatable connection assembly 1050. A pair of eyelets 1074 extend rearward of the rear joining member 1072, and receive a cross-bar 1070 joining the linkage arms 1018. According to various embodiments, the linkage arms 1018 may be otherwise directly or indirectly coupled to the side panels 1004, such that a displacement of the linkage arms 1018 causes a rotation of the side panels 1004 about the pivot point thereof, and a rotation of the side panels 1004 causes a displacement of the linkage arms 1018. Such a displacement can, in turn, cause a rotation of the foot well assembly. For example, the foot well assembly can rotate in a same or opposite direction in a X-Z plane.

The rear joining member 1072 can pass through or otherwise couple with the mast 1016. For example, the mast can include a bracket 1076 mounted thereto to couple to the rear joining member 1072, the latch, or other portions of the lift assembly 1000. In some embodiments, the coupling between the mast and the rear joining member 1072, or other rotatable portions of the lift assembly can include a bearing (e.g., a radial bearing) to reduce a friction or wear associated with a rotation of the guard assembly 1002 or other portions thereof.

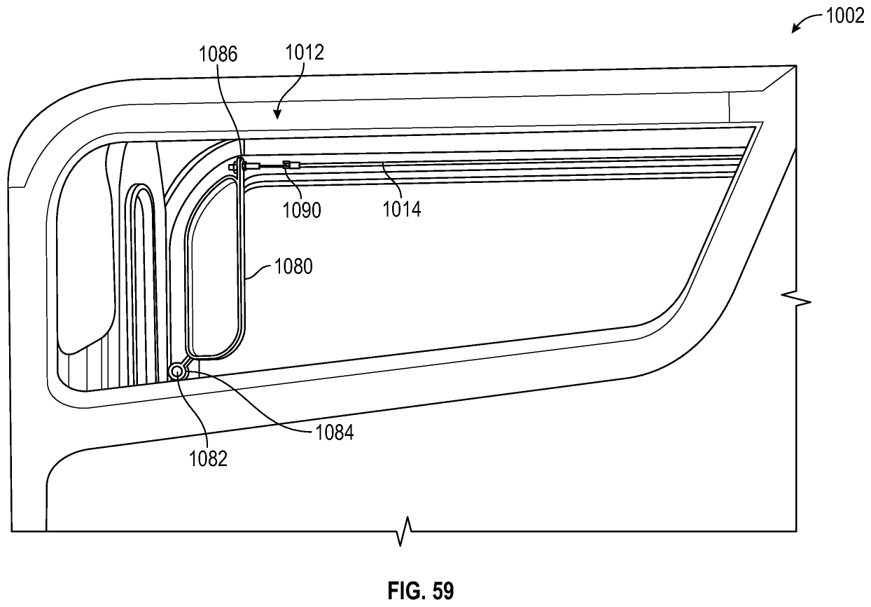

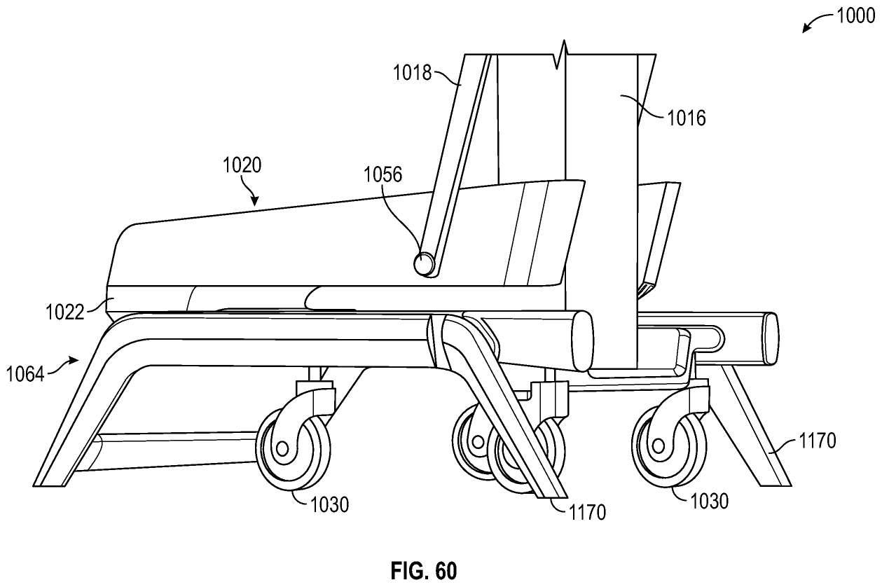

Referring now to FIG. 59, a detail view of the trigger 1012 is provided according to an exemplary embodiment. The trigger 1012 includes a trigger body 1080 coupled to a side panel 1004, such as by the receipt of the depicted integral protrusion 1082 of the side panel in the side panel eyelet 1084 of the trigger 1012. In various embodiments, the integral protrusion 1082 can be substituted for a screw, bolt, tab, or other connection to a portion of the trigger body 1080 configured to couple to the side panel, such as the depicted side panel eyelet 1084. A cable eyelet 1086 disposed on an opposite surface of the trigger body 1080 from the side panel eyelet 1084 receives or otherwise couples to a cable 1014 or other force transmission mechanism. The cable 1014 or other force transmission mechanism can be slidably connected to the side panel 1004 by the depicted guides, an eyelet, or the like.

The cable 1014 can connect to a lock-release mechanism of a latch assembly 1088, shown in FIG. 57, to decouple a coupling point between the mast 1016 and the side panels 1004. Such a lock-release can be actuated to transition the side panels 1004 between the deployed position and the stowed position. The side panel 1004 can include an opening 1090 such that the trigger body 1080 can rotate about the side panel eyelet 1084 to traverse at least a portion of the opening 1090 to engage the latch assembly 1088. As depicted, each side panel 1004 can include a trigger 1012. The respective triggers 1012 of the left and right side panels 1004 can be independent such that the coupled latch assemblies 1088 operate independently, to provide redundancy. The respective triggers 1012 of the left and right side panels 1004 can connect to a same latch assembly 1088 such that an actuation of either trigger can actuate the lock-release mechanism.

Referring now to FIG. 60, a rear perspective view of the foot well assembly 1020 in a deployed position is provided according to an exemplary embodiment. The foot well assembly 1020, as deployed, can interface with the base assembly 1060 of the lift assembly 1000 to limit a deployment thereof. For example, the base assembly 1060 can limit the deployment of the foot well assembly 1020 such that the tread plate 1022 is disposed along a lateral plane (e.g., within 5° or 10° of the lateral plane, which may permit a user to stand on the tread plate 1022). In some embodiments, the foot well assembly 1020 can interface (e.g., rest upon) the outrigger assembly 1064, or the deployment of the foot well assembly can otherwise cause the deployment of the outrigger assembly 1064 to avoid an unbalanced platform for a user. A rear surface of the foot well assembly 1020 includes a cut out portion proximal to the mast 1016. A foot well rotatable connection assembly 1052 can rotatably couple within the cut out portion. A cut out potion can include rearward extension of a portion of the foot well assembly 1020 rearward of a front face of the mast 1016. For example, a foot well assembly 1020 including the cut out portion can be cast, folded, molded (e.g., injection molded plastic), cut, etc. FIG. 60 further depicts a connection between the linkage arms 1018 and the foot well assembly 1020 at a foot well connection point 1056. As described above, the connection of the foot well connection point 1056 forward of the foot well rotatable connection assembly 1052 can cause an upward rotation of the foot well assembly 1020 upon the upward displacement of the linkage arm (e.g., an upward displacement caused by or incident to the stowing of the guard assembly 1002).

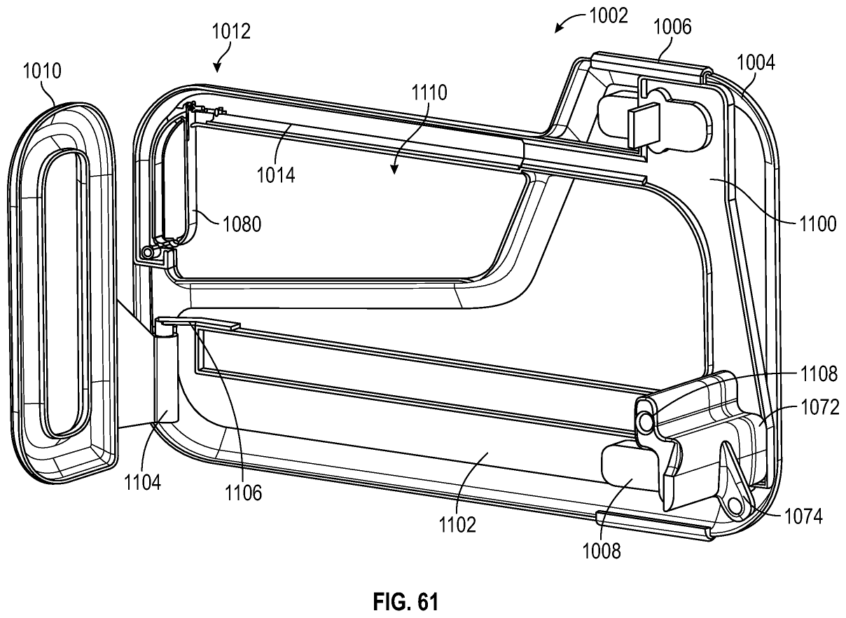

Referring now to FIG. 61, a perspective view of a side panel 1004 of the guard assembly 1002 is provided, according to an exemplary embodiment. For example, the side panel 1004 can be the left side panel 1004 of FIG. 1. The side panel 1004 includes a frame 1100, which may include cast aluminum, steel, a high strength polymer, or the like. The side panel 1004 can further include a panel cover 1102 made from a different material than the frame 1100. For example, the panel cover 1102 can be or include injection molded plastic. According to some embodiments, the panel cover 1102 can include a thickness less than the frame 1100. The front grab handle 1006 and rear grab handle 1008 can be integral to the panel cover 1102 or can be a separate material connected thereto. For example, the front grab handle 1006 and rear grab handle 1008 can be of a same material and different thickness as the panel cover 1102. The front grab handle 1006 and rear grab handle 1008 can couple to the frame 1100 such that forces transmitted through the front grab handle 1006 and rear grab handle 1008 transmit substantially through the frame, rather than the panel cover 1102, which may reduce a material requirement, weight, cost, etc. of the panel cover 1102 relative to other designs.

The side panel 1004 can connect to the door 1010 via a hinge 1104. The hinge 1104 may include or interface with a spring arm 1106 which interfaces with the side panel (e.g., a frame thereof) to apply a rotational force on the hinge to maintain the door in a closed position. The hinge 1104 may have a limit of travel when the door 1010 is disposed laterally perpendicular to the side panel 1004 such that the door 1100 does not open outward, which may prevent inadvertent egress of a user employing the lift assembly 1000. A portion of the rear joining member 1072 is depicted connected to the frame 1100 of the side panel 1004. The rear joining member 1072 can couple to the side panel by bolts, locking tabs, or otherwise couple (e.g., non-rotatably couple) to the side panel 1004. As depicted, the rear joining member 1072 can include an opening 1108 bounded by a sheathing portion of the rear joining member 1072 to receive a rotatable connection assembly 1050. An eyelet 1074 can extend rearward from the rear joining member 1072. For example, the eyelet can be integral to the rear joining member 1072 (e.g., cast, injection molded, or the like) or otherwise coupled thereto.

The side panel 1004 can define a panel opening 1110 to increase visibility of a user, allow for the passage of tools, or the like. According to various embodiments, the side panel 1004 can define various panel openings 1110 such as for a weave pattern, or to further reduce material thereof. The side panel 1004 can include a portion which is disposed along a lateral plane in a deployed position. For example, such a portion can be an upper surface, a lower surface, a panel opening surface, a frame surface, or another portion such that the guard assembly 1002 can avoid unintentional egress. The guard assembly 1002 can include curved surfaces to increase a strength adequate to retain a user therein. For example, the hinge strength can be configured to exceed a weight of a user applied thereto.

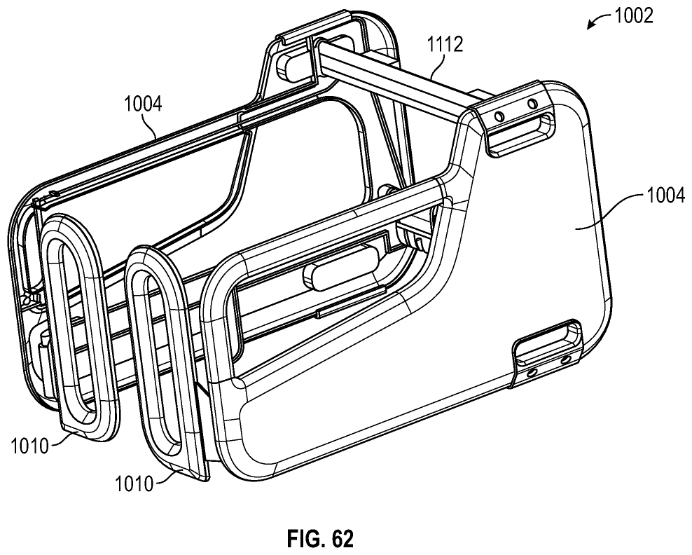

Referring now to FIG. 62, a perspective view of a guard assembly 1002 is provided, according to an exemplary embodiment. The guard assembly 1002 includes a left side panel 1004 and a right side panel 1004. The left side panel can be the side panel 1004 of FIG. 61. In some embodiments, as depicted, the left side panel and right side panel can be symmetrical or substantially symmetrical. The panels are joined by the rear joining member 1072, and a further rear joining member 1112. Each side panel can include a latch assembly 1088, which may be coupled with a joining member, cross bar, or other guard assembly portion. For example, the latch assembly can selectively couple with the mast 1016 of the lift assembly.

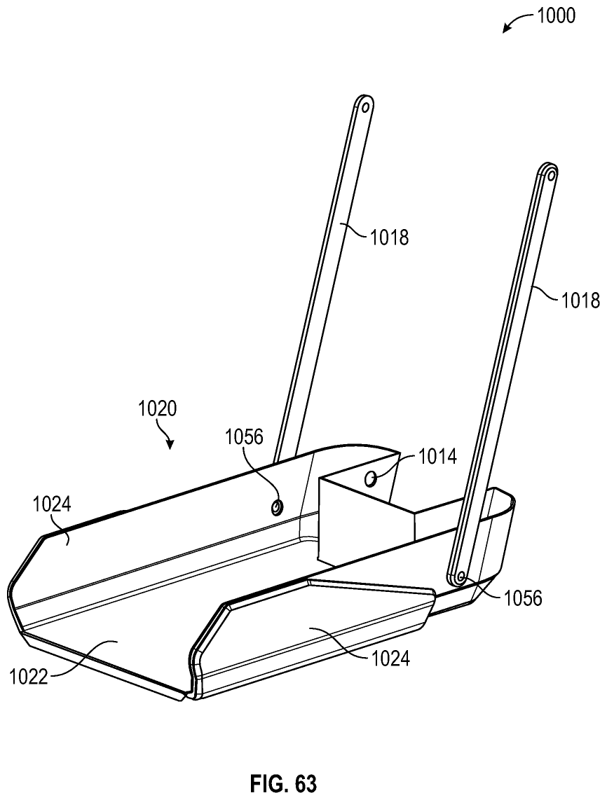

Referring now to FIG. 63, a perspective view of a foot well assembly 1020 is provided, according to an exemplary embodiment. The foot well assembly 1020 includes a tread plate 1022 and side plates 1024. As depicted, the foot well assembly 1020 couples to linkage arms 1018 at foot well connection points 1056. Further foot well rotation points 1114 are configured to interface with the foot well rotatable connection assembly 1052. For example, the foot well rotation points 1102 can be disposed in a cutout of the foot well assembly such that the foot well rotation points 1102 can interface with a foot well rotatable connection assembly 1052 along line traversing the mast 1016.

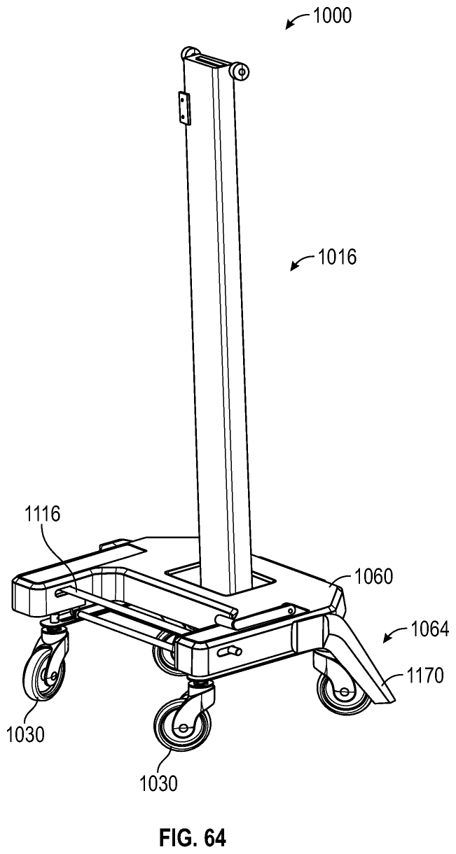

FIG. 64 is a perspective view of a base assembly 1060 coupled to a mast 1016, according to an exemplary embodiment. The mast 1016 can couple to the base assembly 1060 by a engagable connector such as a bolt. The base assembly 1060 can further include various castors 1030 to transport the lift assembly 1000, and can include engageble feet, including a fixed portion and an outrigger portion. For example, a sprung bar 1116 can engage with the outrigger assembly 1064 to lock the outrigger assembly 1064 into a deployed position. Each of the guard assembly 1002 and the foot well assembly 1020 can connect to any portion of the mast 1016.

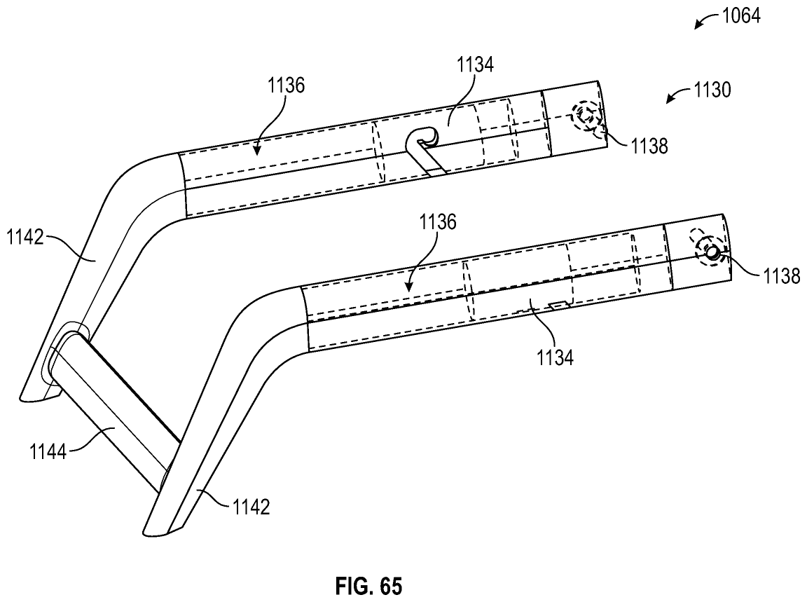

FIG. 65 is a perspective view of a rotatable portion of the stabilizer leg platform or outrigger assembly 1064, according to an exemplary embodiment. The rotatable portion can be referred to as an outrigger 1130, herein. The outrigger 1130 includes a pair of legs 1132 which extend along the X axis in a deployed configuration. At least one leg 1132 includes a locking guide 1134. For example, as depicted, each leg 1132 includes a respective locking guide 1134. The locking guides 1134 can be integral to the leg 1132. For example, the leg 1132 may be cast, injection molded, milled, etc. having the locking guides 1134. In some embodiments, the locking guide 1134 can be coupled to the leg 1132. For example, each leg can include a latch, mounting point, concave surface 1136, void (e.g., void defined by two inner and opposite concave surfaces), or the like. For example, as depicted, the leg 1132 can be an extruded polymer or aluminum leg 1132 having an inward facing concave surface 1136. The locking guide 1134 can be disposed within the concave surface 1136 or void, or be otherwise coupled to the leg 1132. The locking guide 1134 can be a same or different material as the leg 1132. For example, the locking guide 1134 can be an aluminum guide of greater thickness than the leg 1132.

The leg can include rotation points 1138 to couple to the lift assembly 1000. For example, the rotation points can rotatably couple to a base assembly (not depicted) of the lift assembly 1000. In some embodiments, the rotation points 1138 can include a first detent or spring force to maintain a stowed position of the outrigger 1130. In some embodiments, the rotation points are selectively rotatable such that upon an actuation the rotation points 1138 may latch into a rotational position, such as a stowed position as depicted in FIG. 1. In some embodiments, rotation points 1138 are integral to the legs 1132. For example, the rotation points 1138 can be drilled, cast, or coupled to the legs 1132. The rotation points 1138 can be reinforced, such as by the use of swaged fasteners, or a received block (e.g., a block of similar dimension to the locking guide 1134).

Each leg 1132 can include a vertical portion 1140 disposed on an opposite end of the leg from the rotation points 1138. The vertical portion 1140 extends vertically downward from the locking guide 1134, terminating at the depicted feet 1142. In various embodiments, the outrigger 1130 can include additional or fewer feet 1142. For example, the depicted legs 1132 can join to form a single foot 1142, or various feet 1142 can extend from each leg. According to some embodiments, a foot can include an interface material different from the leg (e.g., a rubberized material configured to non-slidably engage with various floor surfaces). The foot material may be compressible to maintain contact with a generally level surface having variances associated therewith, or any variances of the lift assembly 1000. In some embodiments, the vertical portion can extend the length of the leg (e.g. may extend vertically and horizontally).

A crossbar 1144 couples the legs 1132. The crossbar 1144 can be integral to a portion of the legs or otherwise coupled thereto. For example, the crossbar 1144 and the vertical portion of the legs 1132 can be a single cast body. In some embodiments, the crossbar 1144 can be configured to interface with the foot well assembly 1020 or the guard assembly 1002. For example, the crossbar 1144 can selectively engage therewith in a stowed configuration. Such an engagement can be non-mechanical (e.g., magnetic) or mechanical (e.g., a strap, pin, latch, friction retention, or the like). According to various embodiments, the crossbar 1144 can engage automatically upon placing the outrigger in the stowed position (e.g., via a gravity latch or magnetic retention), or may be manually coupled to another portion of the lift assembly 1000 as in the case of strap retention.

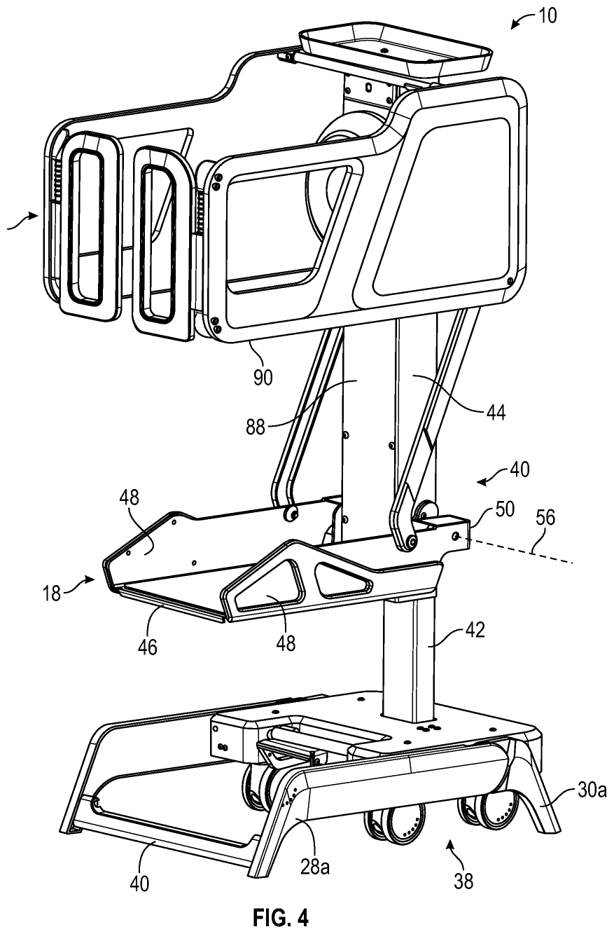

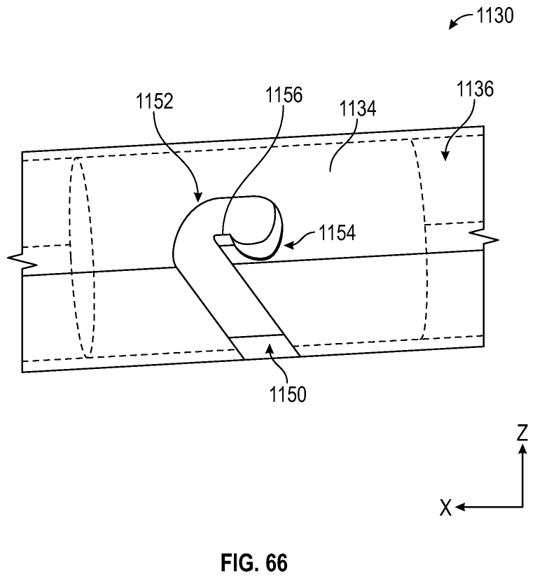

FIG. 66 is a detail view of the locking guide 1134 of FIG. 2, according to an exemplary embodiment. As is further described with respect to FIG. 4, the locking guide 1134 can receive a terminal portion of a sprung bar 1116 and retain said sprung bar 1116 until a release thereof. The locking guide 1134 can include an opening 1150 defined by inner walls of the lower surface of the locking guide 1134. A width of the opening 1150 can be an approximate dimension (e.g., somewhat larger, such as 10% larger) relative to a corresponding dimension of the sprung bar. The opening 1150 can extend into a channel 1152, which continues to be defined according to inner walls, which may also be referred to as sidewalls, and can extend laterally away from the rotation points 1138 and vertically upwards. Such a channel 1152 may cause an increase to a displacement of a spring associated with the sprung bar. The channel 1152 may be generally linear to reduce a force exerted between the sprung bar and the locking guide 1134 which may ease a stowage or deployment of the lift assembly 1000. The channel 1152 can proceed along a rearward direction (rightward, as depicted) towards an end portion or terminus 1154 of the channel.

A protrusion 1156 can extend upwards between the terminus 1154 and another portion of the channel 1152. Such a protrusion 1156 can limit a travel of the sprung bar 1116 when disposed with the terminus 1154. For example, a frontward (leftward, as depicted) force applied to the sprung bar 1116 can cause the interact with the protrusion 1156 to avoid a release of the sprung bar 1116 from the terminus 1156. For an unloaded lift assembly 1000 (e.g., lacking an occupant), such a protrusion may be passed by applying an upward force on the sprung bar. For a loaded lift assembly 1000 (e.g., having an occupant or other weight applied to a base assembly thereof) such an upward force may be greater, which may increase a force required to guide the sprung bar to the opening 1150 from the terminus 1154. Such an increase in force can prevent unintended retraction of the outrigger 1130 while the lift assembly 1000 is in use, to maintain the integrity of the stabilizer leg platform. The terminus end may be over bored, relative to the channel, which may further retain the sprung bar to avoid unintentional release.

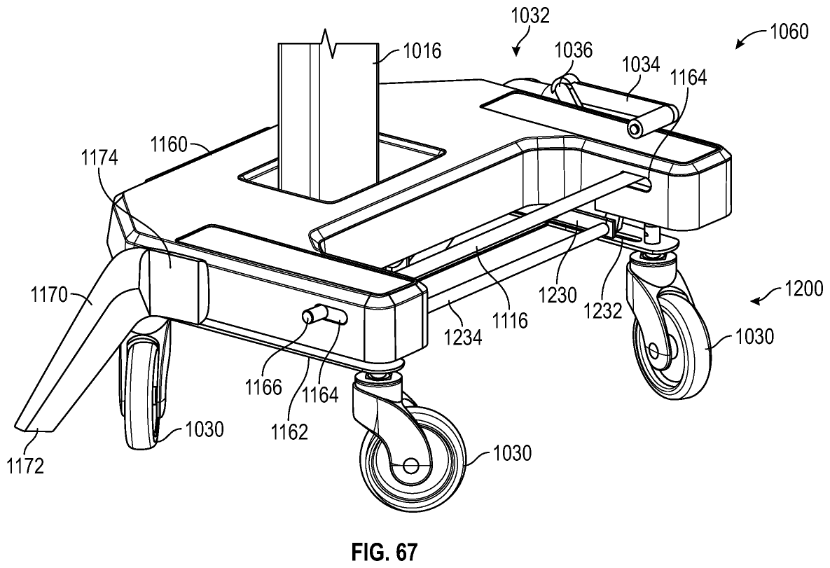

FIG. 67 is a perspective view of a base assembly 1060 coupled to a mast 1016, according to an exemplary embodiment. The base assembly 1060 includes a body 1160 (e.g., a frame or chassis) connecting to the various other components of the lift assembly 1000 and transmitting forces therebetween. The body 1160 can include one or more lateral surfaces, and include vertical surfaces connected thereto to encapsulate one or more pinch points or movable portions thereof as are further described henceforth. The handle 1034 can couple to the bar 1036 (e.g., a force transfer bar) to distribute a force to opposite ends of the base assembly 1060 to adjust a height of a plate 1162 coupled to the casters 1030, to adjust a caster height. A sprung bar 1116 is coupled to a spring. The sprung bar 1116 is disposed within a notch or slot 1164 in which the sprung bar 1116 can travel between a normal and stressed lateral position. A terminal portion 1166 of the sprung bar 1116 extends laterally beyond the notch. In some embodiments, the sprung bar 1116 can include two terminal portions or end portions 1166, disposed on opposite ends of the sprung bar. In some embodiments, the sprung bar 1116 can include multiple segments, which may not be directly coupled, and which include various terminal segments, which can lead to redundancy of a latching mechanism for the outrigger 1130 in a deployed position.

As depicted in FIG. 67, the sprung bar 1116 is in the normal position, wherein the spring is at a minimum displacement. The normal position can align, laterally, with the opening 1150 of the locking guide 1134. By applying a downward force on the outrigger 1130, the outrigger 1130 can rotate about the rotation points 1138 to cause a spring extension/deformation, as the terminal portion 1166 of the sprung bar 1116 traverses the channel 1152. Upon the sprung bar 1116 exceeding the upper surface of the protrusion, the spring force can cause the spring force to retract the sprung bar to the terminus 1154 of the channel 1152. Such a position may be referred to, herein, as a latched position, deployed position, engaged position, or lowered position of the stabilizer leg platform generally, or the outrigger 1130 thereof. The displacement of the spring can depend on a spring type. For example, the lateral disruption herein can apply to a tension spring located frontward of the sprung bar, or a compression spring located rearward of the bar. Such displacements can be inverted for a tension spring located rearward of the sprung bar, or a compression spring located frontward of the sprung bar, and likewise adjusted for other spring types which may be employed including torsion springs, spiral springs, leaf springs, or so forth.

Another portion of the outrigger assembly 1064 is depicted as non-rotatably or fixedly coupled to the body 1160 of the base assembly. Such a portion may be referred to herein as a fixed leg or fixed outrigger 1170. For example, the depicted embodiment includes two fixed outrigger 1170 terminating at feet 1172 at or proximal to a forward extreme of the lift assembly 1000. The fixed legs may be disposed opposite from the outrigger feet 1142 in a deployed configuration along a lateral dimension (e.g., the outrigger feet 1142 may be at a rearward extreme of the lift assembly 1000), and aligned therewith in a perpendicular lateral direction. The fixed outrigger 1170 can include or couple to an interface portion 1174. The interface portion 1174 may be configured to interface with the rotation points 1138 of the outrigger 1130. The interface portion 1174 may include a generally flat surface to permit a rotation of the legs 1132 of the outrigger 1130 about the rotation points 1138. The interface portion 1174 can include or interface with a rotational fastener to rotatably couple the outrigger 1130 to the base assembly 1060 or the fixed outrigger 1170. According to various embodiments, additional or fewer fixed outrigger 1170 can be provided, or fixed outrigger 1170 may be differently located. In some embodiments, the interface portion 1174 can include a generally horizontal feature to engage with an a rearward most portion of the outrigger 1130, which may retain the outrigger in a stowed position when engaged, or may be of a slope to cause a friction retention of the outrigger when in a stowed position (e.g., sloped inward or outward from vertical).

Referring now to FIG. 57, a perspective view of a stowed lift assembly is provided, according to an exemplary embodiment. As depicted in FIG. 67, the sprung bar 1116 is in the normal position at the forward end of the slots 1162. The outrigger 1130 is in an upward stowed position. The outrigger 1130 may be maintained in the stowed position by various retention mechanisms of the present disclosure. For example, the outrigger 1130 can engage with the guard assembly 1002, or proximal to the rotation points thereof (e.g., via the legs 1132, the crossbar 1144, etc.).

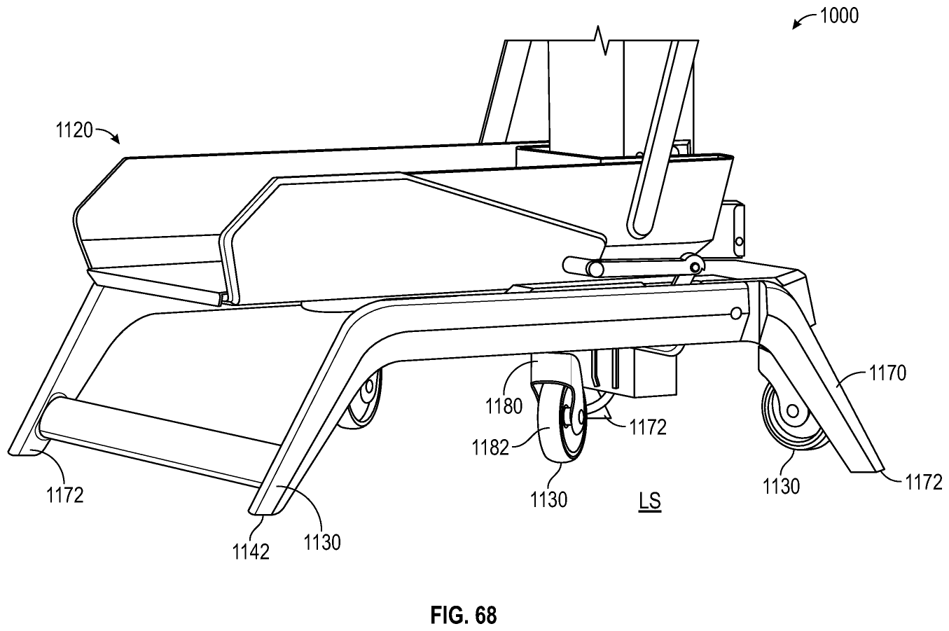

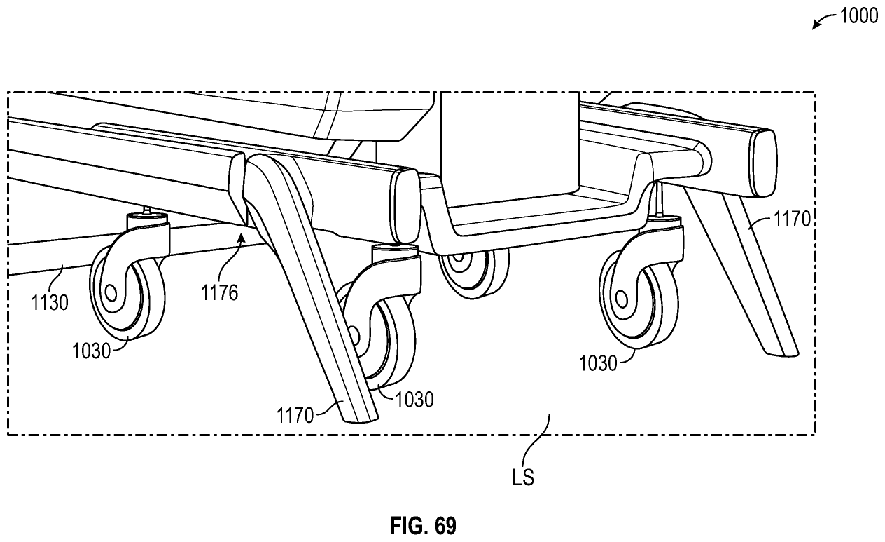

FIG. 68 is a perspective view of the stabilizer leg platform, according to an exemplary embodiment. The stabilizer leg platform includes the outrigger 1130 portion and the fixed outrigger 1170. As deployed over a level surface LS, the feet 1172 of the fixed outrigger 1170 and the deployed outrigger 1130 feet 1142 are disposed in a same lateral plane, which is parallel to, and vertically inferior to a surface of the tread plate 1022. Each caster 1030 includes a caster body 1180 and a wheel 1182. The caster bodies 1180 of the casters 1030 can be retracted upwards such that the coupled wheels 1182 of the casters 1030 are vertically superior to (e.g., above) the lateral plane of the stabilizer leg platform feet 1142, 1172. The caster bodies 1180 may be rotatably coupled to the base assembly 1060 along a perpendicular plane as the wheels 1182 are rotatably coupled to the caster bodies 1180. In a deployed position, the stabilizer leg assembly may fix the position of the lift assembly according to an interface between the level surface LS and the stabilizer leg platform feet 1142, 1172.

FIG. 69 is a detail view of the stabilizer leg platform of FIG. 68, according to an exemplary embodiment. A lateral gap 1176 of the interface portion 1174 of the fixed outrigger 1170, or base assembly 1060 segregate the outrigger 1130 from the remaining portion of the fixed leg 1170. Such a gap 1176 can receive a rearward displacement of the upper portion of the outrigger 1130 during a rotation thereof. As described above, in some embodiments, the interface portion 1174 and upper portion of the outrigger 1130 can interface to maintain a stowed position of the outrigger assembly 1164. For example, a spring loaded latch, detent, or other mechanism can engage therebetween to increase a resistance to rotational movement when engaged.

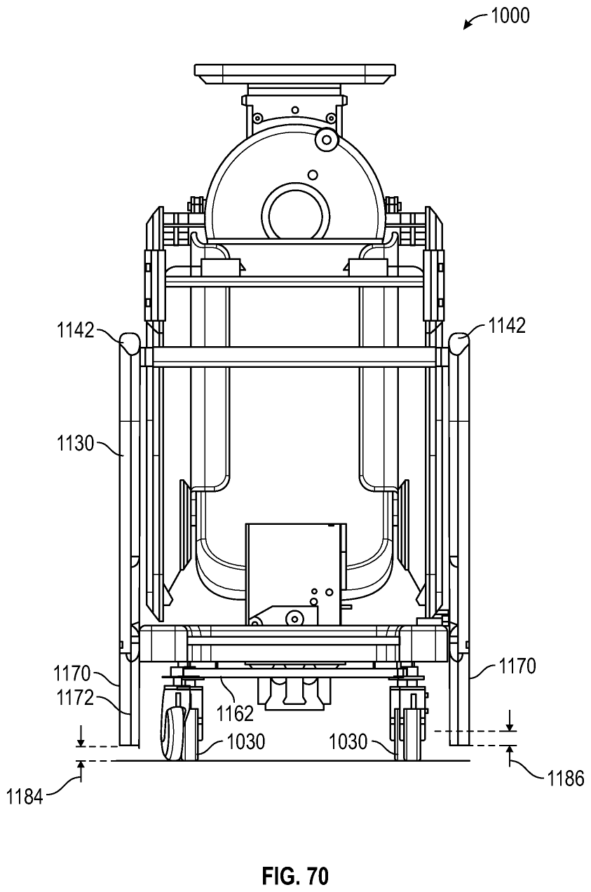

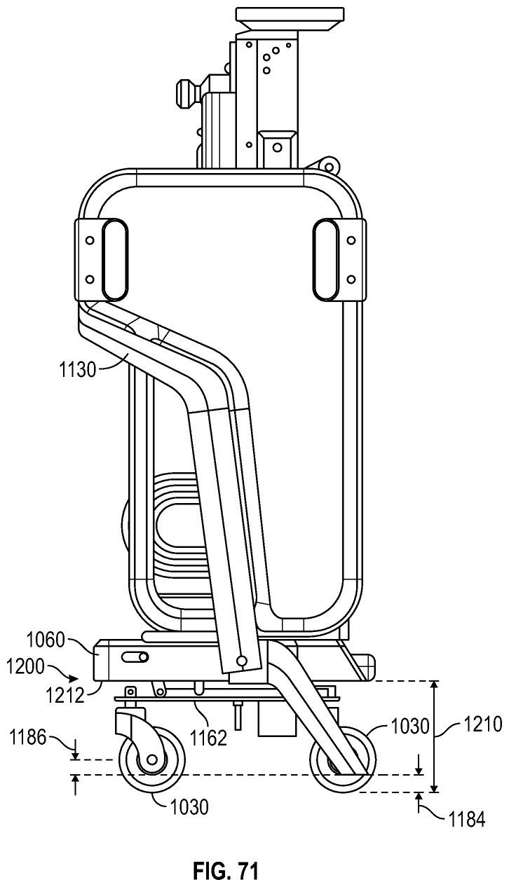

FIG. 70 is a front view of a stowed lift assembly 1000, according to an exemplary embodiment. The feet 1172 of the fixed outrigger 1170 are shown extending from the base assembly 1060 to a lateral plane which may be shared with the feet 1142 of the outrigger 1130. The wheels extend below the lateral plane. A stabilizer leg platform ground clearance 1184 vertically separates said plane from the bottom surface of the wheels 1182. As is further described with respect to FIG. 71, the caster bodies 1180 can retract into the base assembly, by a total distance in excess of the stabilizer leg platform ground clearance 1184, to raise the bottom surface of the wheels 1182 to an elevation 1186 above the plane of the feet 1142. The wheels 1182, when raised to the elevation 1186 may be referred to as at an upper wheel position. A lower wheel position may represent the position where the wheels 1182 are lowered to generate the stabilizer leg platform ground clearance 1184 below the lateral plane of the feet 1142. According to various embodiments, the elevation 1186 may be greater or less than the stabilizer leg platform ground clearance 1184.

The application of weight on the foot well assembly 1020 can cause an actuation of the mechanism coupled to the handle 1034, or otherwise retract the casters 1030 to a distance that is at least the stabilizer leg platform ground clearance 1184 (e.g., by receiving the caster body into the plate 1162), which may prevent movement of the lift assembly 1000 absent a manual retraction of the wheels by causing the stabilizer leg platform including the feet 1172 of the fixed outrigger 1170 and feet 1142 of the outrigger 1130 to non-slidably engage with a surface.

FIG. 57 depicts a perspective view of the lift assembly 1000, according to an exemplary embodiment. The bottom side of the foot well assembly 1020 is depicted, having a side plate 1024 extending along a lower surface thereof. For example, the side plate 1024 can wrap from a side of the tread plate 1022 to a bottom surface thereof. Such a side plate (or bottom plate, the tread plate, etc.) can interface with a base assembly 1060 of the lift assembly 1000. The base assembly 1060 can limit movement of the foot well assembly 1020 (and, via the linkage arms 1018, limit the rotation of the side panels 1004). The base assembly 1060 can also support the lift assembly 1000. A lateral dimension of the lift assembly 1000 can be substantially coextensive, or circumscribed by the lateral dimension of the base assembly 1060. Thus, the base assembly 1060 can be a maximum size which may not constrain a footprint occupied by the lift assembly 1000. According to various embodiments, the base assembly 1060 may exceed the lateral dimension of the other portions of the lift assembly 1000, or the other portions of the lift assembly 1000 can exceed the lateral dimension of the base. In the stowed mode, the guard assembly 1002 and foot well assembly 1020 are disposed within the lateral outer bounds of the base assembly 1060. FIG. 57 depicts an example of the casters 1030 in the first position (e.g., the casters 1030 are making contact with a ground surface) and an example of the bars 1036 in the first orientation.

In the stowed position, the doors 1010 are held open by interfacing with the foot well assembly 1020. The trigger 1012 coupled to the cable 1014 connects to a latch assembly 1050. The latch assembly 1050 can include a normally closed latch that interfaces with a side portion of the mast 1016. For example, the latch can couple the guard assembly 1002 to the mast 1016 to maintain the guard assembly 1002 in a deployed position. The actuation of the trigger 1012 can transmit force (e.g., via the cable 1014) to a lock-release mechanism of the latch assembly 1050 to decouple the guard assembly 1002 from the mast such that the guard assembly 1002 can rotate to the stowed position.

The linkage arms 1018 connect to the guard assembly 1002. A cross-bar 1070 can link the linkage arms 1018. The side panels 1004 interface with an outrigger assembly 1064 in a stowed position. For example, the side panels 1004 can selectively couple to or otherwise interface with the outrigger assembly 1064. For example, a face of the side panel 1004 can interface with a cross member or crossbar 1144 of the outrigger assembly 1064 to arrest a rotation of the guard assembly 1002.

The lift assembly 1000 can include at least one caster assembly 1200. The caster assembly 1200 can be any caster assembly described herein. The caster assembly 1200 can be coupled with at least one of the base assembly 1060, the mast 1016 and/or the outrigger assembly 1064. The caster assembly 1200 can also be coupled with the mechanism 1032 and/or a component thereof. For example, the caster assembly 1200 can be coupled with the bars 1036. The caster assembly 1200 can include the casters 1030 and at least one structure, shown as plate 1162. The plate 1162 can be the primary structural member of the caster assembly described herein. The plate 1162 can be coupled with the casters 1030. The plate 1162 can also be moveably coupled with the bars 1036. For example, the plate 1162 can be coupled with the bars 1036 while the bars 1036 are in the second orientation and the plate 1162 be decoupled from the bars 1036 while the bars 1036 are in the first orientation. The plate 1162 can be and/or include at least one of a plate, a bar, a beam, a brace, a bracket, a board, and/or a joist. The plate 1162 can couple the casters 1030 with the mechanism 1032. The mechanism 1032 can move the plate 1162 and the mechanism 1032 moving the plate 1162 can result in the mechanism 1032 moving the casters 1030.

The casters 1030 can include at least one caster body 1180 and at least one wheel 1182. The caster body 1180 may include a stem 1202. The stem 1202 can be coupled with the plate 1162. The stem 1202 can be and/or include at least one of a shaft, a body, a stick, a pole, a bar, a rod, and/or a joint. The stem 1202 can be coupled or formed with with the caster body 1180. The caster body 1180 can be and/or include at least one of a fork, a support structure, a member, a plate, a housing, and/or a wheel assembly. The caster body 1180 can be coupled with the wheel 1182. The caster body 1180 can also house at least a portion of the wheel 1182. The caster body 1180 can rotate, spin, pivot, swivel and/or otherwise move separately from that stem 1202. For example, the stem 1202 can be rigid while the caster body 1180 can rotate around a central axis of the stem 1202. The caster body 1180 can move the wheels 1802 separately from the stem 1202. For example, the wheels 1802 can move responsive to a direction of force that is applied to the lift assembly 1000. The wheels 1802 can be and/or include at least one of polyurethane material, polycarbonate material, polypropylene material, isoprene polymer material, metal material, and/or among other possible materials. For example, the wheels 1802 can include rubber material.

The tread plate 1022 can include at least one protrusion 1204. The protrusion 1204 can be and/or include the protrusion described herein. The protrusion 1204 can move the casters 1030 from the first position to the second position and the protrusion 1204 can move the casters 1030 from the second position to the first position. The protrusion 1204 can, responsive to the tread plate 1022 supporting an object, interact with a portion of the caster assembly 1200 resulting in the casters 1030 moving from the first position to the second position. For example, the protrusion 1204 can interact with a portion of the caster assembly 1200 that results in the casters 1030 being lifted off of the ground (e.g., moved from the first position to the second position). The tread plate 1022 no longer supporting the object can result in the protrusion 1204 no longer interacting with the portion of the caster assembly 1200 that resulted in the caster 1030 moving to the second position. The protrusion 1204 no longer interacting with the caster assembly 1200 can result in the casters 1030 moving back to the first position.

The outrigger assembly 1064 can move from a stowed position (e.g., the position depicted in FIG. 57) to a deployed position (e.g., the outrigger assembly 1064 and/or a component thereof has pivoted away from the mast 1016, as shown in FIG. 68). The stowed position can be a first configuration and the deployed position can be a second configuration. The position of the casters 1030 (e.g., the first position and/or the second position) can determine whether the outrigger assembly 1064, while in the deployed position, makes contact with a ground surface. For example, while the casters 1030 are in the first position the casters 1030 can extend and/or otherwise be closer to the ground surface to that of the outrigger assembly 1064. The casters 1030, while in the first position, being closer to the ground surface can result in the casters 1030 making contact with the ground surface and the outrigger assembly 1064, while in the deployed position, not making contact with the ground surface. The placement of the casters 1030, by the bars 1036 and/or the mechanism 1032, can result in the outrigger assembly 1064 and/or a component thereof making contact with the ground surface. For example, the outrigger assembly 1064, while in the deployed position, can make contact with the ground surface responsive to the bars 1036 placing the casters 1030 in the second position (e.g., the bars 1036 raised the casters 1030 off of the ground surface resulting in the lift assembly 1000 and/or outrigger assembly 1064 being lowered).

FIG. 71 depicts a side view of the lift assembly 1000, according to an exemplary embodiment. The casters 1030 can make contact with a ground surface, shown as level surface LS. For example, the casters 1030 can make contact with the level surface LS responsive to the casters 1030 being in the first position. The casters 1030 being in the first position can create, define, and/or otherwise establish a distance between the level surface LS and a component of the lift assembly 1000. For example, the casters 1030 being in the first position can establish a distance between the base assembly 1060 and the level surface LS. The casters 1030 being in the first position can also establish a distance between the outrigger assembly 1064 and the level surface LS. The distance established by the casters 1030 between the level surface LS and the base assembly 1060 can be larger than, equal to and/or smaller than the distance established by the casters 1030 between the level surface LS and the outrigger assembly 1064. The casters 1030 being in the first position can establish a distance between the ground surface and a component of the lift assembly 1000 by a range of at least 10 millimeters to 40 millimeters. For example, the casters 1030 can establish a distance of at least 25 millimeters between the level surface LS and a component of the lift assembly 1000 (e.g., the ground clearance 1184). FIG. 71 depicts an example of the casters 1030 in the first position.

FIG. 71 depicts an example of the casters 1030 establishing a distance 1210 between the base assembly 1060 and the level surface LS. While the distance 1210 is shown to be between a bottom portion 1212 (e.g., a portion closet to the level surface LS) of the base assembly 1060 and the level surface LS, the distance 1210 can be a distance between any portion of the base assembly 1060 and the level surface LS. FIG. 71 depicts an example of the casters 1030 establishing the ground clearance 1184 between the outrigger assembly 1064 (specifically the feet 1172) and the level surface LS. While the ground clearance 1184 is shown to be between the feet 1172 of the outrigger assembly 1064, the ground clearance 1184 can be a distance between any portion of the outrigger assembly 1064 and the level surface LS. FIG. 71 depicts an example of the casters 1030 establishing a distance between the base assembly 1060 and the level surface LS (e.g., the distance 1210) that is larger than a distance, established by the casters 1030, between the outrigger assembly 1064 and the level surface LS (e.g., the ground clearance 1184).

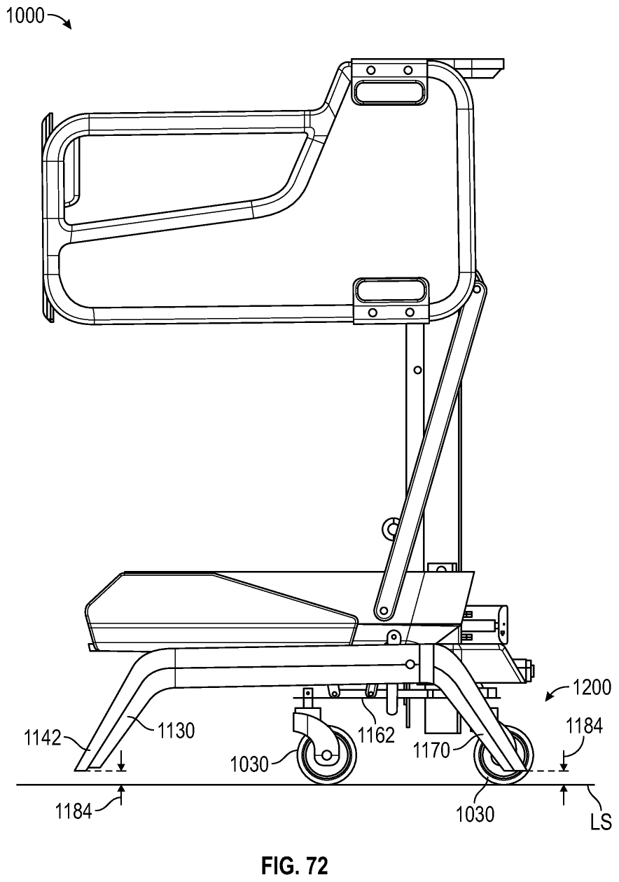

FIG. 72 depicts a side view of the lift assembly 1000, according to an exemplary embodiment. The outrigger assembly 1064 can include at least one deployable outrigger 1130. The outrigger 1130 can move from a stowed position to a deployed position. The outrigger 1130 can be and/or include at least one of a foot, a base, a brace, a support structure and/or a beam. For example, the outrigger 1130 can be a foot that stabilizes and/or supports the lift assembly 1000. FIG. 72 depicts an example of the outrigger 1130 having moved from the stowed position to the deployed position. The casters 1030 can, while in the first position, establish a ground clearance 1184 between the level surface LS and the foot 1142 of the outrigger 1130. The ground clearance 1184 of the outrigger 1130 can be larger than, equal to and/or smaller than the ground clearance 1184 of the fixed outrigger 1170. FIG. 72 depicts an example of the ground clearance 1184 of the outrigger 1130 being smaller than the ground clearance 1184 of the fixed outrigger 1170. FIG. 72 also depicts an example of the casters 1030 in the first position.

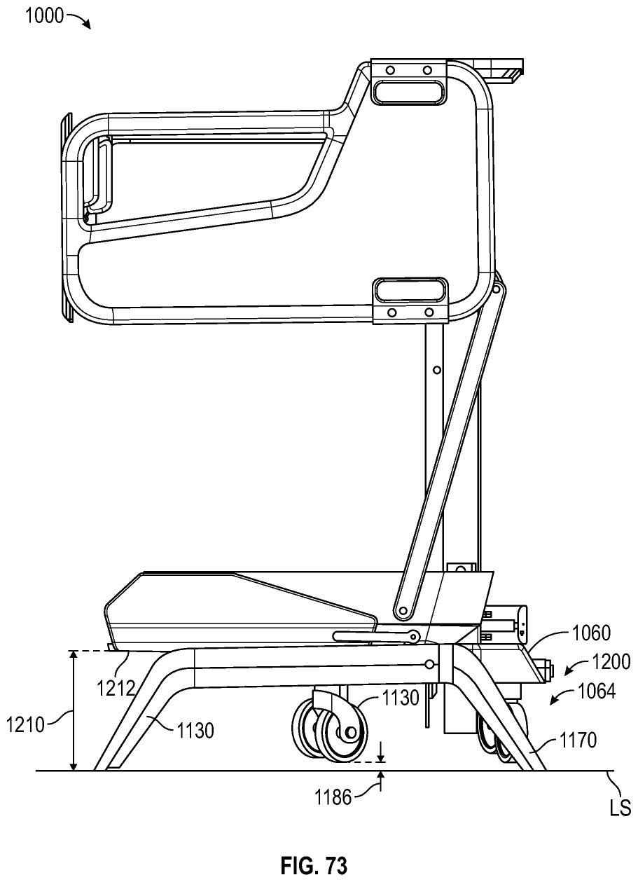

FIG. 73 depicts a side view of the lift assembly 1000, according to an exemplary embodiment. The outrigger 1130 and/or the outrigger assembly 1064 can make contact with the level surface LS. The outrigger assembly 1064 and/or the outrigger 1130 can make contact with the level surface LS responsive to the mechanism 1032 moving the casters 1030 from the first position to the second position. FIG. 73 depicts an example of the casters 1030 in the second position and an example of the outrigger 1130 and the fixed outriggers 1170 making contact with the level surface LS. The moving (e.g., raising of the casters 1030 off of the level surface LS) of the casters 1030 from the first position to the second position can lower the outrigger assembly 1064 onto the level surface LS (e.g., make contact with the level surface LS). For example, the feet 1142 and the feet 1172 of the outrigger assembly 1064 can make contact with the level surface LS.

The distances between the feet 1042 and the feet 1072 of the outrigger assembly 1064 and the bottom portion 1212 of the base assembly 1060 can be substantially similar to the distance between the level surface LS and the bottom portion 1212 of the base assembly 1060 (e.g., the distances can be the same). The distance 1210 between the base assembly 1060 and the level surface LS with the casters 1030 in the first position (e.g., the distance 1210 established by the casters 1030 in the first position) can be larger than the distance between the base assembly 1060 and the level surface LS with the casters 1030 in the second position. For example, the base assembly 1060 and/or a portion thereof can be further away from the level surface LS with the casters 1030 in the first position (e.g., with the casters 1030 making contact with the level surface LS).

An operator of the lift assembly 1000 and/or the mechanism 1032 can interface with, interact with, and/or otherwise engage the handle 1034 and/or the tread plate 1022 to move the casters 1030 and/or the caster assembly 1200 from the first position to the second position and to move the casters 1030 and/or the caster assembly 1200 from the second position to the first position. For example, the casters 1030 can be in the first position (e.g., the casters 1030 are in contact with the level surface LS) and the operator of the lift assembly 1000 can engage with the handle 1034. To continue this example, the operator can engage the handle 1034 by grabbing, touching, contacting and/or otherwise holding the handle 1034. The operator can, responsive to engaging the handle 1034, perform an actuation (e.g., a first actuation of the handle 1034) to move the casters 1030 from the first position to the second position. Similarly, the casters 1030 can be moved from the first position to the second position responsive to the operator of the lift assembly 1000 by stepping onto and/or otherwise positioning themselves on the tread plate 1022. The operator positioning themselves on the tread plate 1022 can result in the tread plate 1022 engaging the mechanism 1032 and/or the bars 1036 resulting in the bars 1036 moving the casters 1030 from the first position to the second position.

The casters 1030 moving from the first position to the second position can result in the outrigger assembly 1064 being lowered and/or otherwise moved closer to the level surface LS. For example, the outrigger assembly 1064, while in the deployed position, can be a first distance (e.g., the ground clearance 1184) away from the level surface LS with the casters 1030 in the first position. The first ground clearance 1184 can be large enough resulting in the outrigger assembly 1064 not making contact with the level surface LS. The raising of the casters 1030 (e.g., moving the casters 1030 from the first position to the second position) can result in the distance between the outrigger assembly 1064 and the level surface LS changing (e.g., the outrigger assembly 1064 is moved closer to the level surface LS). The outrigger assembly 1064 making contact with the level surface LS and the casters 1030 being raised off of the level surface LS can result in the stability of the lift assembly 1000 being increased. For example, with the casters 1030 in the second position that lift assembly 1000can be stationary and the outrigger assembly 1064 can provide additional contact points with the level surface LS. Similarly, the outrigger assembly 1064 can occupy and/or cover a larger surface area of the level surface LS relative to the casters 1030 (e.g., the casters 1030 can be closer to one another and the feet of the outrigger assembly 1064 can be further apart to one another resulting in the stability of the lift assembly 1000 being adjusted).

FIG. 67 depicts a perspective view of the base assembly 1060, according to an exemplary embodiment. The mechanism 1032 can include at least one post 1230. The post 1230 can be coupled with the bar 1036 and the post 1230 can be coupled with the plate 1162. The bar 1036 can move, responsive to the handle 1034 moving the bar 1036 from the first orientation to the second orientation, the post 1230. For example, the bar 1036 can raise and/or lower the post 1230.

The plate 1162 can include at least one opening 1232. The opening 1232 can provide and/or establish an aperture that the bar 1036 and/or the post 1230 can insert into and/or couple with the plate 1162 resulting in the plate 1162 being coupled with the bar 1036 and/or the plate 1162 being coupled with the post 1230. The caster assembly 1200 can include at least one rod 1234. The rod 1234 can be coupled with the post 1230. The rod 1234 can also couple a first plate 1162 with a second plate 1162. The rod 1234 can move in unison with at least one of the bar 1036 and/or the post 1230. For example, the rod 1234 can move with the bar 1036 as the bar 1036 moves from the first orientation to the second orientation. The rod 1234 moving with the bar 1036 can result in the handle 1034 moving both the first plate 1162 and the second plate 1162. The handle 1034 moving both the first plate 1162 and the second plate 1162 can result in the handle 1034 and/or the mechanism 1032 moving both a first caster 1030 and a second caster 1030.

The casters 1030 and/or the caster assembly 1200 can be coupled with the outrigger assembly 1064. The caster assembly 1200 can also be moveable coupled with the outrigger 1130. For example, the rod 1234 can be moveable coupled with the outrigger 1130 responsive to the outrigger 1130 moving from the stowed position to the deployed position. The structure can be at least one of a post, a beam, a shaft, a strut, a bar and/or a railing. The structure can also be movable coupled with the rod 1234. For example, the structure can be coupled with the rod 1234 with the casters 1030 in the second position and with the outrigger 1130 in the deployed position. The moving of the outrigger 1130 from the deployed position to the stowed position can result in the outrigger 1130 decoupling from the caster assembly 1200. The outrigger 1130 decoupling from the caster assembly 1200 can result in the casters 1030 moving from the second position to the first position (e.g., the casters 1030 are lowered towards and contact the level surface LS).

The casters 1030 and/or the caster assembly 1200 can be coupled with the mast 1016. The lifting of the mast 1016, by the lifting mechanism 1040, can result in the casters 1030 moving from the first position to second position. For example, as the mast 1016 is raised from a first height to a second height the casters 1030 can also be raised off of the level surface LS (e.g., the casters 1030 are moved from the first position to the second position). The lowering of the mast 1016, by the lifting mechanism 1040, can result in the casters 1030 being lowered towards to the ground surface (e.g., the casters 1030 are moved from the second position to the first position).

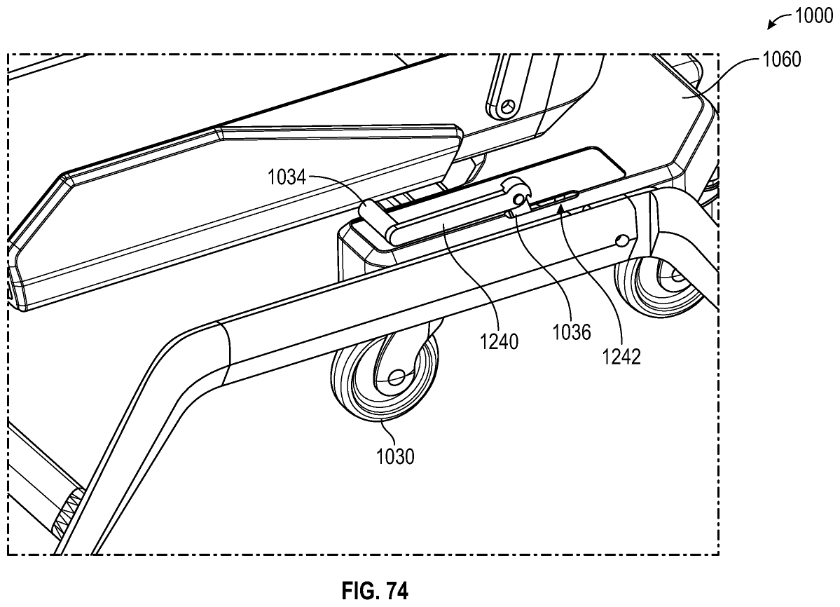

FIG. 74 depicts a perspective view of the lift assembly 1000, according to an exemplary embodiment. The handle 1034 can include at least one arm 1240. The arm 1240 can be pivotably coupled with the bar 1036. For example, an operator engaging with the handle 1034 can result in the arm 1240 pivoting from a first position to a second position. The arm 1240 can be and/or include at least one of a strut, a bracket, a post, a plate, a bar and/or a beam. The arm 1240 can, responsive to an operator actuating the handle 1034, move the bar 1036 from a first orientation to a second orientation. The base assembly 1060 can include at least one opening 1242. The opening 1242 can receive the bar 1036 and/or the bar 1036 can be inserted into and/or through the opening 1242. The opening 1242 can provide space and/or the opening 1242 can create a void allowing the bar 1036 to move from the first orientation to the second orientation and/or allowing the bar 1036 to move from the second orientation to the first orientation.

FIG. 74 depicts an example of the bar 1036 in the second orientation. The arm 1240 moving the bar 1036 from the first orientation to the second orientation can result in the bar 1036 moving the casters 1030 from the first position to the second position. For example, the arm 1240 moving the bar 1036 can result in the bar 1036 engaging with an opening (e.g., the opening 1232) of the plate 1162 and/or can result in the bar 1036 movably coupling with the plate 1162. The bar 1036 engaging with the opening 1232 can result in the plate 1162 and/or the casters 1030 being lifted and/or raised (e.g., the casters 1030 can be lifted off of the level surface LS).

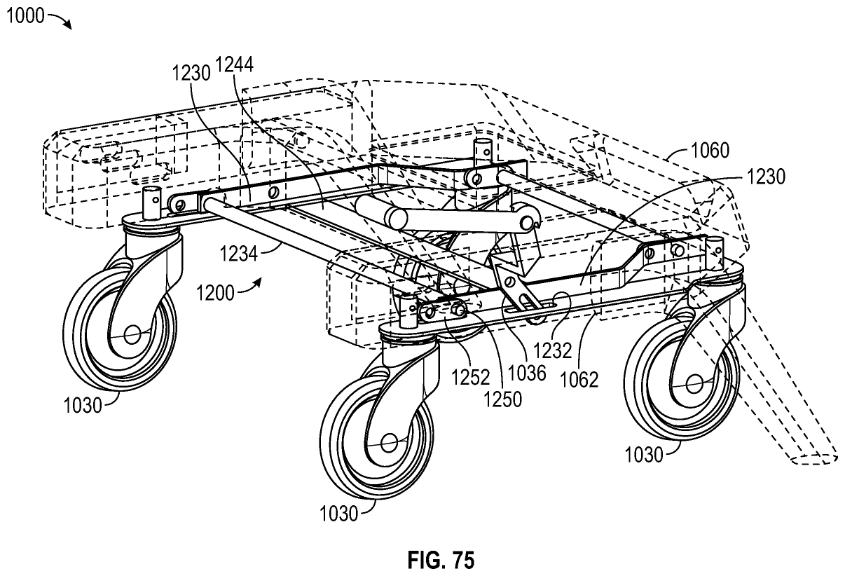

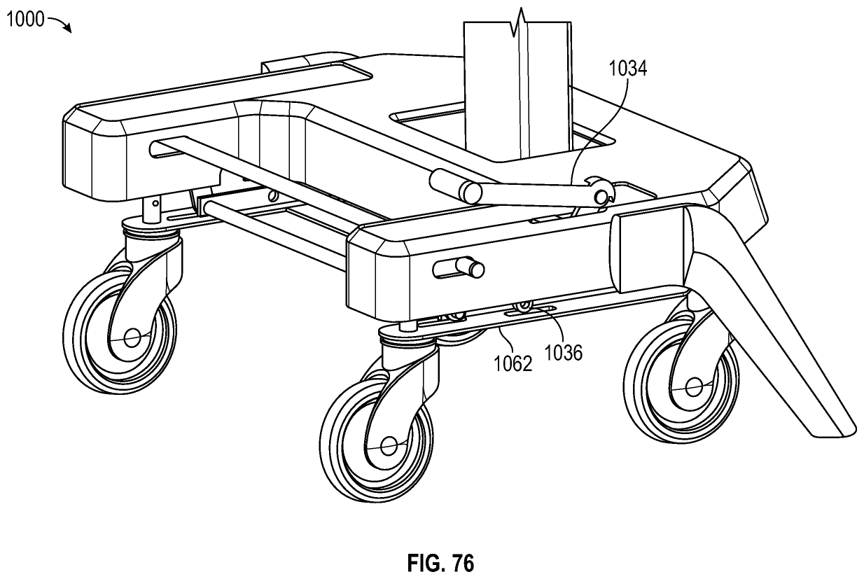

FIG. 75 is a transparent view of the lift assembly 1000, according to an exemplary embodiment. The caster assembly 1200 can include at least one beam 1244. The beam 1244 can couple a first plate 1162 with a second plate 1162. The beam 1244 can also couple a first post 1230 with a second post 1230. The bars 1036 interacting with a first plate 1162 can result in the beam 1244 moving a second plate 1162. For example, the bar 1036 can insert in the opening 1232 of a first plate 1162 and the bar 1036 can lift and/or catch the first plate 1162. The bar 1036 lifting the first plate 1162 can also result in the bar 1036 lifting the beam 1244. The bar 1036 lifting the beam 1244 can result in the second plate 1162 also being lifted. The rod 1234 can include at least one protrusion 1250. The protrusion 1250 can be pivotably coupled with a rotatable portion 1252 of the post 1230. For example, the protrusion 1250 and the rotatable portion 1252 can pivot together and/or in unison while also remaining coupled. The actuation of the handle 1034 and/or the bar 1036 engaging with the plate 1162 can result in rod 1234, the rotatable portion 1252 and the post 1230 moving and/or swiveling. FIG. 75 depicts an example of the bar 1036 having engaged the plate 1162, an example a portion of the bar 1036 disposed within the plate 1162, an example of the bar 1036 in the second orientation, and an example of the bar 1036 having lifted the casters 1030 from the first position to the second position.

FIG. 76 is a perspective view of the lift assembly 1000, according to an exemplary embodiment. FIG. 76 depicts an example of the bar 1036 no longer engaging with the plate 1162 as a result of an actuation of the handle 1034, an example of the bar 1036 having lowered the casters 1030 from the second position to the first position, and an example of the bar 1036 in the first orientation.

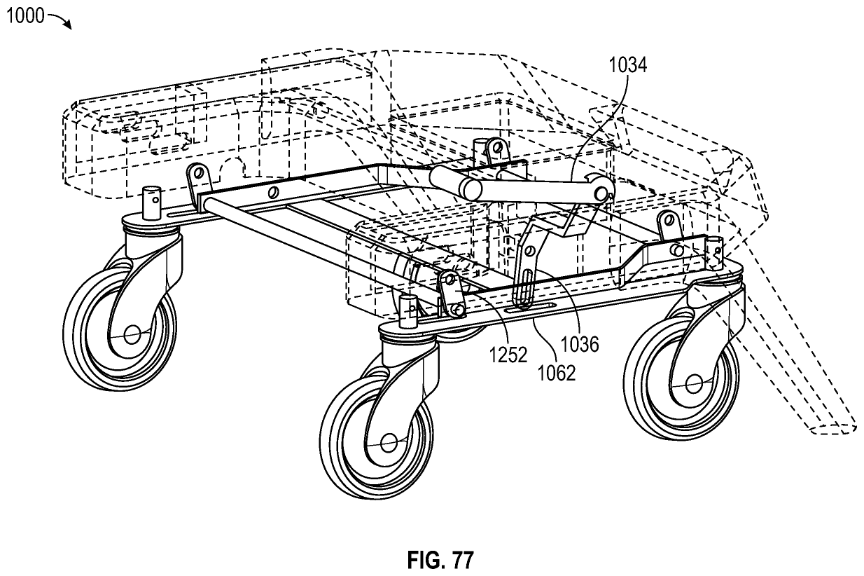

FIG. 77 is a transparent view of the lift assembly 1000, according to an exemplary embodiment. FIG. 77 depicts an example of the bar 1036 no longer having a portion disposed within the plate 1162, an example of the rotatable portion 1252 and the protrusion 1250 having been moved responsive to an actuation of the handle 1034, and an example of the bar 1036 having decoupled from the plate 1162.

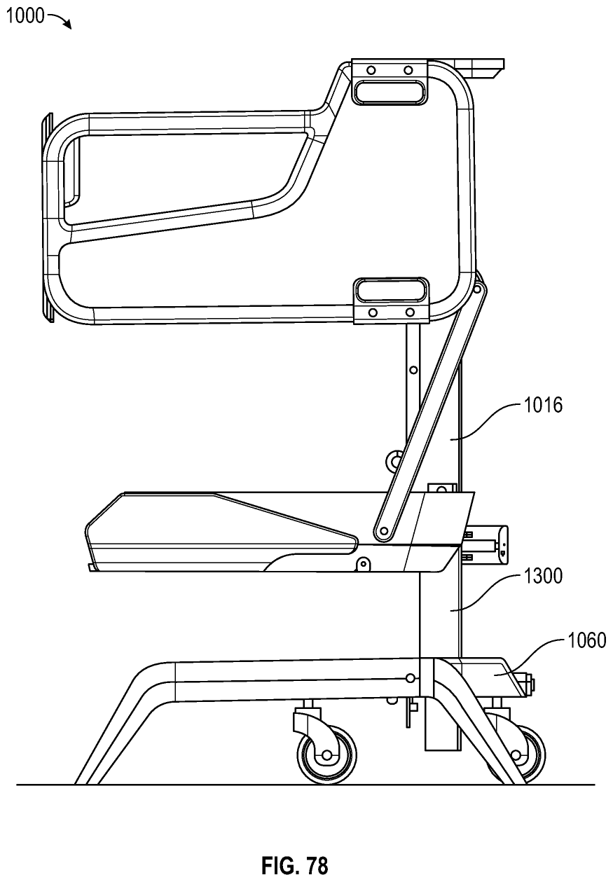

FIG. 78 is a side view of the lift assembly 1000, according to an exemplary embodiment. The lift assembly 1000 can include at least one post 1300. The post 1300 can be and/or include at least one of a beam, a joist, a brace, a support structure, a truss and/or among other possible structures. The post 1300 can be coupled with the base assembly 1060. The post 1300 can also be coupled with the mast 1016. The post 1300 can support the mast 1016. For example, the post 1300 hold and/or keep the position of the mast 1016. The mast 1016 can move, slide, swivel, adjust and/or otherwise change its position and/or location relative to the post 1300. For example, the post 1300 can include struts that extend and/or run vertically along the body of the post and the mast 1016 can include sliders, gliders, railings and/or among other possible components that can slide and/or move along and/or across the struts.

The lifting mechanism 1040 can lift and/or lower the mast 1016 relative to the post 1300. For example, the lifting mechanism 1040 can lift the mast 1016 and the sliders of the mast 1016 can move along the post 1300 resulting in the mast 1016 moving from a first position to a second position. FIG. 78 depicts an example of the mast 1016 in the second position (e.g., a raised position).

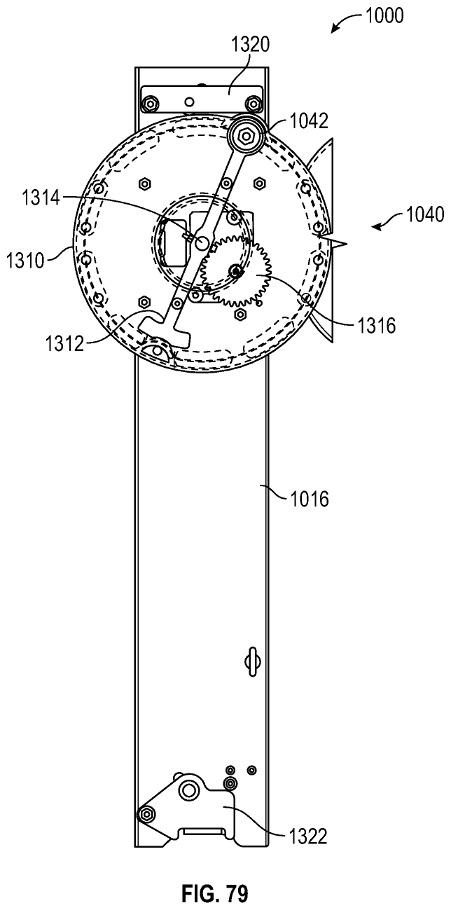

FIG. 79 is a front view of the lift assembly 1000, according to an exemplary embodiment. The lift assembly 1000 can include at least one housing 1310. The housing 1310 can be disposed external to the mast 1016 and the housing 1310 can be coupled with the mast 1016. The housing 1310 can contain, house, store and/or otherwise stow at least a portion of the lifting mechanism 1040. A portion of the crank 1042 can be disposed external to the housing 1310. The crank 1042 can include at least one arm 1312. The arm 1312 can be disposed within the housing the 405. The arm 1312 can spin, rotate, pivot, swivel and/or otherwise move responsive to an actuation of the crank 1042. For example, the crank 1042 can be spun in a clockwise direction and the arm 1312 can also move in a clockwise direction responsive to the crank 1042 can been spun.

The lifting mechanism 1040 can include at least one drive gear 1314 and at least one driven gear 1316. The drive gear 1314 can be and/or include a spindle and teeth. The drive gear 1314 can be coupled with the arm 1312. The drive gear 1314 can also be pivotably coupled with the driven gear 1316. The rotating of the arm 1312 and/or the crank 1042 can move, spin, adjust, swivel and/or other adjust the drive gear 1314. For example, the rotating of the arm 1312, responsive to an operator of the lift assembly 1000 interacting with the crank 1042, can result in the drive gear 1314 also rotating. The rotating of the drive gear 1314 can result in the driven gear 1316 also rotating.

The mast 1016 can include at least one plate 1320 (e.g., a top plate 1320) and at least one plate 1322 (e.g., a bottom plate 1322), which may function as tensioners. The top plate 1320 can be disposed above the housing 1310. The top plate 1320 can be coupled with the lifting mechanism 1040. For example, the top plate 1320 can be coupled with a pulley of the lifting mechanism 1040 that is disposed with a hollow body of the mast 1016. The bottom plate 1322 can be disposed beneath the housing 1310. The bottom plate 1322 can also be coupled with the lifting mechanism 1040. For example, the bottom plate 1322 can also be coupled with pulley of the lifting mechanism 1040 that is disposed with the hollow body of the mast 1016.

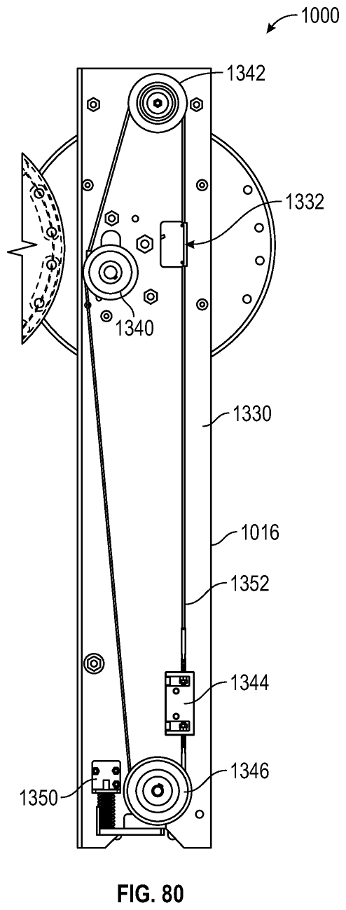

FIG. 80 is a rear view of the lift assembly 1000, according to an exemplary embodiment. A rear portion of the mast 1016 has been removed. The rear portion and a second portion of the mast 1016 can create, establish and/or otherwise define a body of the mast 1016. The lifting mechanism 1040 and/or components thereof can be disposed within and/or housed within the body of the mast 1016.

The lift assembly 1000 can include at least one panel 1330. The panel 1330 can be disposed within the mast 1016. For example, the panel 1330 can be housed within the body of the mast 1016. The panel 1330 can also be coupled with or part of the mast 1016. The panel 1330 can also be coupled with the lifting mechanism 1040. The panel 1330 can include at least one opening 1342. The opening 1342 can provide access to the lifting mechanism 1040. For example, the housing 1310 and/or a component thereof (e.g., a cover) can be removed and the removal of the housing 1310 can expose the opening 1342. The opening 1342 can then provide access to the body of the mast 1016 and/or the lifting mechanism 1040.

The lifting mechanism 1040 can include at least one capstan 1340, at least one pulley 1342 (e.g., a top pulley 1342), at least one link 1344, at least one pulley 1346 (e.g., a bottom pulley 1346) at least one spring mechanism or tensioner, shown as structure 1350, and at least one tensile member, shown as cable 1352. The capstan 1340 can be rotatably coupled with the driven gear 1316. For example, the capstan 1340 can rotate with the driven gear 1316. The capstan 1340 can house, store, stow and/or otherwise include a wound up and/or twisted up portion of the cable 1352. For example, the cable 1352 can be spun around a track of the capstan 1340. The rotating of the capstan 1340 can result in the cable 1352 moving in a circular and/or semi-circular path within the mast 1016. The link 1344 may be fixedly coupled to the post 1300, such that the movement of the cable 1352 can result in the mast 1016 being lifted and/or lowered.

The top pulley 1342 can be coupled with the top plate 1320. The top pulley 1342 can house, receive and/or otherwise include a portion of the cable 1352. The top pulley 1342 can provide tension to the cable 1352. The top pulley 1342 can also provide a pivot point and/or a rotation point for the cable 1352. The bottom pulley 1346 can be coupled with the bottom plate 1322. The bottom pulley 1346 can provide tension to the cable 1352. The bottom pulley 1346 can also provide a pivot point and/or a rotation point for the cable 1352.

The link 1344 can be coupled with the mast 1300. The link 1344 can also be coupled with each end of the cable 1352. The link 1344 can move along with and/or as a result of the cable 1352 being rotated by the drive gear 1316. For example, the cable 1352 rotating can result in the link 1344 being lifted and/or lowered and the lifting and/or lowering of the link 1344 can result in the mast 1016 being lifted and/or lowered.

The structure 1350 can be and/or include at least one of a biasing element, spring, a gasket, a latch, a lever, a catch and/or among other possible mechanism. For example, the structure 1350 can be a spring. The structure 1350 can apply a downward biasing force onto the bottom pulley 1346 to tension the cable 1352.

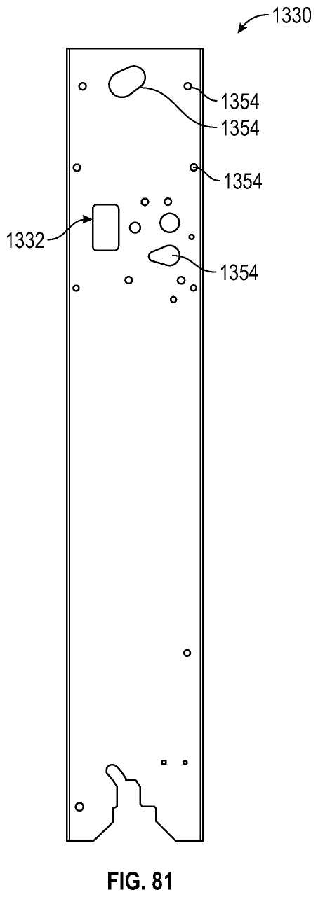

FIG. 81 is a front view of the panel 1330, according to an exemplary embodiment. The panel 1330 can include a plurality of apertures 1354. The apertures 1354 can provide at least one of an opening, a gap, a void and/or a hole between a first side and a second side of the panel 1330. The apertures 1354 can receive fasteners and the fasteners can couple components together. For example, a first aperture 1354 can receive a first fastener and the first fastener can couple the driven gear 1316 with the capstan 1340.

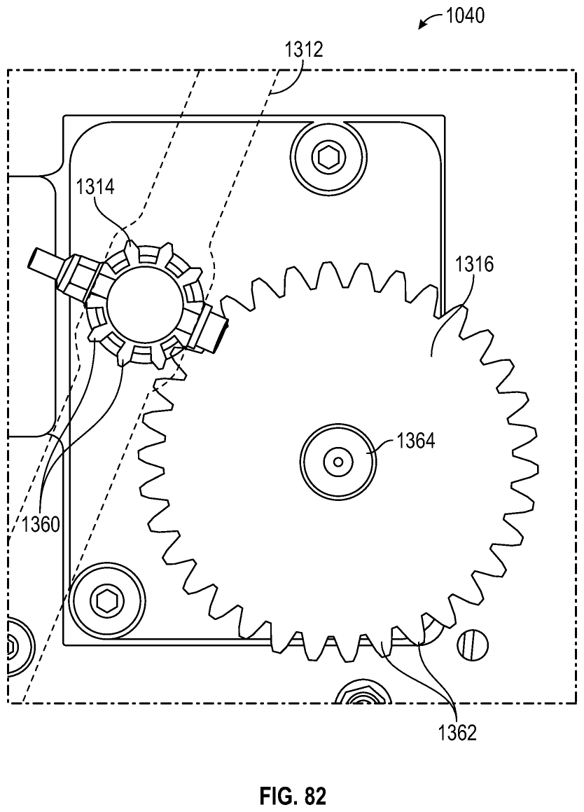

FIG. 82 is a front view of the drive gear 1314 and the driven gear 1316, according to an exemplary embodiment. The drive gear 1314 and/or a portion thereof can be disposed, positioned, located, placed and/or otherwise elevated relative to the driven gear 1316. For example, the drive gear 1314 can located above the driven gear 1316. The drive gear 1314 may be fixedly coupled to the arm 1312. The drive gear 1314 can include teeth 1360. The teeth 1360 can interact with, interface with and/or otherwise engage the driven gear 1316. The teeth 1360 can engage at least one groove and/or teeth 1362 of the driven gear 1316. For example, the crank 1042 rotating the drive gear 1314 can result in the teeth 1360 engaging with the teeth 1362 resulting in the drive gear 1314 rotating the driven gear 1316. The rotation of the driven gear 1316 can result in the rotation of the capstan 1340.

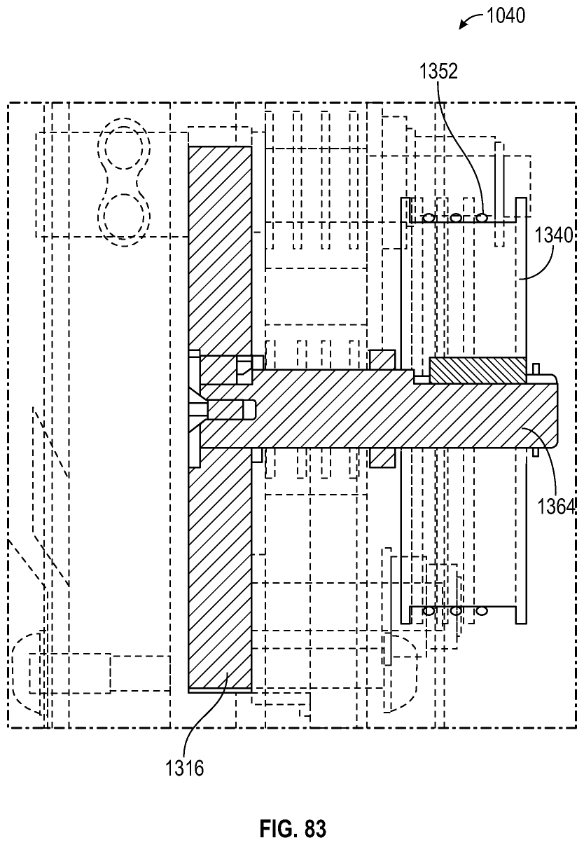

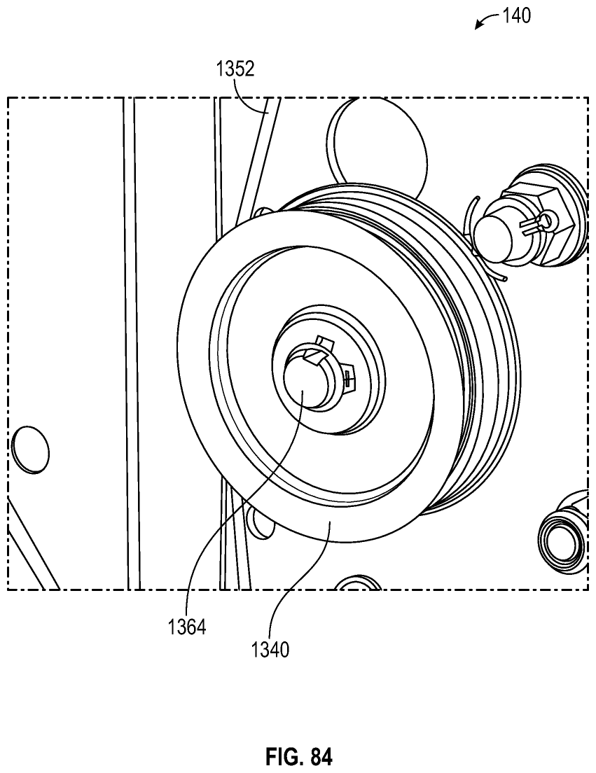

FIG. 83 is a cross sectional view of the mast 1016, according to an exemplary embodiment. FIG. 83 depicts an example of the cable 1352 can be wound around the capstan 1340. A fastener or shaft 1364 (e.g., the fasteners described herein) is shown coupling the driven gear 1316 and the capstan 1340.

FIG. 84 is a perspective view of the panel 1330, according to an exemplary embodiment. FIG. 84 depicts an example of the cable 1352 wound around the capstan 1340. The portion of the cable 1352 that is wound around the capstan 1340 can be adjusted and/or changed based on the lifting mechanism 1040 raising and/or lower the mast 1016. The amount of the cable 1352 (e.g., a number of wraps) that is wound around the capstan 1340 may be adjusted to vary the frictional forces between the capstan 1340 and the cable 1352.

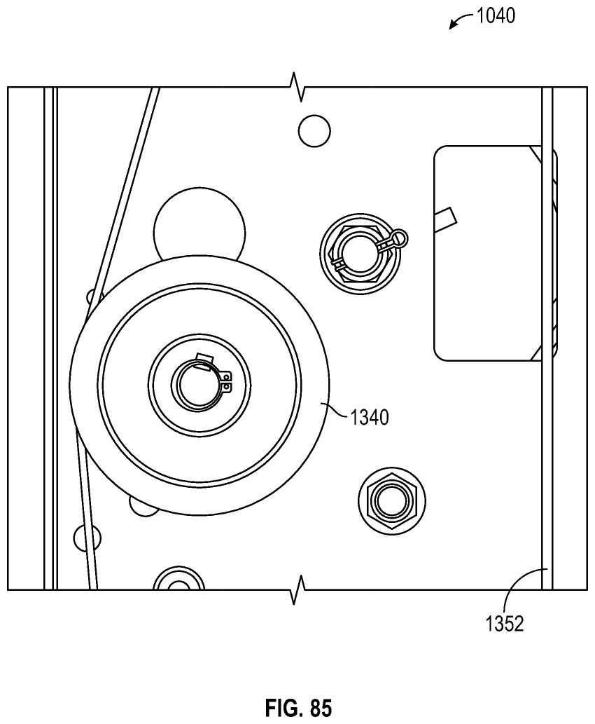

FIG. 85 is a rear view of the panel 1330, according to an exemplary embodiment. The capstan 1340 can spin and/or rotate responsive to an actuation of the crank 1042. For example, the crank 1042 can activate the drive gear 1314 and the drive gear 1314 can activate the driven gear 1316. The activation of the driven gear 1316 can result in the capstan 1340 rotating. The rotating of the capstan 1340 can be in a first direction based on a first direction of the crank 1042 and the rotating of the capstan 1340 can be in a second direction base on a second direction of the crank 1042. The direction of rotation for the capstan 1340 can result in the mast 1016 being lifted and/or lowered. For example, the capstan 1340 rotating in the first direction can result in the mast 1016 being lifted and the capstan 1340 rotating in the second direction can result in the mast 1016 being lowered.

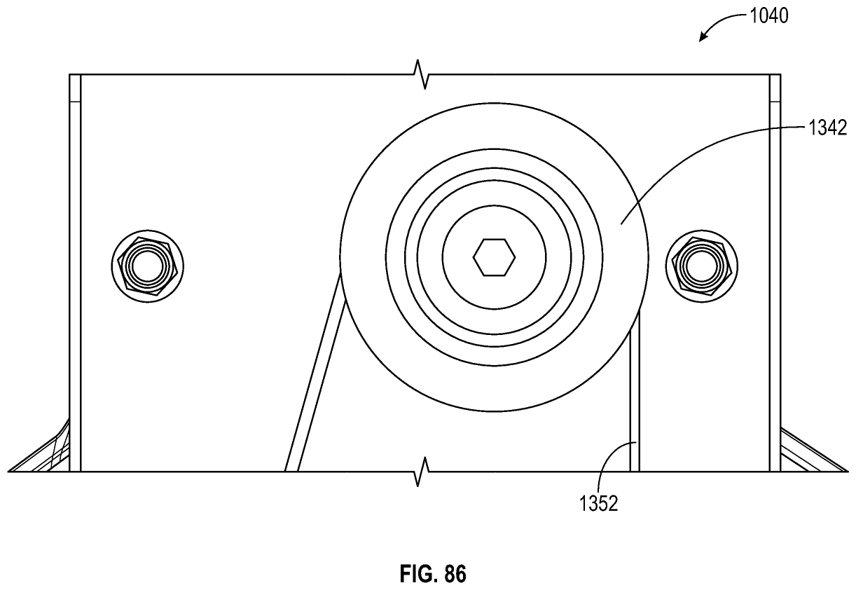

FIG. 86 is rear view of the panel 1330, according to an exemplary embodiment. The top pulley 1342 can receive the cable 1352 and the top pulley 1342 can provide tension to the cable 1352. For example, the top pulley 1342 can maintain a certain rigidity in the cable 1352 resulting in the cable 1352 having a certain amount of tautness and/or tightness. The top pulley 1342 can rotate, pivot, swivel and/or otherwise move as the cable 1352 is rotated around the top pulley 1342. For example the top pulley 1342 can move in a first direction as the lifting mechanism 1040 raises the mast 1016 and the top pulley 1342 can move in a second direction as the lifting mechanism 1040 lowers the mast 1016.

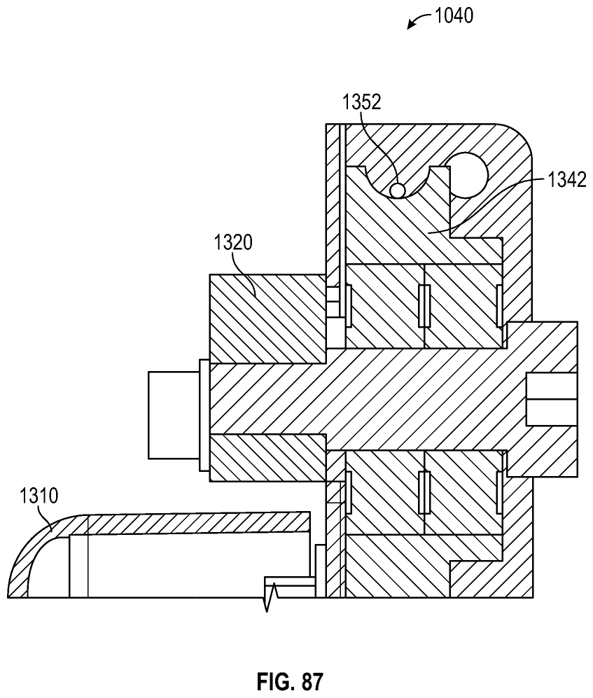

FIG. 87 is cross sectional view of the panel 1330, according to an exemplary embodiment. The top plate 1320 and the housing 1310 are shown to be separated by a distance, defining a void therebetween. The void between the top plate 1320 and the housing 1310 can provide space and/or area for an operators hand to interact with, interface with and/or otherwise engage with the crank 1042.

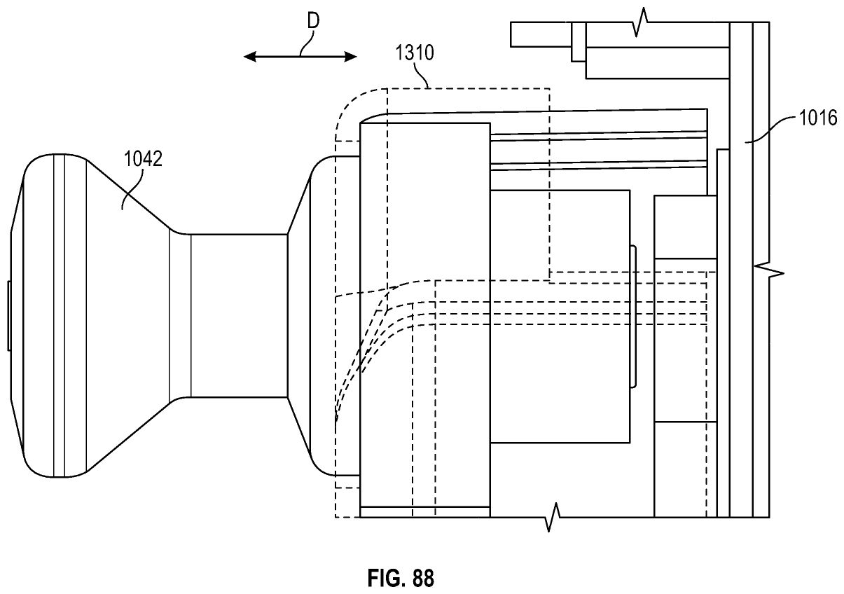

FIG. 88 is cross sectional view of the crank 1042 and the housing 1310, according to an exemplary embodiment. The crank 1042 is shown to have a protrusion and/or a bar that is extended into and/or otherwise disposed within the housing 1310. The crank 1042 may be longitudinally repositionable in a direction D. This may permit the crank 1042 to selectively engage the apertures defined by the mast to limit (e.g., prevent) rotation of the drive gear 1314.

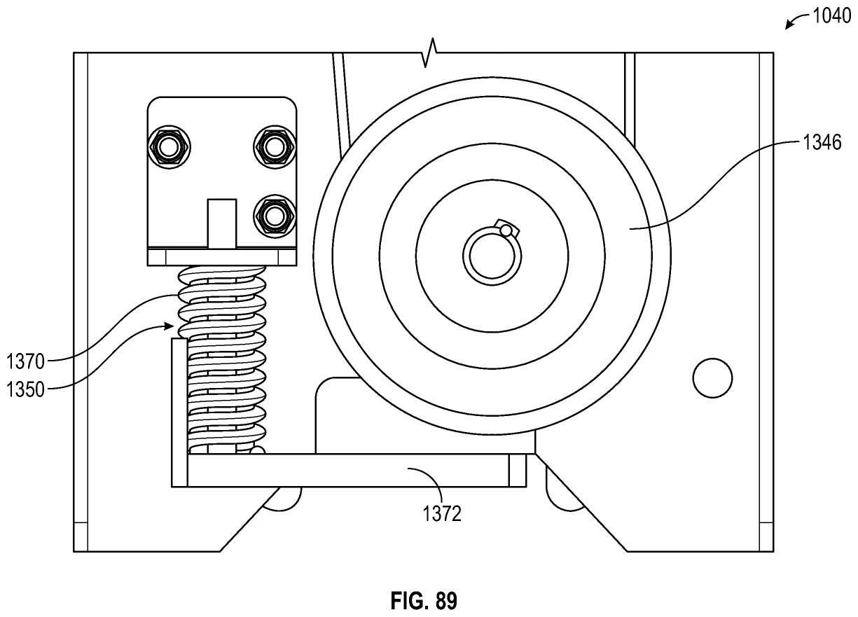

FIG. 89 is rear view of the panel 1330, according to an exemplary embodiment. The bottom pulley 1346 is shown coupled with the bottom plate 1322. The bottom pulley 1346 can receive the cable 1352 and the bottom pulley 1346 can provide tension to the cable 1352. For example, the structure 1350 can apply a biasing force to the bottom pulley 1346 to maintain a certain amount of tautness and/or tightness in the cable 1352. The bottom pulley 1346 can rotate, pivot, swivel and/or otherwise move as the cable 1352 is rotated around the bottom pulley 1346. For example the bottom pulley 1346 can move in a first direction as the lifting mechanism 1040 raises the mast 1016 and the bottom pulley 1346 can move in a second direction as the lifting mechanism 1040 lowers the mast 1016. The structure 1350 can include at least one spring 1370 that applies a biasing force onto a post 1372. The post 1372 can be disposed below the bottom pulley 1346. The post 1372 can couple with, interface with, interact with and/or otherwise engage with the bottom pulley 1346. Accordingly, the biasing force of the spring on the post 1372 may be transferred to the bottom pulley 1346.

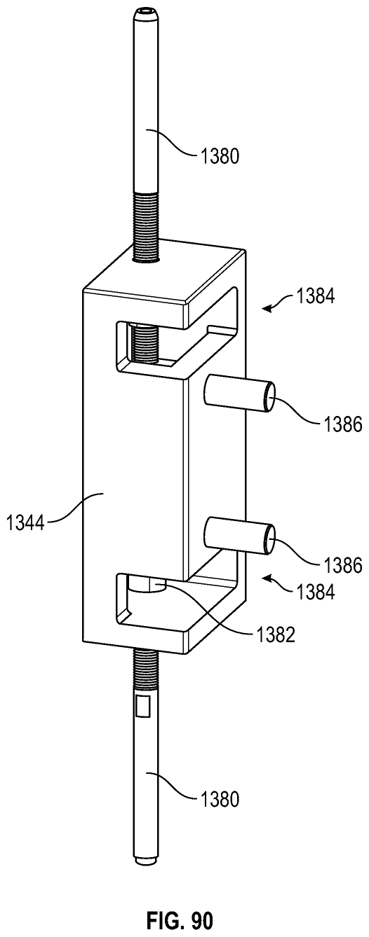

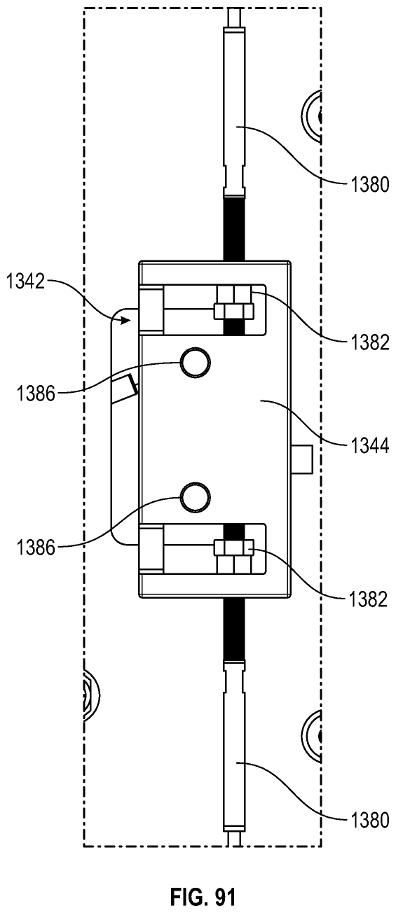

FIGS. 90 and 91 show the link 1344, according to an exemplary embodiment. The link 1344 can be coupled with each end of the cable 1352 by a swaged stud 1380. Each swaged stud 1380 may be crimped, swaged, or otherwise fixedly coupled to one end of the cable 1352, and each swaged stud 1380 may be in threaded engagement with a fastener, shown as nut 1382, that engages the link 1344. The nuts 1382 can be accessible through the link 1344 via openings 1384. The openings 1815 can be accessible through the opening 1342. A tool can be used to twist the nuts 1382 and adjust the relative positions of the swaged studs 1380 (e.g., tighten and/or loosen). For example, a wrench can be used to tighten the swage studs 1380 and tension the cable 1352. The link 1344 can include a pair of protrusions 1386. The protrusions 1386 can be and/or include at least one of a fastener, a bar, a beam, a post, a joist, and/or an object that can be coupled with the post 1300. The link 1344 can move with and/or move as a result of the lifting mechanism 1040 moving the cable 1352. The link 1344 moving with the cable 1352 can result in the mast 1016 being lifted and/or raised relative to the post 1300.

FIG. 91 is a rear view of the panel 1330, according to an exemplary embodiment. The link 1344 is shown to have been moved to a position near the opening 1342 to permit user access to the link 1344 through the opening 1342. For example, the housing 1310 can be removed and/or a cover of the housing 1310 can be taken off and the link 1344 can then be accessible via the opening 1342.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device 10 and the lift assembly 1000 as shown in the various exemplary embodiments is illustrative only. Additionally, any element disclosed in one embodiment may be incorporated or utilized with any other embodiment disclosed herein. By way of example, a component of the lift assembly 1000 may be substituted for a corresponding component of the lift device 10. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lift device, comprising:
a base;
a mast assembly including an inner mast section coupled to the base and an outer mast section;
a platform assembly pivotally coupled to the outer mast section;
a guardrail assembly pivotally coupled to the outer mast section;
a crank assembly including a drive gear that is rotatably coupled to a pulley assembly, wherein rotation of the pulley assembly is configured to move the outer mast section relative to the inner mast section; and
a lift assist motor rotatably coupled to the drive gear and configured to selectively apply an assisting torque on the drive gear to assist in raising the outer mast section, the platform assembly, and the guardrail assembly relative to the base.

2. The lift device of claim 1, wherein the lift assist motor is rotatably coupled to an outer gear.

3. The lift device of claim 2, wherein the outer gear is rotatably fixed to the drive gear.

4. The lift device of claim 3, wherein the outer gear is rotatably fixed to the drive gear by a handle that is rigidly coupled between the outer gear and the drive gear.

5. The lift device of claim 1, wherein the pulley assembly is rotatably coupled to the drive gear by a driven gear.

6. The lift device of claim 1, further comprising a torque sensor and a controller in communication with the lift assist motor and the torque sensor.

7. The lift device of claim 6, wherein the controller is configured to detect, via the torque sensor, that the outer mast section is being raised and, in response, instruct the lift assist motor to generate the assisting torque.

8. The lift device of claim 1, further comprising a support plate coupled to the outer mast section, wherein the lift assist motor is mounted within the support plate.

9. A lift device, comprising:
a base;
a mast assembly including an inner mast section coupled to the base and an outer mast section;
a platform assembly pivotally coupled to the outer mast section;
a guardrail assembly pivotally coupled to the outer mast section;
a crank assembly including a handle, a drive gear, a driven gear, and a pulley assembly, wherein the handle is rotatably fixed to the drive gear, and the driven gear is rotatably fixed to the pulley assembly, and wherein the pulley assembly is coupled between the inner mast section and the outer mast section so that rotation of the pulley assembly is configured to raise and lower the outer mast section, the platform assembly, and the guardrail assembly relative to the base; and
a lift assist motor rotatably coupled to the drive gear and configured to selectively apply an assisting torque on the drive gear that reduces a torque required to rotate the handle and raise the outer mast section, the platform assembly, and the guardrail assembly relative to the base via the pulley assembly.

10. The lift device of claim 9, wherein the crank assembly further comprises an outer gear, and the lift assist motor is rotatably coupled to the outer gear.

11. The lift device of claim 10, wherein the outer gear is rotatably fixed to the drive gear.

12. The lift device of claim 11, wherein the handle is rigidly coupled between the outer gear and the drive gear so that the outer gear is rotatably fixed to the drive gear.

13. The lift device of claim 9, further comprising a torque sensor and a controller in communication with the lift assist motor and the torque sensor.

14. The lift device of claim 13, wherein the controller is configured to detect, via the torque sensor, that the outer mast section is being raised and, in response, instruct the lift assist motor to generate the assisting torque.

15. The lift device of claim 9, further comprising a support plate coupled to the outer mast section, wherein the lift assist motor is mounted within the support plate.

16. A lift device, comprising:
a base;
a mast assembly including an inner mast section coupled to the base and an outer mast section;
a platform assembly pivotally coupled to the outer mast section;
a guardrail assembly pivotally coupled to the outer mast section;
a crank assembly including a handle and a pulley assembly, wherein the pulley assembly is coupled between the inner mast section and the outer mast section, and wherein the handle is rotatably coupled to the pulley assembly so that rotation of the handle in a first direction is configured to raise the outer mast section, the platform assembly, and the guardrail assembly relative to the base; and
a lift assist motor;
a torque sensor; and
a controller in communication with the lift assist motor and the torque sensor, the controller being configured to:
detect, via the torque sensor, that the handle is being rotated in the first direction and, in response, instruct the lift assist motor to generate an assisting torque that reduces a torque required to rotate the handle and raise the outer mast section, the platform assembly, and the guardrail assembly relative to the base via the pulley assembly.

17. The lift device of claim 16, wherein the crank assembly further comprises an drive gear and an outer gear, and the lift assist motor is rotatably coupled to the outer gear.

18. The lift device of claim 17, wherein the outer gear is rotatably fixed to the drive gear.

19. The lift device of claim 18, wherein the handle is rigidly coupled between the outer gear and the drive gear so that the outer gear is rotatably fixed to the drive gear.

20. The lift device of claim 16, further comprising a support plate coupled to the outer mast section, wherein the lift assist motor is mounted within the support plate.
